(19) United States
(12) Patent Application Publication
(10) Pub. No.: US 2017/0019673 A1
(43) Pub. Date: Jan. 19, 2017

(54) IMAGE DECODING DEVICE, IMAGE DECODING METHOD, RECODING MEDIUM, IMAGE CODING DEVICE, AND IMAGE CODING METHOD

(71) Applicant: Sharp Kabushiki Kaisha, Sakai City, Osaka (JP)

(72) Inventors: Takeshi TSUKUBA, Sakai City (JP); Tomohiro IKAI, Sakai City (JP); Tomoyuki YAMAMOTO, Sakai City (JP)

(21) Appl. No.: 15/124,407

(22) PCT Filed: Mar. 12, 2015
(86) PCT No.: PCT/JP2015/057251

§ 371 Date: Sep. 8, 2016

(30) Foreign Application Priority Data
Mar. 14, 2014 (JP) 2014-051864
Apr. 16, 2014 (JP) 2014-084519

(51) Int. Cl. H04N 19/30; H04N 19/105; H04N 19/46

(52) U.S. Cl. CPC H04N 19/30; H04N 19/46; H04N 19/105; H04N 19/172

(57) ABSTRACT

According to an aspect of the present invention, in an output layer set, decoding processing of a non-output and non-reference layer is omitted, and thus a processing amount and a memory size required for decoding the non-output and non-reference layer can be reduced.

### TECHNICAL FIELD

The present invention relates to an image decoding device and an image decoding method in which hierarchy coding data obtained by hierarchically coding an image is decoded.

### BACKGROUND ART

In general, an image or a video is one of information transmitted in a communication system, or information recorded in an accumulation device. In the related art, a technology of coding an image for transmitting or accumulating an image (including a video in the following descriptions) is known.

As a video coding method, AVC (H.264/MPEG-4 Advanced Video Coding) and High-Efficiency Video Coding (HEVC) which is an advanced coding method are known (NPL 1).

In the video coding method, generally, a predicted image is generated based on a locally-decoded image obtained by coding/decoding an input image. A prediction residual (may be also referred to as “differential image” or “residual image”) obtained by removing the generated predicted image from the input image (original image) is coded. As a generation method of the predicted image, inter-frame prediction (inter-prediction) and intra-frame prediction (intra-prediction) are exemplified.

Recently, a scalable coding technology or a hierarchy coding technology in which an image is hierarchically coded according to the necessary data rate is proposed. As a representative scalable coding method (hierarchy coding method), Scalable HEVC (SHVC) and MultiView HEVC (MV-HEVC) are known.

In the SHVC, spatial scalability, temporal scalability, and SNR scalability are supported. For example, in a case of the spatial scalability, an image obtained by performing down-sampling on an original image so as to have a desired resolution is coded as a lower layer. Then, in a higher layer, inter-layer prediction is performed in order to remove redundancy between layers (NPL 2).

In the MV-HEVC, view scalability is supported. For example, in a case where three viewpoint images of a viewpoint image 0 (Layer 0), a viewpoint image 1 (Layer 1), and a viewpoint image 2 (Layer 2) are coded, the viewpoint image 1 and the viewpoint image 2 which are higher layers are predicted from the lower layer (Layer 0) by inter-layer prediction. Thus, the redundancy between the layers can be removed (NPL 3).

In the SHVC or the MV-HEVC, each layer belonging to a designated target output layer set is decoded from input hierarchy coding data, and a decoded picture having a layer which has been designated as an output layer is output. A layer set indicating a set of layers, an output layer flag which is used for designating a layer which is to be set as the output layer, from the layer set, profile/level information (PTL information in the following descriptions) corresponding to each layer set, HRD information, DPB information, and the like are decoded/coded as information regarding the output layer set.

In the related art, output layer sets of output layer sets OLS#0 to OLS#(VpsNumLayerSets−1) are correlated with layer sets of LS#0 to LS#(VpsNumLayerSets−1) which respectively correspond to suffixes (also referred to as output layer set identifier) of the output layer sets. Output layers in each of the output layer sets are determined by a value of a default output layer identifier (default_target_output_layer_idc). For example, in a case where the value of the default output layer identifier is 0, all layers in the output layer set are set as output layers. In a case where the value of the default output layer identifier is 1, a primary picture layer which has a layer ID of the top layer in the output layer set is set as an output layer. In a case where the value of the default output layer identifier is 2, output layers in each output layer set OLS#i (i=1 . . . (VpsNumLayerSets−1)) are designated by an output layer flag (output layer flag) of which a notification is explicitly performed.

In a case where an additional output layer set is defined (in a case where the number (num_add_output_layer_sets) of additional output layer sets is more than 0), each output layer set OLS#i (i=VpsNumLayerSets . . . NumOuputLayerSets−1, the number (NumOutputLayerSets) of output layer sets=VpsNumlayerSets+num_add_output_layer_sets)) is correlated with a layer set LS#(LayerSetldx[i]) designated by a layer set identifier (LayerSetldx[i]=output_layer_set_idx_minus1[i]+1) of which a notification is explicitly performed. In addition, an output layer is designated by the output layer flag (output_layer_flag) of which a notification is explicitly performed.

NPL 4 discloses that a sub-bitstream extracted by a stereo profile does not include an auxiliary picture layer, as the restriction (profile restriction) of a stereo profile of MV-HEVC.

### CITATION LIST

### Non Patent Literature

NPL 1: “Recommendation H.265 (04/13)”, ITU-T (publication date: 2013 Jun. 7)

NPL 2: JCTVC-P1008_v4 “High efficiency video coding (HEVC) scalable extensions Draft 5”, Joint Collaborative Team on Video Coding (JCT-VC) of ITU-T SG 16 WP 3 and ISO/IEC JTC 1/SC 29/WG 11 16th Meeting: San Jose, US, 9-17 Jan. 2014 (publication date: 2014 Jan. 22)

NPL 3: JCT3V-G1004 v6 “MV-HEVC Draft Text 7”, Joint Collaborative Team on 3D Video Coding Extension Development of ITU-T SG 16 WP 3 and ISO/IEC JTC 1/SC 29/WG 11 7th Meeting: San Jose, US, 11-17 Jan. 2014 (publication date: 2014 Jan. 24)

NPL 4: JCT3V-H0126 v2 “MV-HEVC: On phrasing used in specifying the Stereo Main profile”, Joint Collaborative Team on 3D Video Coding Extension Development of ITU-T SG 16 WP 3 and ISO/IEC JTC 1/SC 29/WG 11 8th Meeting: Valencia, ES, 29 Mar.-4 Apr. 2014. (publication date: 2014 Apr. 4)

### SUMMARY OF INVENTION

### Technical Problem

However, in the related art, all layers included in an output layer set are set as decoding targets, and decoding processing is performed on the decoding targets. Thus, there is a problem in that decoding processing of a layer which is not required for decoding an output layer is necessarily performed. For example, in FIG. 1, it is assumed that a layer L#1 and a layer L#0 are independent from each other (do not refer to each other) in the output layer set OLS#1. At this time, in the related art, the output layer L#1 and the layer L#0 which is a non-output and non-reference layer are also decoded.

Further, since all layers included in an output layer set are set as decoding targets in the related art, it is considered that DPB information and PTL information which are required for decoding an output layer set having a different output layer, for example, OLS#1 to OLS#3 in FIG. 1 are the same with reference to the same layer set, for example, LS#1 in FIG. 1. Thus, there is a problem in that redundancy is likely to occur in a case where a notification of a PTL designation identifier (profile_level_tier_idx) is performed for an output layer set which refers to the same layer set. The PTL designation identifier is used for separately designating the DPB information and the PTL information.

Considering the above problems, an object of the present invention is to realize an image decoding device in which decoding processing of a non-output and non-reference layer in an output layer set is omitted, and thus a processing amount and a memory size required for decoding the non-output and non-reference layer can be reduced. Another object of the present invention is to realize an image decoding device and an image coding device in which redundancy of DPB information and PTL information regarding an output layer set which refers to the same layer set is reduced, and thus the DPB information and the PTL information can be decoded/coded with a coding amount smaller than before.

In NPL 4, it is necessary that an auxiliary picture layer not be included in a sub-bitstream in order to omit decoding of an auxiliary picture which is not necessary. Thus, there is a problem in that omitting of decoding processing of an auxiliary picture layer is not possible in a case where the auxiliary picture layer is included in an output layer set.

Considering the above problems, an object of the present invention is to realize an image decoding device in which, even in a case where an auxiliary picture layer is included in an output layer set, the decoding processing of the auxiliary picture layer is omitted, and thus the processing amount and the memory size required for decoding the auxiliary picture layer can be reduced.

### Solution to Problem

To solve the above problems, according to the present invention, there is provided an image decoding device which decodes hierarchy image coding data. The image decoding device includes first flag decoding means for decoding a first flag which indicates whether or not each layer is included in a layer set in a unit of a layer set, layer set information decoding means for deriving a layer ID list of the layer set based on the first flag, output layer set information decoding means for decoding output layer set information in a unit of an output layer set, the output layer set information including a) a layer set identifier, and b) an output layer flag which indicates whether or not each layer included in the output layer set is an output layer, dependency flag deriving means for deriving a dependency flag which indicates whether or not a first layer is a reference layer of a second layer, decoding layer ID list deriving means for deriving a decoding layer ID list in the output layer set based on a layer ID list which indicates a configuration of a layer set corresponding to the output layer set, an output layer flag of the output layer set, and the dependency flag, the decoding layer ID list indicating a layer to be decoded, and picture decoding means for decoding a picture of each layer included in the derived decoding layer ID list.

According to the present invention, there is provided an image decoding method of decoding hierarchy image coding data. The image decoding method includes a first flag decoding step of decoding a first flag which indicates whether or not each layer is included in a layer set in a unit of a layer set, a layer set information decoding step of deriving a layer ID list of the layer set based on the first flag, an output layer set information decoding step of decoding output layer set information in a unit of an output layer set, the output layer set information including a) a layer set identifier, and b) an output layer flag which indicates whether or not each layer included in the output layer set is an output layer, a dependency flag deriving step of deriving a dependency flag which indicates whether or not a first layer is a reference layer of a second layer, a decoding layer ID list deriving step of deriving a decoding layer ID list in the output layer set based on a layer ID list which indicates a configuration of a layer set corresponding to the output layer set, an output layer flag of the output layer set, and the dependency flag, the decoding layer ID list indicating a layer to be decoded, and a picture decoding step of decoding a picture of each layer included in the derived decoding layer ID list.

### Advantageous Effects of Invention

According to an aspect of the present invention, decoding processing of a non-output and non-reference layer in an output layer set is omitted, and thus it is possible to reduce a processing amount and a memory size required for decoding the non-output and non-reference layer.

According to another aspect of the present invention, decoding processing of an auxiliary picture layer in an output layer set is omitted, and thus it is possible to reduce a processing amount and a memory size required for decoding the auxiliary picture layer.

According to still another aspect of the present invention, it is possible to reduce redundancy of DPB information and PTL information regarding an output layer set which refers to the same layer set.

### BRIEF DESCRIPTION OF DRAWINGS

FIG. 1 is a diagram illustrating a problem which relates to an output layer set in the related art, and a diagram illustrating an example of an output layer set which does not have an output layer, and output layer sets in which the combination of output layers is the same, and which are duplicated.

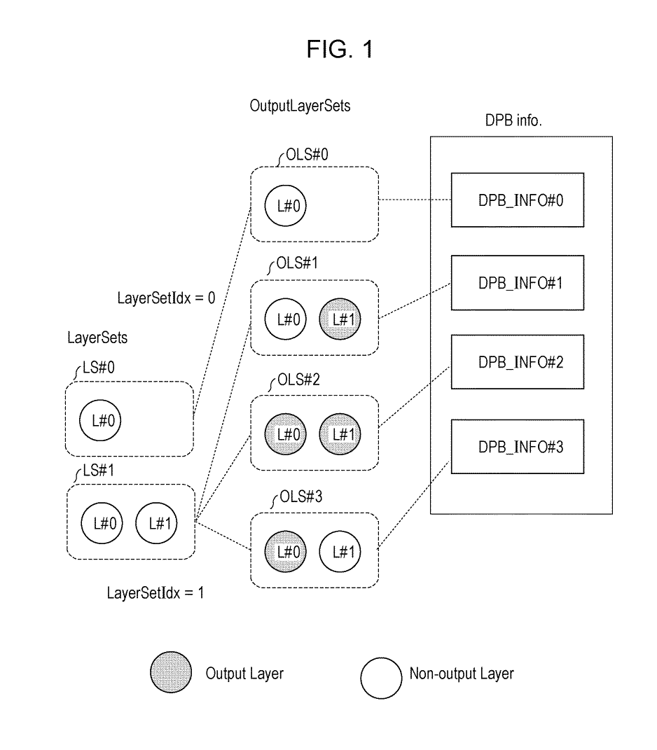

FIG. 2 is a diagram illustrating a layer structure of hierarchy coding data according to an embodiment of the present invention. FIG. 2(a) illustrates a hierarchy video coding device side. FIG. 2(b) illustrates a hierarchy video decoding device side.

FIG. 3 is a diagram illustrating bitstream extraction processing, and is a diagram illustrating a configuration of a layer set A and a layer set B which is a subset of the layer set A.

FIG. 4 is a diagram illustrating an example of a data structure for constituting an NAL unit layer.

FIG. 5 is a diagram illustrating an example of a syntax included in an NAL unit layer. FIG. 5(a) illustrates a syntax example for constituting an NAL unit layer. FIG. 5(b) illustrates a syntax example of an NAL unit header.

FIG. 6 is a diagram illustrating a relation between a value of an NAL unit type and a class of an NAL unit according to the embodiment of the present invention.

FIG. 7 is a diagram illustrating an example of a configuration of an NAL unit included in an access unit.

FIG. 8 is a diagram illustrating a configuration of hierarchy coding data according to the embodiment of the present invention. FIG. 8(a) is a diagram illustrating a sequence layer for predetermining a sequence SEQ. FIG. 8(b) is a diagram illustrating a picture layer for defining a picture PICT. FIG. 8(c) is a diagram illustrating a slice layer for defining a slice S. FIG. 8(d) is a diagram illustrating a slice data layer for defining slice data. FIG. 8(e) is a diagram illustrating a coding tree layer for defining a coding tree unit which is included in the slice data. FIG. 8(f) is a diagram illustrating a coding unit layer for defining a coding unit (CU) which is included in the coding tree.

FIG. 9 is a diagram illustrating a reference relation of parameter sets according to the embodiment.

FIG. 10 is a diagram illustrating a reference picture list and reference pictures. FIG. 10(a) is a conceptual diagram illustrating an example of the reference picture list. FIG. 10(b) is a conceptual diagram illustrating an example of the reference pictures.

FIG. 11 is a diagram illustrating an example of a syntax table of a VPS according to the embodiment of the present invention.

FIG. 12 is a diagram illustrating an example of a syntax table of VPS extension data according to the embodiment of the present invention.

FIG. 13 is a diagram illustrating an example of a syntax table of PTL information according to the embodiment.

FIG. 14 is a diagram illustrating a scalable identifier according to the embodiment of the present invention. FIG. 14(a) is a correspondence table between a scalable identifier and a scalability type. FIG. 14(b) illustrates a pseudo code indicating an example of deriving processing of scalable identification. FIG. 14(c) illustrates an example of a syntax table relating to the scalable identifier.

FIG. 15 is a diagram illustrating an example of a syntax table of DPB information according to the embodiment. FIG. 15(a) illustrates an example of DPB information of an output layer set OLS#0. FIG. 15(b) illustrates an example of DPB information of an output layer set OLS#i (i=1 . . . NumOutputLayerSets−1).

FIG. 16 is a diagram illustrating an estimation method of the DPB information in the present invention.

FIG. 17 is a diagram illustrating an example of syntax tables of SPS/PPS/slice layer according to the embodiment of the present invention. FIG. 17(a) illustrates an example of a syntax table of an SPS. FIG. 17(b) illustrates an example of a syntax table of a PPS. FIG. 17(c) illustrates an example of a syntax table of a slice header and slice data which are included in a slice layer. FIG. 17(d) illustrates an example of a syntax table of a slice header. FIG. 17(e) illustrates an example of a syntax table of slice data.

FIG. 18 is a schematic diagram illustrating a configuration of the hierarchy video decoding device according to the embodiment.

FIG. 19 is a flowchart illustrating deriving of a target decoding layer ID list in an output control unit 16 according to the embodiment.

FIG. 20 is a schematic diagram illustrating a configuration of a target set picture decoding unit according to the embodiment.

FIG. 21 is a flowchart illustrating an operation of a picture decoding unit according to the embodiment.

FIG. 22 is a flowchart illustrating Bitstream extraction processing 1 in a bitstream extraction unit according to the embodiment.

FIG. 23 is a flowchart illustrating Bitstream extraction processing 2 in the bitstream extraction unit according to the embodiment.

FIG. 24 is a diagram illustrating an example of a syntax table relating to sub-bitstream characteristic information according to the embodiment.

FIG. 25 is a schematic diagram illustrating a configuration of the hierarchy video coding device according to the embodiment.

FIG. 26 is a schematic diagram illustrating the configuration of a target set picture coding unit according to the embodiment.

FIG. 27 is a flowchart illustrating an operation of a picture coding unit according to the embodiment.

FIG. 28 is a diagram illustrating a configuration of a transmission device in which the hierarchy video coding device is mounted, and a reception device in which the hierarchy video decoding device is mounted. FIG. 28(a) illustrates the transmission device in which the hierarchy video coding device is mounted. FIG. 28(b) illustrates the reception device in which the hierarchy video decoding device is mounted.

FIG. 29 is a diagram illustrating a configuration of a recording device in which the hierarchy video coding device is mounted, and a reproduction device in which the hierarchy video decoding device is mounted. FIG. 29(a) illustrates the recording device in which the hierarchy video coding device is mounted. FIG. 29(b) illustrates the reproduction device in which the hierarchy video decoding device is mounted.

### DESCRIPTION OF EMBODIMENTS

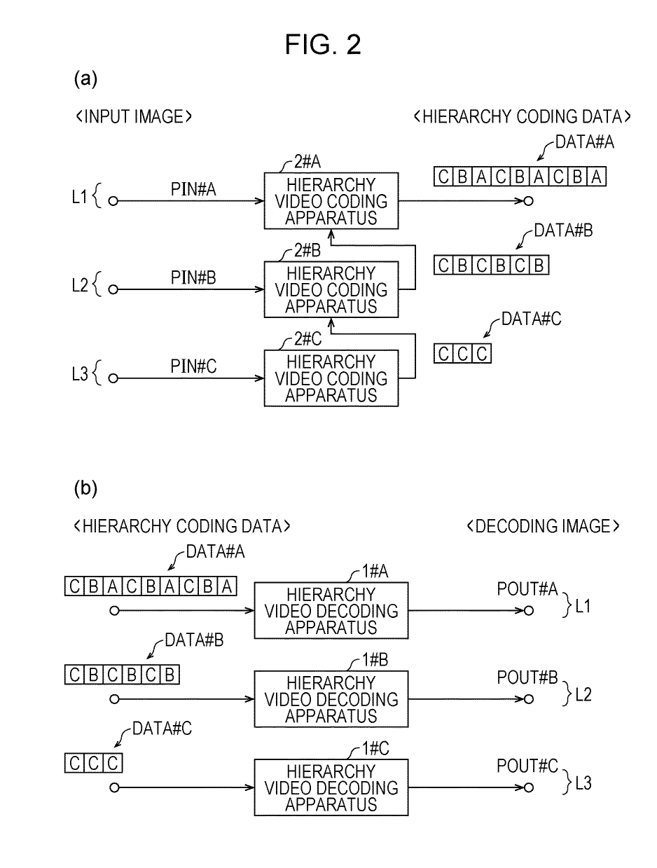

A hierarchy video decoding device 1 and a hierarchy video coding device 2 according to an embodiment of the present invention will be described as follows, with reference to FIGS. 2 to 29.

[Outline]

The hierarchy video decoding device (image decoding device) 1 according to the embodiment decodes coding data which has been obtained by hierarchy coding of the hierarchy video coding device (image coding device) 2. The hierarchy coding means a coding method in which a video is hierarchically coded from a video having low quality to a video having high quality. The hierarchy coding is standardized in, for example, SVC or SHVC. The quality of a video referred here broadly means an element of subjectively and objectively having an influence on a visual aspect of a video. As the quality of a video, for example, “resolution”, “frame rate”, “image quality”, and “expression precision of a pixel” are included. Thus, in the following descriptions, a statement that quality of video is different indicates that, for example, “resolution” and the like are different. However, it is not limited thereto. For example, in a case of videos quantized by different quantizing steps (that is, in a case of videos coded by different coding noises), it may be stated that quality of the videos is different from each other.

The hierarchy coding technology is classified into (1) spatial scalability, (2) temporal scalability, (3) SNR (Signal to Noise Ratio) scalability, and (4) view scalability. The spatial scalability is a technology of performing hierarchy in resolution or a size of an image. The temporal scalability is a technology of performing hierarchy in a frame rate (number of frames during a unit time). The SNR scalability is a technology of performing hierarchy in a coding noise. The view scalability is a technology of performing hierarchy in a position of a viewpoint correlated with each image.

Before the hierarchy video coding device 2 and the hierarchy video decoding device 1 according to the embodiment are described in detail, firstly, (1) a layer structure of hierarchy coding data which is generated by the hierarchy video coding device 2, and is decoded by the hierarchy video decoding device 1 will be described. Then, (2) a specific example of a data structure which may be employed in each layer will be described.

[Layer Structure of Hierarchy Coding Data]

Here, coding and decoding of hierarchy coding data will be described as follows, by using FIG. 2. FIG. 2 is a schematic diagram illustrating a case where a video is hierarchically coded/decoded by three level layers of a lower layer L3, a middle layer L2, and a higher layer L1. That is, in the example illustrated in FIGS. 2(a) and 2(b), among the three level layers, the higher layer L1 is the top layer, and the lower layer L3 is the bottom layer.

In the following descriptions, a decoding image which corresponds to specific quality and may be decoded from hierarchy coding data is referred to as a decoding image having a specific level (or a decoding image corresponding to the specific level) (for example, decoding image POUT#A of a higher layer L1).

FIG. 2(a) illustrates hierarchy video coding devices 2#A to 2#C that respectively and hierarchically code input images PIN#A to PIN#C, and generate pieces of coding data DATA#A to DATA#C. FIG. 2(b) illustrates hierarchy video decoding devices 1#A to 1#C that respectively decode pieces of coding data DATA#A to DATA#C which have been hierarchically coded, and generate decoding images POUT#A to POUT#C.

Firstly, the coding device side will be described with reference to FIG. 2(a). Regarding input images PIN#A, PIN#B, and PIN#C which function as inputs of the coding device side, original images are the same as each other, but quality (resolution, frame rate, image quality, and the like) of the images is different from each other. The quality of the images is reduced in an order of the input images PIN#A, PIN#B, and PIN#C.

The hierarchy video coding device 2#C for the lower layer L3 codes the input image PIN#C of the lower layer L3, and generates the coding data DATA#C of the lower layer L3. Base information required for decoding the decoding image POUT#C of the lower layer L3 is included (indicated by “C” in FIG. 2). Since the lower layer L3 is the bottom layer, the coding data DATA#C of the lower layer L3 is also referred to as base coding data.

The hierarchy video coding device 2#B for the middle layer L2 codes the input image PIN#B of the middle layer L2 with reference to the coding data DATA#C of the lower layer, and generates the coding data DATA#B of the middle layer L2. In addition to the base information “C” which is included in the coding data DATA#C, additional information (indicated by “B” in FIG. 2) required for decoding the decoding image POUT#B of the middle layer is included in the coding data DATA#B of the middle layer L2.

The hierarchy video coding device 2#A for the higher layer L1 codes the input image PIN#A of the higher layer L1 with reference to the coding data DATA#B of the middle layer L2, and generates the coding data DATA#A of the higher layer L1. In addition to the base information “C” required for decoding the decoding image POUT#C of the lower layer L3, and to the additional information “B” required for decoding the decoding image POUT#B of the middle layer L2, additional information (indicated by “A” in FIG. 2) required for decoding the decoding image POUT#A of the higher layer is included in the coding data DATA#A of the higher layer L1 higher layer L1.

As described above, the coding data DATA#A of the higher layer L1 includes information regarding a plurality of decoding images which have different quality.

Next, the decoding device side will be described with reference to FIG. 2(b). In the decoding device side, the decoding devices 1#A, 1#B, and 1#C decode pieces of coding data DATA#A, DATA#B, and DATA#C in accordance with each of the level layers (higher layer L1, middle layer L2, and lower layer L3), and outputs the decoding images POUT#A, POUT#B, and POUT#C.

Information of a portion of higher hierarchy coding data is extracted (also referred to as bitstream extraction). In the lower specific decoding device, the extracted information is decoded, and thus a video having specific quality can be reproduced.

For example, the hierarchy decoding device 1#B for the middle layer L2 may extract information (that is, “B” and “C” included in the hierarchy coding data DATA#A) required for decoding the decoding image POUT#B, from the hierarchy coding data DATA#A of the higher layer L1, and may decode the decoding image POUT#B. In other words, in the decoding device side, the decoding images POUT#A, POUT#B, and POUT#C can be decoded based on information which is included in the hierarchy coding data DATA#A of the higher layer L1.

The hierarchy coding data is not limited to the above hierarchy coding data of the three levels. The hierarchy coding data may be subjected to hierarchy coding at two levels, and may be subjected to hierarchy coding at levels of which the number is more than 3.

The hierarchy coding data may be configured such that a portion or the entirety of coding data relating to a decoding image of a specific level may be coded so as to be separated from other level, and decoding is completed without referring to information of the other level when the specific level layer is decoded. For example, in the example which has been described with reference to FIGS. 2(a) and 2(b), a case where the decoding image POUT#B is decoded with reference to “C” and “B” is described. However, it is not limited thereto. The hierarchy coding data may be configured so as to enable decoding of the decoding image POUT#B only by using “B”. For example, a hierarchy video decoding device in which hierarchy coding data configured only by “B” and the decoding image POUT#C are used as an input can be configured in order to decode the decoding image POUT#B.

In a case where SNR scalability is realized, hierarchy coding data having image quality in which decoding images POUT#A, POUT#B, and POUT#C are different from each other in a state where the same original image is used for input images PIN#A, PIN#B, and PIN#C can be generated. In this case, a hierarchy video coding device of the lower layer performs quantization of a prediction residual by using a quantization width which is wider than that in a hierarchy video coding device of the higher layer, and thus the hierarchy video coding device of the lower layer generates hierarchy coding data.

In this specification, for simple descriptions, terms as follows are defined. The following terms are used for presenting the following technical items, as long as there is no particular statement.

Profile: a profile is used for assuming a specific application and for defining a processing function which is to be included in a decoder based on the standard. The profile is defined by combination or a set of coding tools (element technologies). There are advantages by defining the profile, in that only an appropriate profile, not all rules, may be mounted in each application, and complexity of a decoder/encoder can be reduced.

Level: a level is used for defining an upper limit of processing capacity of a decoder or a range of a circuit size. The level defines the restriction of a parameter such as the maximum number of processed pixels per unit time, the maximum resolution of an image, the maximum bit rate, the maximum reference image buffer size, and the minimum compression ratio. That is, the level is for defining processing capacity of a decoder or complexity of a bitstream. The level also defines a range in which a tool which has been defined by each profile is supported. Thus, supporting a lower level is required at a higher level. Examples of various parameters of which levels are limited include the maximum luminance picture size (Max luma picture size), the maximum bitrate (Max bitrate), the maximum CPB size (Max CPB size), the maximum number of slice segments per picture unit (Max slice segments per picture), the maximum number of tile rows per picture unit (Max number of tile rows), the maximum number of tile columns per picture unit (Max number of tile columns). As various parameters which are applied for a specific profile and have limited levels, the maximum luminance sample rate (Max luma sample rate), the maximum bit rate (Max bit rate), and the minimum compression ratio (Mincompression Ratio) are exemplified. As a subconcept of the level, a “tier” is provided. The “tier” indicates whether the maximum bit rate of a bitstream (coding data) corresponding to each level, and the maximum CPB size for storing a bitstream have values defined by the main tier (for a consumer) or values defined by a high tier (for a work).

HRD (Hypothetical Reference Decoder): HRD is a virtual model of a decoder, focused on an operation of a buffer. The HRD may be also referred to as a buffer model. The HRD is configured by (1) a coded picture buffer (CPB), (2) a decoding processing unit, (3) a decoded picture buffer (DPB), and (4) a cropping processing unit. The CPB is a transmission buffer of a bitstream. The decoding processing unit performs a decoding operation instantly. The DPB stores a decoded picture. The cropping processing unit performs cutting processing (processing of cutting only an effective area of an image).

A basic operation of the HRD is as follows.

(SA01) An input bitstream is accumulated into the CPB;
(SA02) Instant decoding processing is performed on an AU accumulated in the CPB;
(SA03) A decoded picture obtained by performing the instant decoding processing is stored in the DPB; and
(SA04) The decoded picture stored in the DPB is cropped and output.

HRD parameters: An HRD parameter is a parameter indicating a buffer model which is used for the HRD verifying whether an input bitstream satisfies a conformance condition.

Bitstream conformance: Bitstream conformance is a condition having a need to be satisfied by a bitstream which is decoded by a hierarchy video decoding device (here, the hierarchy video decoding device according to the embodiment of the present invention). Similarly, a bitstream generated by a hierarchy video coding device (here, the hierarchy video coding device according to the embodiment of the present invention) is needed to satisfy the bitstream conformance in order to ensure that the generated bitstream is a bitstream which can be decoded by the hierarchy video decoding device.

VCL NAL unit: A VCL (Video Coding Layer) NAL unit is an NAL unit which includes coding data of a video (picture signal). For example, slice data (coding data of a CTU) and header information (slice header) are included in a VCL NAL unit. The header information is commonly used through decoding of the slice.

Non-VCL NAL unit: A non-VCL (non-Video Coding Layer) NAL unit is an NAL unit which includes header information or coding data such as auxiliary information SEI. The header information is a set of coding parameters such as a video parameter set VPS, a sequence parameter set SPS, and a picture parameter set PPS, which are used when each sequence or each picture is decoded.

Layer identifier: A layer identifier (also referred to as a layer ID) is used for identifying a level (layer). The layer identifier has one-to-one correspondence with the layer. An identifier used for selecting partial coding data is included in hierarchy coding data. The partial coding data is required for decoding a decoding image of a specific level. A subset of hierarchy coding data associated with a layer identifier which corresponds to a specific layer is also referred to as a layer expression.

Generally, a layer expression of a level layer and/or a layer expression corresponding to a lower layer of the level layer are used when a decoding image of a specific level layer is decoded. That is, a layer expression of a target layer and/or a layer expression of one or more level layers which are included in a lower layer of the target layer are used when a decoding image of a target layer is decoded.

Layer: The layer is one of a set of a VCL NAL UNIT having a value (nuh_layer_id, nuhLayerId) of a layer identifier of a specific level layer (layer), and a non-VCL NAL UNIT associated with the VCL NAL unit, or a set of syntax structure having a hierarchical relation.

Higher layer: A layer positioned higher than a certain layer is referred to as a higher layer. For example, in FIG. 2, a higher layer of the lower layer L3 is the middle layer L2 and the higher layer L1. A decoding image of the higher layer means a decoding image having higher quality (for example, resolution is high, a frame rate is high, and image quality is high).

Lower layer: A layer positioned lower than a certain layer is referred to as a lower layer. For example, in FIG. 2, a lower layer of the higher layer L1 is the middle layer L2 and the lower layer L3. A decoding image of the lower layer means a decoding image having lower quality.

Target layer: A target layer means a layer set as a target of decoding or coding. A decoding image corresponding to the target layer is referred to as a target layer picture. Pixels constituting the target layer picture are referred to as target layer pixels.

Reference layer: A specific lower layer used as a reference when a decoding image corresponding to a target layer is decoded is referred to as a reference layer. A decoding image corresponding to the reference layer is referred to as a reference layer picture. Pixels constituting the reference layer are referred to as reference layer pixels.

In the example illustrated in FIGS. 2(a) and 2(b), a reference layer of the higher layer L1 is the middle layer L2 and the lower layer L3. However, it is not limited thereto, and hierarchy coding data can be configured so as to allow decoding of a specific layer without referring to all lower layers. For example, hierarchy coding data may be configured so as to cause either of the middle layer L2 and the lower layer L3 to be set as the reference layer of the higher layer L1. The reference layer can be expressed as being a layer which is used (referred to) when a coding parameter and the like which are used in decoding of a target layer is predicted, and is different from a target layer. A reference layer which is directly referred to in inter-layer prediction of a target layer may be referred to as a direct reference layer. A direct reference layer B which is referred to in inter-layer prediction of a direct reference layer A of a target layer may be also referred to as an indirect reference layer of the target layer because the target layer indirectly depends on the direct reference layer B. In other words, in a case where a layer i indirectly depends on a layer j through one or a plurality of layers k (i<k<j), the layer j is the indirect reference layer of the layer i. The direct reference layer and the indirect reference layer for a target layer are collectively referred to as a dependency layer.

Base layer: A layer positioned at the bottom layer is referred to as a base layer. A decoding image of the base layer is a decoding image having the lowest quality, among images which may be decoded from coding data. The decoding image of the base layer is referred to as a base decoding image. In other words, the base decoding image is a decoding image corresponding to the level of the bottom layer. Partial coding data of hierarchy coding data required for decoding the base decoding image is referred to as base coding data. For example, the base information “C” included in the hierarchy coding data DATA#A of the higher layer L1 is the base coding data. The base layer is a layer which at least has the same layer identifier, and is formed from one or a plurality of VCL NAL units of which a value of the layer identifier (nuh_layer_id) is 0.

Extension layer (non-base layer): A higher layer of a base layer is referred to as an extension layer. The extension layer is a layer which at least has the same layer identifier, and is formed from one or a plurality of VCL NAL units of which a value of the layer identifier (nuh_layer_id) is more than 0.

Inter-layer prediction: Inter-layer prediction means that a syntax element value of a target layer, or a coding parameter and the like used in decoding of the target layer is predicted. The prediction is performed based on a syntax element value included in a layer expression of a level layer (reference layer), which is different from the layer expression of the target layer, a value derived by the syntax element value, and a decoding image. Inter-layer prediction in which information regarding motion prediction is predicted from information of a reference layer may be referred to as inter-layer motion information prediction. Inter-layer prediction in which prediction is performed from a decoding image of a lower layer may be referred to as inter-layer image prediction (or inter-layer texture prediction). A level layer used in the inter-layer prediction is a lower layer of a target layer, for example. Prediction which is performed in a target layer without using a reference layer may be referred to as intra-layer prediction.

Temporal identifier: A temporal identifier (temporal ID) is an identifier for identifying a layer (hereinafter, sublayer) which relates to temporal scalability. The temporal identifier is used for identifying a sublayer, and has one-to-one correspondence with a sublayer. A temporal identifier used for selecting partial coding data which is required for decoding a decoding image of a specific sublayer is included in coding data. Particularly, a temporal identifier of the highest-ordered (top) sublayer is referred to as the highest-ordered (top) temporal identifier (highest TemporalId, highestTid).

Sublayer: A sublayer is a layer which is specified by a temporal identifier and relates to temporal scalability. In order to distinguish scalability other than the temporal scalability, such as spatial scalability and SNR scalability, from each other, in the following descriptions, the above layer is referred to as a sublayer (also referred to as a temporal layer). In the following descriptions, the temporal scalability is assumed to be realized by a sublayer which is included in coding data of a base layer or hierarchy coding data required for decoding a certain layer.

Layer set: A layer set is a set of layers formed from one layer or more. Particularly, a configuration of the layer set is expressed by a layer ID list LayerSetLayerIdList[ ] (or LayerIdList[ ]). A layer ID (or index indicating an order of layers in a VPS) for identifying a layer included in the layer set is stored in each element in the layer ID list LayerIdList[K] (K=0 . . . N−1, N is the number of layers included in the layer set).

Output layer set: An output layer set is a set of layers for designating whether or not a layer included in the layer set is an output layer. The output layer set is also expressed as a set expressed by combination of a layer set and an output layer flag for designating an output layer. An output layer set identified by an identifier i is described below as an OLS#i.

Output layer: An output layer is a layer designated as that a decoding picture of the layer is output as an output picture, among layers set as targets of decoding or coding in the output layer set.

Alternative output layer: An alternative output layer is a layer in the output layer set, which is separate from an output layer, and has a decoding image used as an alternative and is output in a case where decoding of a decoding image of a layer designated as the output layer is not possible due to a certain reason.

Bitstream extraction processing: Bitstream extraction processing is processing in which a NAL unit which is not included in a set (referred to as a target set TargetSet) is removed (discarded) from a certain bitstream (hierarchy coding data, coding data), and a bitstream configured from a NAL unit included in the target set TargetSet is extracted. The set (referred to as a target set TargetSet) is determined by a target highest-ordered temporal identifier (highestTid) and a layer ID list LayerIdList[ ] which presents layers included in a target layer set. The bitstream extraction may be also referred to as sub-bitstream extraction.

The target highest-ordered temporal identifier is also referred to as TargetHighestTid. The target layer set is also referred to as TargetLayerSet. The layer ID list (target layer ID list) of the target layer set is also referred to as TargetLayerIdList. Particularly, a layer ID list set as a decoding target is also referred to as TargetDecLayerIdList. A bitstream which is generated by the bitstream extraction and is configured from a NAL unit included in the target set TargetSet is also referred to as coding data BitstreamToDecode.

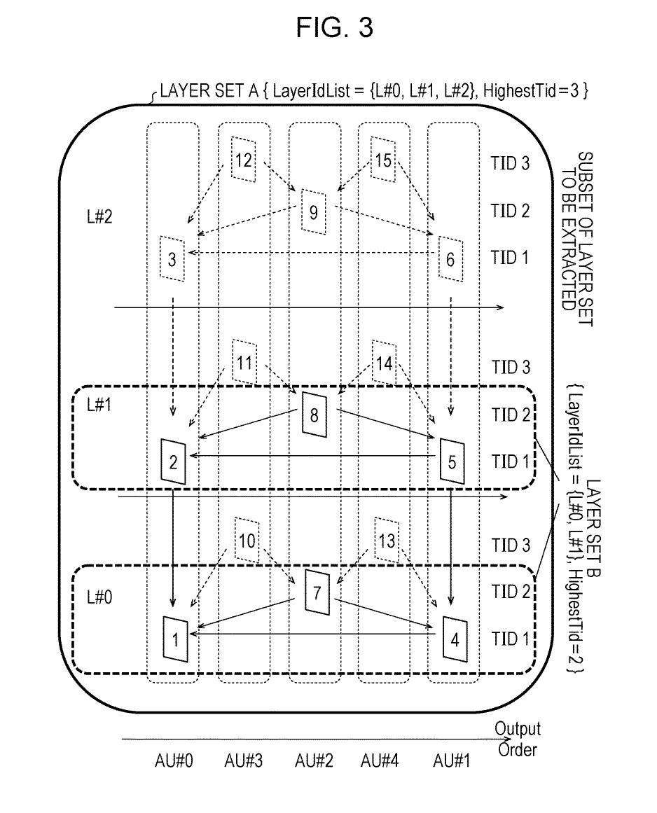

Next, an example in which hierarchy coding data including a layer set B which functions as a subset of a certain layer set A is extracted from hierarchy coding data including the layer set A by the bitstream extraction processing will be described with reference to FIG. 3.

FIG. 3 illustrates a configuration of a layer set A and a layer set B. The layer set A is formed from three layers (L#0, L#1, and L#2), and each of the three layers is formed from three sublayer (TID1, TID2, and TID3). The layer set B is a subset of the layer set A. Layers and sublayers constituting a layer set are indicated by {LayerIdList={L#0, . . . , L#N}, HighestTid=K}. For example, the layer set A in FIG. 3 is expressed as {LayerIdList={L#0, L#1, L#2}, HighestTid=3}. Here, the sign L#N indicates a certain layer N. Each box in FIG. 3 indicates a picture. The number in the box indicates an example of a decoding order. The number N in a picture is described as P#N.

An arrows between pictures indicates a dependency direction (reference relation) between the pictures. If an arrow is provided in the same layer, this indicates that pictures are reference pictures used in inter-prediction. If an arrow is provided between layers, this indicates that pictures are reference pictures (also referred to as reference layer pictures) used in inter-layer prediction.

An AU in FIG. 3 indicates an access unit. The sign #N indicates an access unit number. If an AU at a certain start point (for example, random access start point) is set as AU#0, AU#N indicates to be the (N−1)th access unit, and indicates an order of an AU included in a bitstream. That is, in the example of FIG. 3, access units are arranged on the bitstream in an order of AU#0, AU#1, AU#2, AU#3, AU#4, and . . . . The access unit indicates a set of NAL units, which is integrated in accordance with a specific classification rule. AU#0 in FIG. 3 can be considered as a set of VCL NALs which include coding data of pictures P#1, P#1, P#3. The access unit will be described below in detail. In the specification, in a case where describing as an X-th order is performed, it is assumed that the leading element has the 0-th order, and counting is performed from the 0-th order (similar in the following descriptions).

In the example of FIG. 3, since the target set TargetSet(layer set B) is {LayerIdList={L#0, L#1}, HighestTid=2}, a layer which is not included in the target set TargetSet, and a sublayer having a temporal ID larger than the highest-ordered temporal ID (HighestTid=2) are discarded from a bitstream including the layer set A, by the bitstream extraction. That is, the layer L#2 which is not included in the layer ID list and NAL units which include the sublayer (TID3) are discarded. Finally, a bitstream including the layer set B is extracted. In FIG. 3, a box of a dot line indicates the discarded picture. An arrow of a dot line indicates a dependency direction between the discarded picture and the reference picture. Because the layer L#3 and the NAL unit constituting the picture of the sublayer of TID3 are completely discarded, dependency relation has been cut already.

In the SHVC or the MV-HEVC, the concepts of a layer and a sublayer are applied for realizing SNR scalability, spatial scalability, temporal scalability, and the like. As already illustrated in FIG. 3, in a case where a frame rate and the temporal scalability is realized, firstly, coding data of a picture (highest-ordered temporal ID (TID3)) which is not referred to is discarded from other pictures by the bitstream extraction processing. In a case of FIG. 3, pieces of coding data of pictures (10, 13, 11, 14, 12, and 15) are discarded, and thus coding data of which the frame rate is reduced to ½ is generated.

In a case where the SNR scalability, the spatial scalability, or the view scalability is realized, coding data of a layer, which is not included in target set TargetSet is discarded by bitstream extraction, and thus it is possible to change granularity of the scalability. In a case of FIG. 3, pieces of coding data of pictures (3, 6, 9, 12, and 15) are discarded, and thus coding data in which the granularity of the scalability is increased is generated. The above process is repeated, and thus it is possible to gradually adjust granularity of a layer and a sublayer.

The above-described terms are used just for simple descriptions, and the above-described technical items may be expressed by other terms.

[Data Structure of Hierarchy Coding Data]

A case of using HEVC and an extension method thereof is exemplified below as a coding method of generating coding data of each level layer. However, it is not limited thereto, and the coding data of each level layer may be generated by a coding method such as MPEG-2 and H.264/AVC.

The lower layer and the higher layer may be coded by different coding methods. The coding data of each level layer may be supplied to the hierarchy video decoding device 1 through different channels, and may be supplied to the hierarchy video decoding device 1 through the same channel.

For example, in a case where a ultra-high definition video (video, 4K video data) is subjected to scalable coding by using a base layer and one extension layer, and is transmitted, regarding the base layer, 4K video data may be subjected to down scaling, and interlaced video data may be coded by MPEG-2 or H.264/AVC, and may be transmitted on a television broadcasting network. Regarding the extension layer, a 4K video (progressive) may be coded by HEVC, and may be transmitted on the Internet.

<Structure of Hierarchy Coding Data DATA>

Before the image coding device 2 and the image decoding device 1 according to the embodiment will be described in detail, a data structure of hierarchy coding data DATA which is generated by the image coding device 2 and is decoded by the image decoding device 1 will be described.

(NAL Unit Layer)

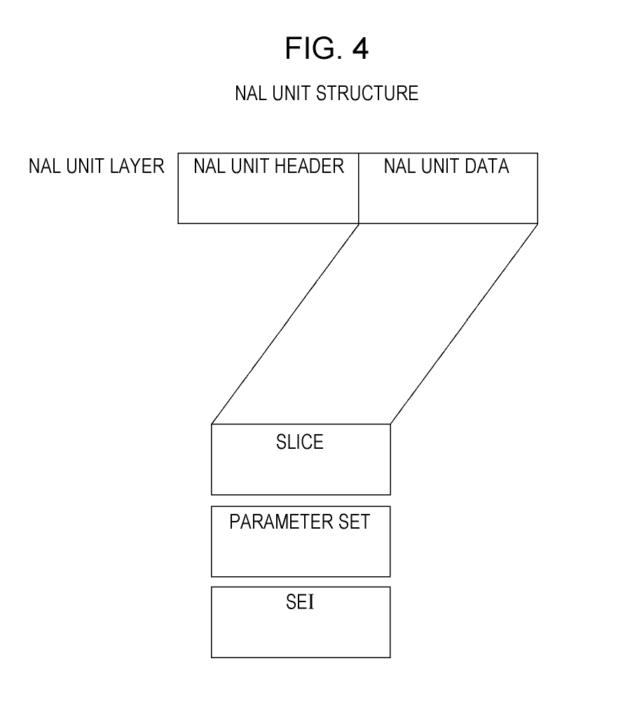

FIG. 4 is a diagram illustrating a hierarchy structure of data in the hierarchy coding data DATA. The hierarchy coding data DATA is coded in a unit which may be referred to as a network abstraction layer (NAL) unit.

A NAL is a layer provided for abstracting communication between a video coding layer (VCL) and a lower system. The VCL is a layer in which video coding processing is performed. In the lower system, coding data is transmitted and accumulated.

The VCL is a layer in which image coding processing is performed. In the VCL, coding is performed. The lower system referred herein corresponds to a file format of H.264/AVC and HEVC or an MPEG-2 system. In an example described below, the lower system corresponds to decoding processing in the target layer and the reference layer. A bitstream generated in the VCL is divided in a unit which is referred to as a NAL unit, in the NAL, and is transmitted to a lower system set as a destination.

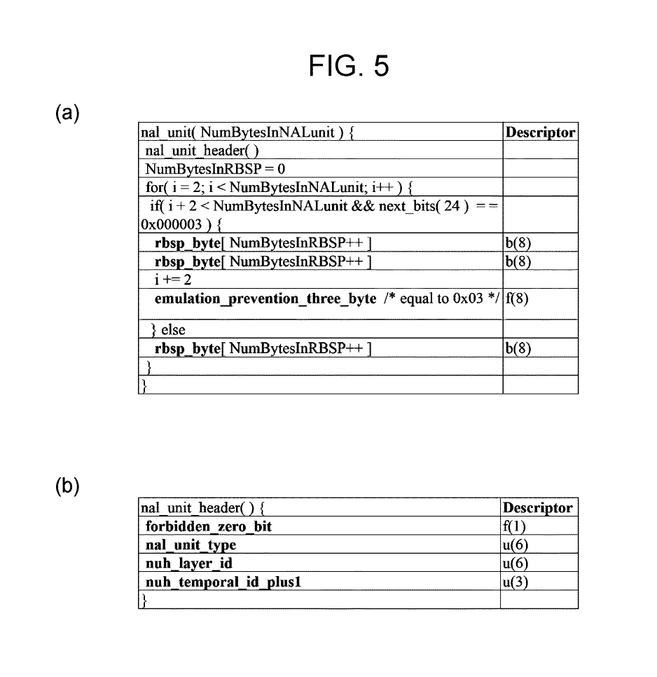

FIG. 5(a) illustrates a syntax table of a NAL unit. Coding data coded in a VCL, and a header (NAL unit header: nal_unit_header( ) for appropriately sending the coding data to a lower system as a destination are included in the NAL unit. A NAL unit header is expressed by, for example, a syntax illustrated in FIG. 5(b). “nal_unit_type”, “nuh_temporal_id_plus1”, or “nuh_layer_id” (or nuh_reserved_zero_6 bits) is described in the NAL unit header. “nal_unit_type” indicates the type of coding data stored in a NAL unit. “nuh_temporal_id_plus1” indicates an identifier (temporal identifier) of a sublayer to which the stored coding data belongs. “nuh_layer_id” indicates an identifier (layer identifier) of a layer to which the stored coding data belongs. A parameter set, an SEI, a slice, and the like (which will be described later) are included in the NAL unit data.

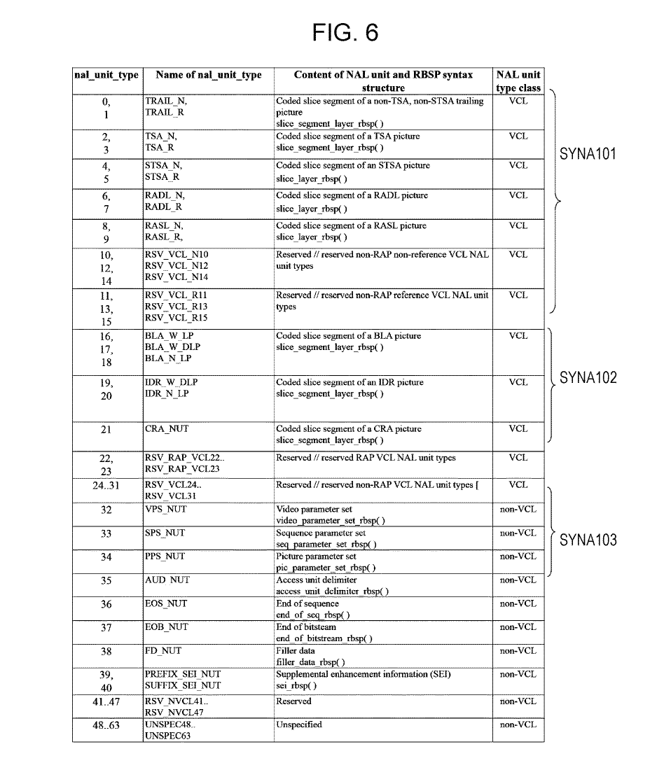

FIG. 6 is a diagram illustrating a relation between a value of a NAL unit type and the type class of a NAL unit. As illustrated in FIG. 6, NAL units of NAL unit types having values of 0 to 15 which are indicated by SYNA101 correspond to slices of a non-RAP (random access picture). NAL units of NAL unit types having values of 16 to 21 which are indicated by SYNA102 correspond to slices of a RAP (random access picture, IRAP picture). The RAP picture is roughly divided into a BLA picture, an IDR picture, and a CRA picture. The BLA picture is further classified into BLA_W_LP, BLA_W_DLP, and BLA_N_LP. The IDR picture is further classified into IDR_W_DLP and IDR_N_LP. As a picture other than the RAP picture, a leading picture (LP picture), a temporal access picture (TSA picture, STSA picture), a trailing picture (TRAIL picture), and the like are provided. Coding data at each level is subjected to NAL multiplexing by being stored in a NAL unit, and is transmitted to the hierarchy video decoding device 1.

As illustrated in FIG. 6, particularly, illustrated in the NAL Unit Type Class, each NAL unit is classified into data (VCL data) constituting a picture and data (non-VCL) other than the VCL data, in accordance with a NAL unit type. All pictures regardless of a picture type such as a random access picture, a leading picture, and a trailing picture are classified as a VCL NAL unit. A parameter set, an SEI, an access unit delimiter (AUD), an end of a sequence (EOS), an end of a bitstream (EOB) are classified as a non-VCL NAL unit. The parameter set is data required for decoding a picture. The SEI is auxiliary information of the picture. The AUD, the EOS, the EOB, and the like are used for presenting division of a sequence.

(Access Unit)

A set of NAL units which are integrated in accordance with a specific classification rule is referred to as an access unit. In a case where the number of layers is 1, the access unit is a set of NAL unit constituting one picture. In a case where the number of layers is more than 1, the access unit is a set of NAL units constituting pictures of a plurality of layers at the same time (same output timing). In order to indicate division of an access unit, coding data may include a NAL unit which may be referred to as an access unit delimiter (AUD). The access unit delimiter is included between a set of NAL units constituting an access unit in the coding data, and a set of NAL units constituting another access unit.

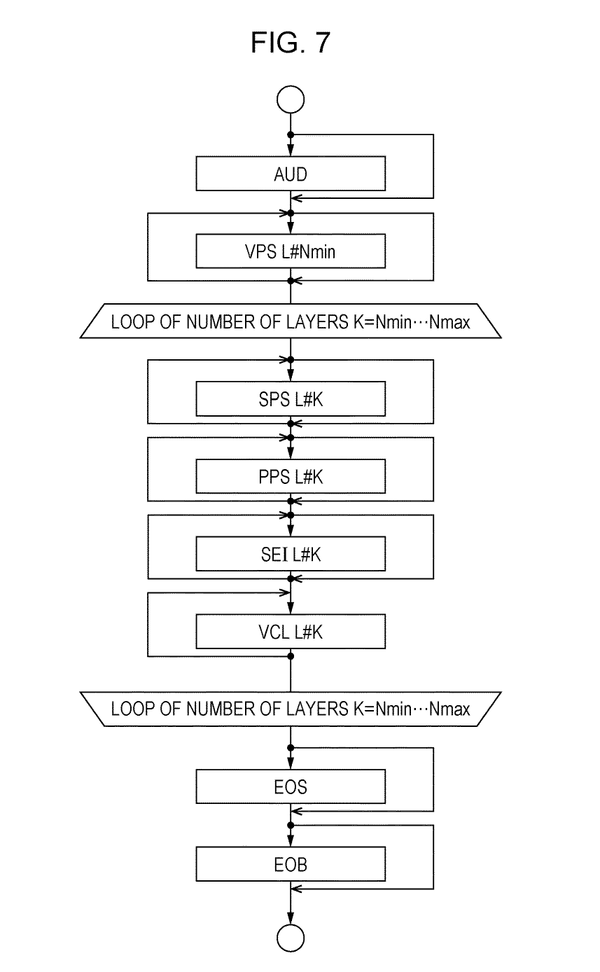

FIG. 7 is a diagram illustrating an example of a configuration of a NAL unit included in an access unit. In FIG. 7, an AU is configured by NAL units such as an access unit delimiter (AUD), various parameter sets (VPS, SPS, and PPS), various SEIs (Prefix SEI and Suffix SEI), a VCL (slice) or a VCL, an EOS (End of Sequence), and an EOB (End of Bitstream). The access unit delimiter (AUD) indicates the leading of the AU. The VCL (slice) constitutes one picture in a case where the number of layers is 1. The VCL constitutes pictures of the number of layers in a case where the number of layers is more than 1. The EOS (End of Sequence) indicates a termination of a sequence. The EOB (End of Bitstream) indicates a termination of a bitstream. In FIG. 7, the sign L#K (K=Nmin . . . Nmax) attached to a VPS, an SPS, SEI, or a VCL indicates a layer ID (or index indicating an order of a layer which is defined on the VPS). In the example in FIG. 7, In an AU, an SPS, a PPS, SEI, and a VCL of each of a layer L#Nmin to a layer L#Nmax are provided except for the VPS, in the ascending order of the layer ID (or index indicating an order of a layer which is defined on the VPS). In the example in FIG. 7, the VPS is sent with only the lowest-ordered layer ID. In FIG. 7, an arrow indicates whether a specific NAL unit is provided in an AU, or a NAL unit is repeatedly provided.

For example, if a specific NAL unit is provided in an AU, this is indicated by an arrow which passes through the NAL unit. If a specific NAL unit is not provided in an AU, this is indicated by an arrow which skips the NAL unit. For example, an arrow which does not pass through an AUD and is directed toward a VPS indicates a case where an AUD is not provided in an AU. An arrow which passes through a VCL and returns to the VCL indicates a case where one VCL or more are provided.

A VPS which has a higher layer ID other than the lowest order may be included in an AU. However, it is assumed that the image decoding device ignores a VPS having a layer ID other than the lowest order. As illustrated in FIG. 7, the various parameter sets (VPS, SPS, and PPS) or the SEI which is auxiliary information may be included as a portion of an access unit, or may be transmitted to a decoder by the means which is different from the means for a bitstream. FIG. 7 illustrates just an embodiment of a configuration of a NAL unit included in an access unit. The configuration of a NAL unit included in an access unit may be changed in a range in which decoding of a bitstream is possible.

Particularly, an access unit including an IRAP picture of layer identifier nuhLayerId=0 is referred to as an IRAP access unit (random access point•access unit). An IRAP access unit for initializing decoding processing of all layers included in a target set is referred to as an initialization IRAP access unit. A set of access units (excluding the next initialization IRAP access unit) of non-initialization IRAP access units (access units other than the initialization IRAP access unit) of which the number is equal to or more than 0 and which continue from the initialization IRAP access unit to the next initialization IRAP access unit in a decoding order is also referred to as a CVS (Coded Video Sequence; below also referred to as a sequence SEQ).

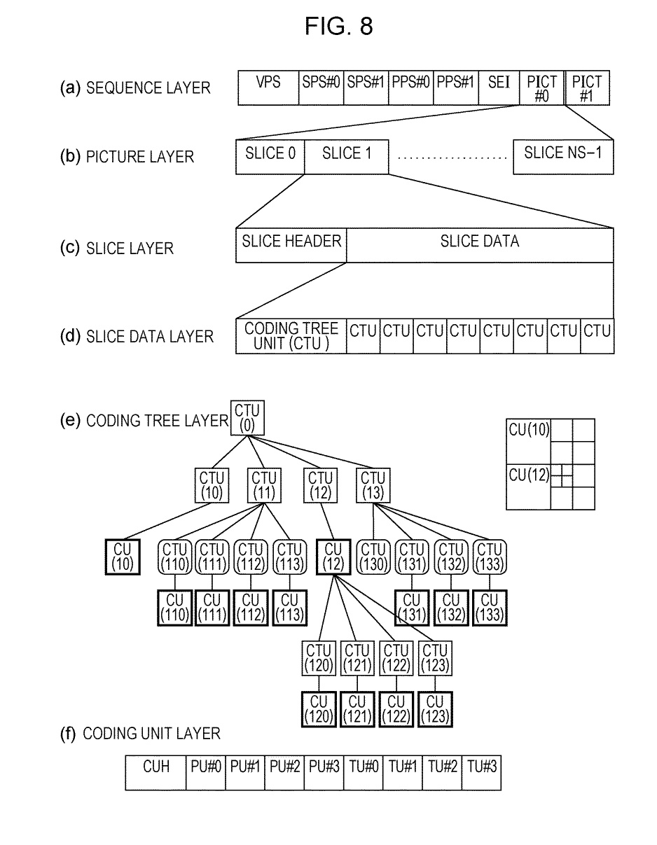

FIG. 8 is a diagram illustrating a hierarchy structure of data in the hierarchy coding data DATA. The hierarchy coding data DATA includes a sequence and a plurality of pictures constituting the sequence, for example. FIGS. 8(a) to 8(f) are respectively diagrams illustrating a sequence layer for predetermining a sequence SEQ, a picture layer for defining a picture PICT, a slice layer for defining a slice S, a slice data layer for defining slice data, a coding tree layer for defining a coding tree unit which is included in the slice data, and a coding unit layer for defining a coding unit (CU) which is included in the coding tree.

(Sequence Layer)

A set of pieces of data to which the image decoding device 1 refers in order to decoding a sequence SEQ (below also referred to as a target sequence) set as a processing target is defined in a sequence layer. As illustrated in FIG. 8(a), the sequence SEQ includes a video parameter set, a sequence parameter set SPS, a picture parameter set PPS, a picture PICT, and supplemental enhancement information SEI. A value attached to # herein indicates a layer ID. FIG. 8 illustrates an example in which #0 and #1, that is, coding data in which the layer ID is 0, and coding data in which the layer ID is 1 are provided. However, the type of the layer and the number of layers are not limited thereto.

(Video Parameter Set)

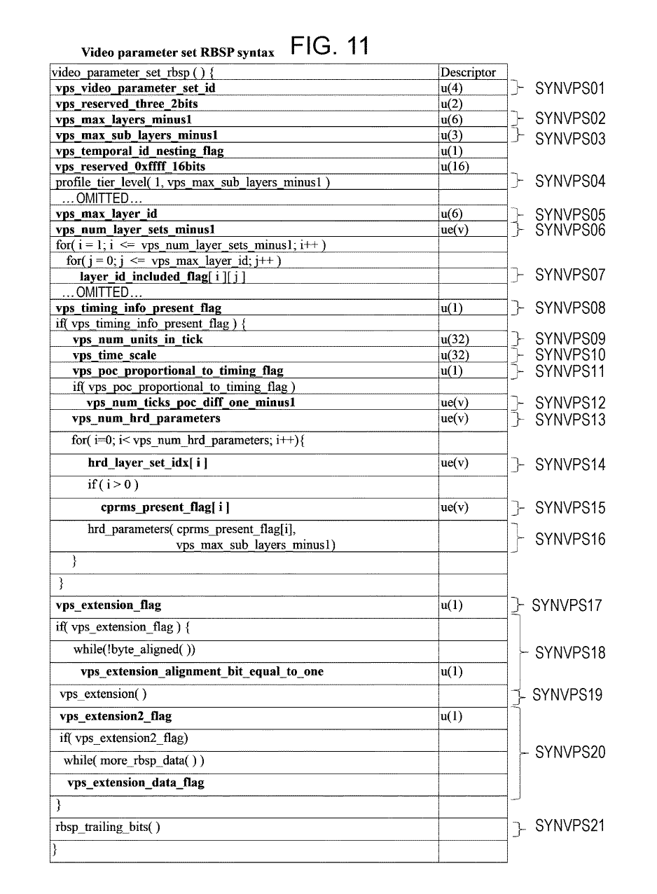

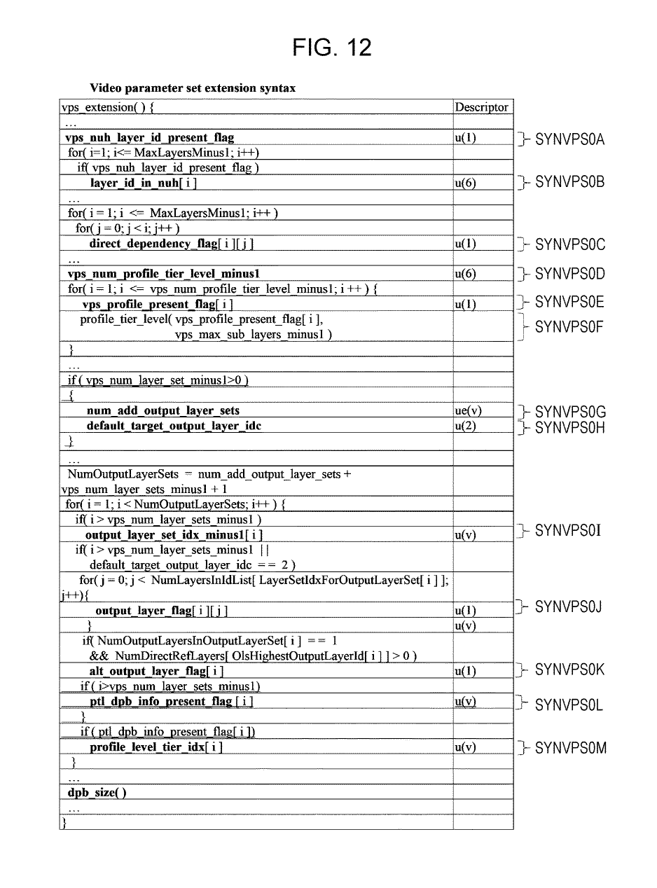

FIG. 11 illustrates an example of a syntax table of a video parameter set VPS. FIG. 12 illustrates an example of a syntax table of enhancement data of the video parameter set VPS. In the video parameter set VPS, a set of coding parameters to which the image decoding device 1 refers in order to decode coding data which is configured from one or more layers is defined. For example, the followings are defined: a VPS identifier (video_parameter_set_id) (SYNVPS01 in FIG. 11) which is used for identifying a VPS to which a sequence parameter set (which will be described later) or another syntax element refers; the number (vps_max_layers_minus1) (SYNVPS02 in FIG. 11) of layers included in coding data; the number (vps_sub_layers_minus1) (SYNVPS03 in FIG. 11) of sublayers included in a layer; the number (vps_num_layer_sets_minus1) (SYNVPS06 in FIG. 11) of layer sets for defining a set of layers, which is expressed in the coding data, and is formed from one or more layers; layer set information (layer set, layer_id_included_flag[i][j]) (SYNVPS07 in FIG. 11) for defining a set of layers constituting a layer set; dependency relation between layers (direct dependency flag direct_dependency_flag[i][j]) (SYNVPS0C in FIG. 12); a set of output layers constituting an output layer set; output layer set information for defining PTL information and the like, (default output layer identifier default_target_output_layer_idc, associated layer set identifier output_layer_set_idx_minus1, output_layer_flag output_layer_flag[i][j], alternative output_layer_flag alt_output_layer_flag[i], PTL designation identifier profile_level_tier_idx[i], and the like) (SYNVPS0G to SYNVPS0M in FIG. 12). A plurality of VPSs may be provided in coding data. In this case, a VPS used for decoding is selected from a plurality of candidates, for each target sequence.

A VPS used for decoding a specific sequence which belongs to a certain layer may be referred to as an active VPS. As long as a particular statement is not made in the following descriptions, the VPS means an active VPS for a target sequence belonging to a certain layer.

(Sequence Parameter Set)

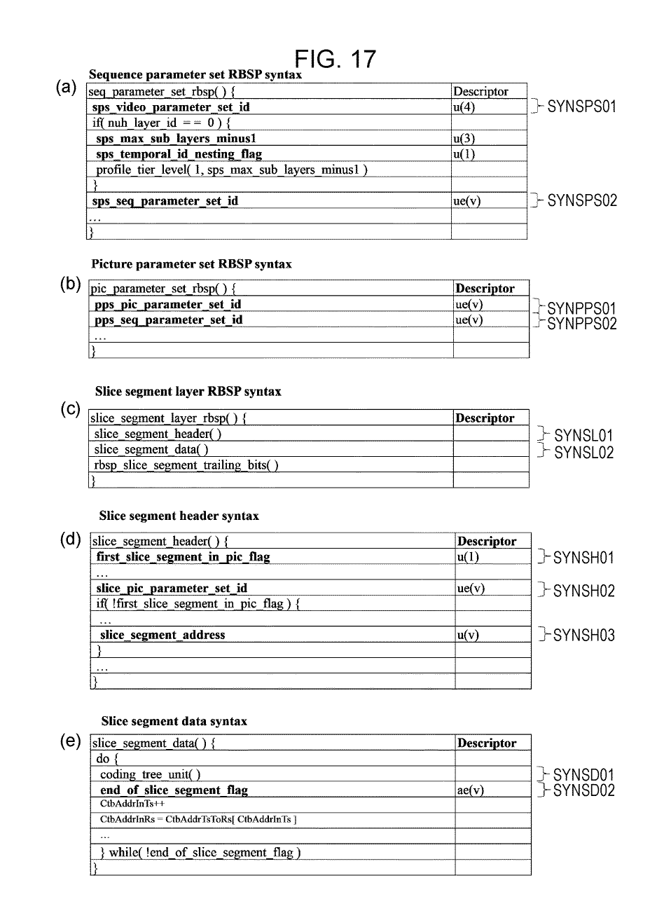

FIG. 17(a) illustrates an example of a syntax table of a sequence parameter set SPS. In the sequence parameter set SPS, a set of coding parameter to which the image decoding device 1 refers in order to decode a target sequence is defined. For example, the followings are defined: an active VPS identifier (sps_video_parameter_set_id) (SYNSPS01 in FIG. 17(a)) for indicating an active VPS to which a target SPS refers; an SPS identifier (sps_seq_parameter_set_id) (SYNSPS02 in FIG. 17(a)) for identifying an SPS to which a picture parameter set (which will be described later) or another syntax element refers; and the width or the height of a picture. A plurality of SPSs may be provided in coding data. In this case, an SPS used for decoding is selected from a plurality of candidates, for each target sequence.

An SPS used for decoding a specific sequence which belongs to a certain layer may be referred to as an active SPS. As long as a particular statement is not made in the following descriptions, the SPS means an active SPS for a target sequence belonging to a certain layer.

(Picture Parameter Set)

FIG. 17(b) illustrates an example of a syntax table of a picture parameter set PPS. In the picture parameter set PPS, a set of coding parameter to which the image decoding device 1 refers in order to decode each picture in a target sequence is defined. For example, the followings are defined: an active SPS identifier (pps_seq_parameter_set_id) (SYNPPS01 in FIG. 17(b)) for indicating an active SPS to which a target PPS refers; a PPS identifier (pps_pic_parameter_set_id) (SYNPPS02 in FIG. 17(b)) for identifying a PPS to which a slice header (which will be described later) or another syntax element refers; a reference value (pic_init_qp_minus26) of a quantization width, which is used for decoding a picture; a flag (weighted_pred_flag) indicating application of weighted prediction; and a scaling list (quantization matrix). A plurality of PPSs may be provided. In this case, any of the plurality of PPSs is selected from each picture in the target sequence.

A PPS used for decoding a specific picture which belongs to a certain layer may be referred to as an active PPS. As long as a particular statement is not made in the following descriptions, the PPS means an active PPS for a target picture belonging to a certain layer. The active SPS may be set to be a different SPS for each layer, and the active PPS may be set to be a different PPS for each layer. That is, decoding processing can be performed with reference to a different SPS or a different PPS for each layer.

(Picture Layer)

In a picture layer, a set of pieces of data to which the image decoding device 1 refers in order to decode a picture PICT (below also referred to as a target picture) set as a processing target is defined. As illustrated in FIG. 8(b), the picture PICT includes slices S0 to SNS−1 (NS is the total number of slices included in the picture PICT). In a case where the slices S0 to SNS−1 are not required for being distinguished from each other, the suffix of the signs may be omitted and descriptions will be made below. Regarding another piece of data which is data included in hierarchy coding data DATA (which will be described below) and has an attached suffix, descriptions will be similarly made.

(Slice Layer)

In a slice layer, a set of pieces of data to which the hierarchy video decoding device 1 refers in order to decode a slice S (also referred to as a target slice, slice segment) set as a processing target is defined. As illustrated in FIG. 8(c), the slice S includes a slice header SH and slice data SDATA.

A coding parameter group to which the hierarchy video decoding device 1 refers in order to determine a decoding method of a target slice is included in the slice header SH. FIG. 17(d) illustrates an example of a syntax table of a slice header. For example, an active PPS identifier (slice_pic_parameter_set_id) (SYNSH02 in FIG. 17(d)) is included. The active PPS identifier is used for designating a PPS (active PPS) referring in order to decode a target slice. An SPS to which an active PPS refers is designated by an active SPS identifier (pps_seq_parameter_set_id) which is included in the active PPS. Further, a VPS (active VPS) to which an active SPS refers is designated by an active VPS identifier (sps_video_parameter_set_id) which is included in the active SPS.

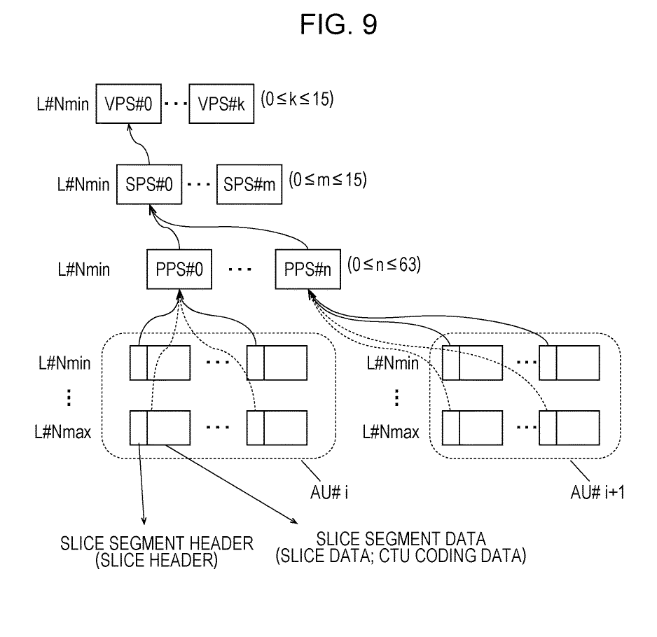

Activation of a parameter set will be described by using the example in FIG. 9. FIG. 9 illustrates a reference relation between header information and coding data which constitutes an access unit (AU). In the example in FIG. 9, each slice constituting a picture which belongs to a layer L#K (K=Nmin . . . Nmax) in each AU causes an active PPS identifier for designating a PPS to be referred to be included in a slice header, and a PPS (active PPS) which is used for decoding by using the identifier when decoding of each slice is started is designated (also refers to perform activation). Identifiers of a PPS, an SPS, and a VPS to which a slice in the same picture refers are required to be the same as each other. An active SPS identifier for designating an SPS (active SPS) which is to refer on the decoding processing is included in an activated PPS. An SPS (active SPS) which is used for decoding by using the identifier is designated. Similarly, an active VPS identifier for designating a VPS (active VPS) which is to refer on the decoding processing of a sequence belonging to each layer is included in an activated SPS. A VPS (active VPS) used for decoding by using the identifier is designated. With the above procedures, a parameter set required when decoding processing of coding data of each layer is performed is determined.

An identifier of a higher parameter set to which each header information (slice header SH, PPS, SPS) refers is not limited to the example in FIG. 9. In a case of a VPS, the identifier may be selected from k VPS identifiers (k=0 . . . 15). In a case of an SPS, the identifier may be selected from m SPS identifiers (m=0 . . . 15). In a case of a PPS, the identifier may be selected from n PPS identifiers (n=0 . . . 63).

Slice type designation information (slice_type) for designating a slice type is an example of a coding parameter included in the slice header SH.

As the slice type which may be designated by the slice type designation information, (1) an I slice only using intra-prediction when coding is performed, (2) a P slice using uni-directional prediction or intra-prediction when coding is performed, (3) a B slice using uni-directional prediction, bi-directional prediction, or intra-prediction, and the like are exemplified.

(Slice Data Layer)

In a slice data layer, a set of pieces of data to which the hierarchy video decoding device 1 refers in order to decode slice data SDATA set as a processing target is defined. As illustrated in FIG. 8(d), the slice data SDATA includes a coding tree block (CTB). The CTB is a block which constitutes a slice and has a fixed size (for example, 64×64). The CTB may be referred to as a largest cording unit (LCU).

(Coding Tree Layer)

As illustrated in FIG. 8(e), in the coding tree layer, a set of pieces of data to which the hierarchy video decoding device 1 refers in order to decode a coding tree block set as a processing target is defined. The coding tree unit is divided by recursive quad-tree division. A node having a tree structure obtained by the recursive quad-tree division is referred to as a coding tree. An intermediate node of the quad-tree is a coding tree unit (CTU), and the coding tree block itself is defined as the top CTU. The CTU includes a split flag (split_flag). In a case where split_flag is 1, division into four coding tree units CTU is performed. In a case where split_flag is 0, the coding tree unit CTU is divided into four coding units (CUs). The coding unit CU is a terminal node of the coding tree layer. In this layer, division is not performed more. The coding unit CU functions as a basic unit for coding processing.

A partial area on a target picture which is decoded in a coding tree unit is referred to as a coding tree block (CTB). A CTB corresponding to a luminance picture which is a luminance component of a target picture may be referred to as a luminance CTB. In other words, a partial area on a luminance picture which is decoded from the CTU may be referred to as a luminance CTB. A partial area on a luminance picture corresponding to a chroma picture which is decoded from the CTU may be referred to as a chroma CTB. Generally, if a color format of an image is determined, the luminance CTB size and the chroma CTB size can be mutually transformed. For example, in a case where the color format is 4:2:2, the chroma CTB size is the half of the luminance CTB size. In the following descriptions, as long as particular statement is not made, a CTB size means the luminance CTB size. The CTU size is the luminance CTB size corresponding to a CTU.

(Coding Unit Layer)

As illustrated in FIG. 8(f), in the coding unit layer, a set of pieces of data to which the hierarchy video decoding device 1 refers in order to decode a coding unit as a processing target is defined. Specifically, the coding unit CU is configured from a CU header CUH, a prediction tree, and a transform tree. In the CU header CUH, for example, it is defined whether the coding unit is a unit using intra-prediction or a unit using inter-prediction. The coding unit functions as a root of the prediction tree (PT) and the transform tree (TT). An area on a picture, which corresponds to a CU may be referred to as a coding block (CB). A CB on a luminance picture is referred to as a luminance CB. A CB on a chroma picture is referred to as a chroma CB. The CU size (size of the coding node) means a luminance CB size.

(Transform Tree)

In a transform tree (below abbreviated to a TT), the position and the size of each of transform blocks which are obtained by dividing a coding unit CU into one or a plurality of transform blocks are defined. In other words, the transform block is one or a plurality of areas which constitute a coding unit CU and do not overlap each other. The transform tree includes one or a plurality of transform blocks which are obtained by the above-described division. Information regarding a transform tree which is included in a CU, and information enclosed in the transform tree are referred to as TT information.

As split performed in a transform tree, allocation of an area which has the same size of a coding unit, as a transform block, and division by the recursive quad-tree division (similar to the above-described division of a tree block) are provided. Transform processing is performed for each transform block. A transform block which is a unit of transform is also referred below to as a transform unit (TU).

A transform tree TT includes TT split information SP_TT and quantization prediction residuals QD 1 to QD NT (NT is the total number of transform units TU included in a target CU). The TT split information SP_TT is used for designating a split pattern of a target CU into transform blocks.

Specifically, the TT split information SP_TT is information for determining the shape of each of transform blocks included in a target CU, and a position of each of the transform blocks in the target CU. For example, the TT split information SP_TT can be realized by information (split_transform_unit_flag) and information (trafoDepth). The information (split_transform_unit_flag) indicates whether or not a target node is split. The information (trafoDepth) indicates a depth of the split.

Each quantization prediction residual QD is coding data generated in such a manner that the hierarchy video coding device 2 performs the following processing 1 to 3 on a target block which is a transform block set as a processing target.

Processing 1: Frequency transform (for example, discrete cosine transform (DCT transform), discrete sine transform (DST transform), and the like) is performed on a prediction residual obtained by subtracting a predicted image from a coding target image;

Processing 2: A transform coefficient obtained by Processing 1 is quantized;
Processing 3: A transform coefficient quantized by Processing 2 is subjected to variable length coding;
The above-described quantization parameter qp indicates the size of a quantization step QP used when the hierarchy video coding device 2 quantizes the transform coefficient (QP=2^{qp/6}).

(Prediction Tree)

In a prediction tree (below abbreviated to a PT), the position and the size of each of prediction blocks which are obtained by dividing a coding unit CU into one or a plurality of prediction blocks are defined. In other words, the prediction block is one or a plurality of areas which constitute a coding unit CU and do not overlap each other. The prediction tree includes one or a plurality of prediction blocks which are obtained by the above-described division. Information regarding a prediction tree which is included in a CU, and information enclosed in the prediction tree are referred to as PT information.

Prediction processing is performed for each prediction block. A prediction block which is a unit of prediction is also referred below to as a prediction unit (PU).

As a type of split performed in a prediction tree, there are two cases of a case of intra-prediction and a case of inter-prediction. The intra-prediction is prediction in the same picture. The inter-prediction performs an instruction of prediction processing which is performed between pictures different from each other (for example, between display points of time, between layer images). That is, in the inter-prediction, a predicted image is generated from a decoding image on a reference picture by using either of a reference picture (reference picture in a layer) of a layer which is the same as a target layer and a reference picture (reference picture between layers) on a reference layer of a target layer, as the reference picture.

In a case of the intra-prediction, as a split method, 2N×2N (the same size as a coding unit) and N×N are provided.

In a case of the inter-prediction, as a split method, 2N×2N (the same size as a coding unit), 2N×N, 2N×nU, 2N×nD, N×2N, nL×2N, nR×2N, N×N, and the like which are coded by part mode of coding data are provided.

(Prediction Parameter)

A predicted image of a prediction unit is derived by a prediction parameter which appends to the prediction unit. As the prediction parameter, a prediction parameter for the intra-prediction and a prediction parameter for the inter-prediction are provided.

An intra-prediction parameter is a parameter for restoring intra-prediction (prediction mode) for each intra-PU. As the parameter for restoring a prediction mode, mpm_flag, mpm_idx, and rem_idx are included. mpm_flag is a flag relating to a most probable mode (MPM, the same hereinafter). mpm_idx is an index for selecting a MPM. rem_idx is an index for designating a prediction mode other than the MPM.

An inter-prediction parameter is configured from prediction list use flags predFlagL0 and predFlagL1, reference picture indices refIdxL0 and refIdxL1, and vectors mvL0 and mvL1. The prediction list use flags predFlagL0 and predFlagL1 are flags indicating whether or not reference picture lists which may be respectively referred to as an L0 reference list and an L1 reference list are used. The reference picture list corresponding to a case where a value is 1 is used. In a case where two reference picture lists are used, that is, in a case of predFlagL0=1 and predFlagL1=1, corresponding to bi-prediction is performed. In a case where one reference picture list is used, that is, in a case of (predFlagL0, predFlagL1)=(1, 0) or (predFlagL0, predFlagL1)=(0, 1), corresponding to uni-prediction is performed.

(Example of Reference Picture List)

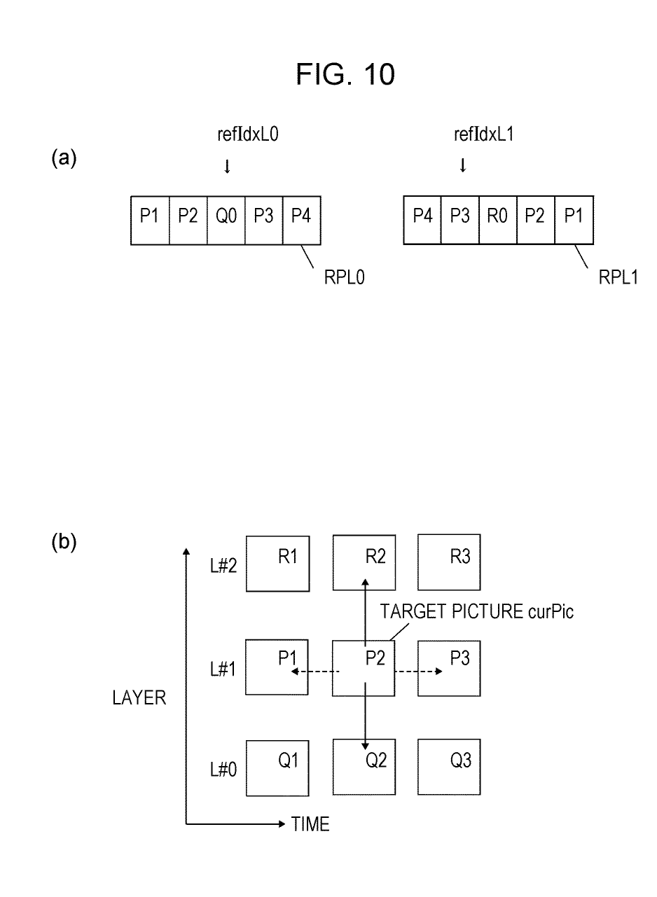

Next, an example of the reference picture list will be described. The reference picture list is a sequence formed from reference pictures stored in a decoded picture buffer. FIG. 10(a) is a conceptual diagram illustrating an example of the reference picture list. In a reference picture list RPL0, five rectangles which are arranged horizontally in series respectively indicate reference pictures. Signs P1, P2, Q0, P3, and P4 which are indicated in an order from the left end to the right are respectively signs indicating reference pictures. Similarly, in a reference picture list RPL1, signs P4, P3, R0, P2, and P1 which are indicated in an order from the left end to the right are respectively signs indicating reference pictures. P such as P1 indicates a target layer P. Q of Q0 indicates a layer Q which is different from the target layer P. Similarly, R of R0 indicates a layer R which is different from the target layer P and the layer Q. Suffixes of P, Q and R indicate picture ordering counts POC. A downward arrow right under refIdxL0 indicates that the reference picture index refIdxL0 is an index referring to the reference picture Q0 by the reference picture list RPL0 in the decoded picture buffer. Similarly, a downward arrow right under refIdxL1 indicates that the reference picture index refIdxL1 is an index referring to the reference picture P3 by the reference picture list RPL1 in the decoded picture buffer.

(Example of Reference Picture)

Next, an example of a reference picture used when a vector is derived will be described. FIG. 10(b) is a conceptual diagram illustrating an example of a reference picture. In FIG. 10(b), a horizontal axis indicates a display time and a vertical axis indicates the number of layers. Rectangles (total 9 pieces) of 3 columns by 3 rows, which are illustrated respectively indicate pictures. Among the 9 rectangles, the second rectangle from the left of the lower row indicates a picture (target picture) of a decoding target. The 8 remaining rectangles respectively indicate reference pictures. Reference pictures Q2 and R2 which are indicated by downward arrows from the target picture are pictures which have the same display time as the target picture and have a layer different from each other. In the inter-layer prediction in which a target picture curPic (P2) is used as a reference, the reference picture Q2 or R2 is used. A reference picture P1 indicated by a leftward arrow from the target picture is a previous picture which has the same layer as the target picture. A reference picture P3 indicated by a rightward arrow from the target picture is a future picture which has the same layer as the target picture. In motion prediction in which the target picture is used as a reference, the reference picture P1 or P3 is used.

(Motion Vector and Displacement Vector)

As a vector mvLX, a motion vector and a displacement vector (disparity vector) are provided. The motion vector is a vector indicating a shift of a position between a position of a block in a picture at a certain display time of a certain layer, and a position of the corresponding block in a picture having the same layer at a different display time (for example, adjacent discrete time).

The displacement is a vector indicating a shift of a position between a position of a block in a picture at a certain display time of a certain layer, and a position of the corresponding block in a picture having a different layer at the same display time. As the picture having a different layer, there are, for example, a case of being a picture which has the same resolution and different quality, a case of being a picture which has a different viewpoint, or a case of being a picture which has different resolution. Particularly, a displacement vector corresponding to a picture which has a different viewpoint is referred to as a disparity vector.

[Hierarchy Video Decoding Device]

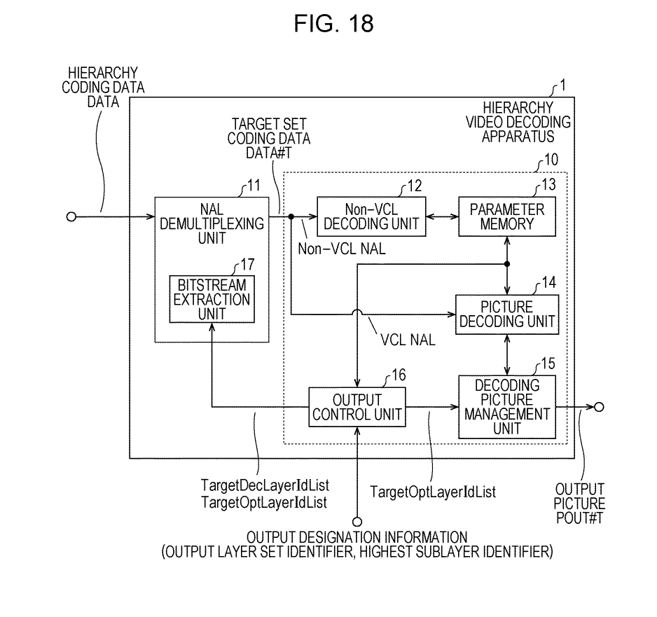

A configuration of the hierarchy video decoding device 1 according to the embodiment will be described below with reference to FIGS. 18 to 21.

(Configuration of Hierarchy Video Decoding Device)

The configuration of the hierarchy video decoding device 1 according to the embodiment will be described. FIG. 18 is a schematic diagram illustrating the configuration of the hierarchy video decoding device 1 according to the embodiment.

The hierarchy video decoding device 1 decodes hierarchy coding data DATA which is supplied from the hierarchy video coding device 2, generates a decoding picture of each layer included in a target set TargetSet, and outputs the decoding picture of an output layer as an output picture POUT#T. The target set TargetSet is determined by output designation information which is supplied from the outside of the device.

That is, the hierarchy video decoding device 1 decodes coding data of a picture of a layer i, generates a decoding picture thereof. The decoding and the generation are performed in an order of elements TargetDecLayerIdList[0] to TargetDecLayerIdList[N−1] (N is the number of layers included in the target set) in a target decoding layer ID list TargetDecLayerIdList. The target decoding layer ID list TargetDecLayerIdList indicates a configuration of layers required for decoding a target output layer set TargetOptLayerSet which is indicated by the output designation information. In a case where an output layer information OutputLayerFlag[i] of the layer i indicates “an output layer”, the hierarchy video decoding device 1 outputs the decoding picture of the layer i at a predetermined timing.

As illustrated in FIG. 18, the hierarchy video decoding device 1 includes a NAL demultiplexing unit 11 and a target set picture decoding unit 10. The target set picture decoding unit 10 includes a non-VCL decoding unit 12, a parameter memory 13, a picture decoding unit 14, a decoding picture management unit 15, and an output control unit 16. The NAL demultiplexing unit 11 includes a bitstream extraction unit 17.

The hierarchy coding data DATA includes a NALU which includes a parameter set (VPS, SPS, PPS), SEI, or the like, in addition to a NALU (NAL Unit) generated by a VCL. The NALs may be referred to as a non-VCL NAL unit (non-VCL NALU) against a VCL NALU.

The output control unit 16 derives output control information, based on output designation information supplied from the outside of the device, syntax of an active VPS held in the parameter memory 13, and a parameter derived from the syntax. More specifically, the output control unit 16 derives a target output layer ID list TargetOptLayerIdList, and supplies the derived list as a portion of output control information, to the decoding picture management unit 15. The output control unit 16 performs the deriving based on an output layer set identifier TargetOLSIdx, layer set information(layer set) of an active VPS held in the parameter memory 13, and output layer set information (layer set identifier and output layer flag). The target output layer ID list TargetOptLayerIdList indicates a layer configuration of an output layer in a target output layer set TargetOptLayerSet. The output layer set identifier TargetOLSIdx is included in the output designation information and is used for specifying an output layer set.

The output control unit 16 derives a target decoding layer ID list TargetDecLayerIdList, and supplies the derived target decoding layer ID list as a portion of output control information, to the bitstream extraction unit 17 and a target set picture unit 10. The deriving is performed based on an output layer set identifier TargetOLSIdx included in the output designation information, layer set information of an active VPS held in the parameter memory 13, output layer set information, a dependency flag derived by using inter-layer dependency information, and a target output layer ID list TargetOptLayerIdList derived by the output control unit 16. The target decoding layer ID list TargetDecLayerIdList indicates a configuration of layers required for decoding the target output layer set with excluding a non-output layer and a non-dependency layer. Deriving processing of the target output layer ID list and the target decoding layer ID list in the output control unit 16 will be described in detail later.

The bitstream extraction unit 17 included in the NAL demultiplexing unit 11 roughly performs bitstream extraction processing so as to extract a target decoding layer ID list supplied by the output control unit 16, a set determined by the highest-ordered sublayer identifier TargetHighestTid as a decoding target, and a target set coding data DATA#T (BitstreamToDecode) from the hierarchy coding data DATA. The target set coding data DATA#T (BitstreamToDecode) is configured from a NAL unit included in a target TargetSet. Processing which has high relevancy with the present invention, in the bitstream extraction unit 17 will be described in detail later.

The NAL demultiplexing unit 11 performs demultiplexing on the target set coding data DATA#T (BitstreamToDecode) which has been extracted by the bitstream extraction unit 17. The NAL demultiplexing unit 11 supplies a NAL unit included in the target set to the target set picture decoding unit 10, with reference to a NAL unit type, a layer identifier(layer ID), and a temporal identifier(temporal ID) which are included in the NAL unit.

The target set picture decoding unit 10 supplies a non-VCL NALU to the non-VCL decoding unit 12, and supplies a VCL NALU to the picture decoding unit 14, among NALUs included in the supplied target set coding data DATA#T. That is, the target set picture decoding unit 10 decodes a header (NAL unit header) of the supplied NAL unit. The target set picture decoding unit 10 supplies coding data of the non-VCL NALU to the non-VCL decoding unit 12, supplies coding data of the VCL NALU to the picture decoding unit 14, in accordance with the decoded NAL unit type, a layer identifier, and a temporal identifier. The supplying is performed based on the NAL unit type, the layer identifier, and the temporal identifier which are included in the decoded NAL unit header.

The non-VCL decoding unit 12 decodes a parameter set, that is, a VPS, an SPS, and a PPS from the input non-VCL NALU, and supplies a result of the decoding to the parameter memory 13. Processing which has high relevancy with the present invention, in the non-VCL decoding unit 12 will be described in detail later.

The parameter memory 13 holds the decoded parameter set and the coding parameter of the parameter set for each identifier of the parameter set. Specifically, if the parameter set is a VPS, the parameter memory 13 holds a coding parameter of the VPS for each VPS identifier (video_parameter_set_id). If the parameter set is an SPS, the parameter memory 13 holds a coding parameter of the SPS for each SPS identifier (sps_seq_parameter_set_id). If the parameter set is a PPS, the parameter memory 13 holds a coding parameter of the PPS for each PPS identifier (pps_pic_parameter_set_id). A layer identifier and a temporal identifier of each parameter set may be included in the coding parameter held in the parameter memory 13.

The parameter memory 13 supplies a coding parameter of a parameter set (active parameter set) to which the picture decoding unit 14 (which will be described later) refers in order to decode a picture, to the picture decoding unit 14. Specifically, firstly, an active PPS is designated by an active PPS identifier (slice_pic_parameter_set_id) which is included in the slice header SH decoded by the picture decoding unit 14. Then, an active SPS is designated by an active SPS identifier (pps_seq_parameter_set_id) which is included in the designated active PPS. Finally, an active VPS is designated by an active VPS identifier (sps_video_parameter_set_id) which is included in the active SPS. Then, coding parameters of the active PPS, the active SPS, and the active VPS which have been designated are supplied to the picture decoding unit 14. Similarly, the parameter memory 13 supplies a coding parameter of an active parameter set to which the output control unit 16 refers in order to derive output control information, to the output control unit 16.

The picture decoding unit 14 generates a decoding picture based on the VCL NALU, the active parameter sets (active PPS, active SPS, and active VPS), and the reference picture which have been input. The picture decoding unit 14 supplies the generated decoding picture to the decoding picture management unit 15. The supplied decoding picture is recorded in a buffer in the decoding picture management unit 15. The picture decoding unit 14 will be described later in detail.

The decoding picture management unit 15 records the input decoding picture in an internal decoded picture buffer (DPB), and performs generation of a reference picture list or determination of an output picture. The decoding picture management unit 15 outputs a decoding picture of an output layer included in the target output layer ID list TargetOptLayerIdList which has been derived by the output control unit 16 among decoding picture recorded in the DPB, as an output picture POUT#T to the outside at a predetermined timing.

(Non-VCL Decoding Unit 12)

The non-VCL decoding unit 12 decodes parameter sets (VPS, SPS, and PPS) used for decoding the target set, from the input target set coding data. Coding parameters of the decoded parameter sets are supplied to the parameter memory 13, and are recorded for each identifier of each of the parameter sets. A decoding target of the non-VCL decoding unit 12 is not limited to the parameter set. In FIG. 6, the non-VCL decoding unit 12 may decode NAL units (nal_unit_type=32 . . . 63) classified as a non-VCL. Similar to the parameter set, each coding parameter of the decoded non-VCL is recorded in the parameter memory 13.

Generally, the parameter set is decoded based on the predetermined syntax table. That is, a bit string is read from coding data by a predetermined procedure of the syntax table, and syntax included in the syntax table is decoded. If necessary, a variable is derived based on the decoded syntax, and the derived variable may be included in a parameter set to be output. Thus, a parameter set output from the non-VCL decoding unit 12 can be expressed by a set of syntax relating to the parameter sets (VPS, SPS, and PPS) which are included in coding data, and a variable derived by using the syntax.

The non-VCL decoding unit 12 includes parameter set decoding means. The parameter set decoding means decodes a parameter set (VPS/SPS/PPS) based on the defined syntax table (not illustrated). The parameter set decoding means includes layer set decoding means, inter-layer dependency information decoding means, output layer set information decoding means, PTL information decoding means, DPB information decoding means, scalable identifier decoding means, and the like which are not illustrated. The layer set decoding means decodes layer set information. The inter-layer dependency information decoding means decodes inter-layer dependency information. The output layer set information decoding means decodes output layer set information. The PTL information decoding means decodes PTL information corresponding to an output layer set. The DPB information decoding means decodes DPB information corresponding to the output layer set. The scalable identifier decoding means decodes a scalable identifier (ScalabilityID) of each layer, and an auxiliary picture layer ID (AuxID).

Descriptions will be made below focused on a syntax table which has high relevancy with the present invention, among syntax tables used for decoding of the non-VCL decoding unit 12.

(Layer Set Information)

The layer set information corresponds to a list (below, layer ID list LayerIdList) indicating a set of layers constituting a layer set which is included in hierarchy coding data. The layer set information is decoded from the VPS by the layer set information decoding means. In the layer set information, syntax (vps_num_layer_sets_minus1) (SYNPVS06 in FIG. 11) and syntax “layer_id_included_flag[i][j]” (SYNVPS07) are included. The syntax (vps_num_layer_sets_minus1) indicates the number of layer sets defined on the VPS. The syntax “layer_id_included_flag[i][j]” indicates whether or not the j-th layer(layer j) is included in the i-th layer set(layer set i) in an order of layer definition on the VPS. The number of layer sets VpsNumLayerSets is set to (vps_num_layer_sets_minus1+1). The layer set i is constituted of a certain layer j in which a value of the syntax “layer_id_included_flag[i][j]” is 1. That is, the layer j constituting the layer set i is included in the layer ID list LayerIdList[i].

The number of layers NumLayersInIdList[i] included in the layer set i is derived from the number of flags which relate to the layer set i and have the value of the syntax of 1, out of the syntax “layer_id_included_flag[i][j]”.

More specifically, the layer set information decoding means derives a layer ID list LayerIdList[i] of each layer set i and the number of layers NumLayersInIdList[i] included in the layer set i, by using the following pseudo code.

(Pseudo Code Indicating Layer ID List of Each Layer Set)

```
for(i = 0; i< VpsNumLayerSets; i++){
  NumLayersInIdList[i] = 0;
  for(m = 0; m<= vps_max_layer_id; m++){
    if(layer_id_included_flag[i][m]){
      LayerIdList[i][NumLayersInIdList[i]] = m;
      NumLayersInIdList[i]++;
    }
  } // end of loop on for(m=0; m<= vps_max_layer_id; m++)
} // end of loop on for(i=0; i<VpsNumLayerSets; i++)
```

The pseudo code is expressed in a form of a step, as follows.

(SA01) SA01 is a start point of a loop relating to deriving of a layer ID list of a layer set i. Before the loop is started, a variable i is initialized so as to be 0. A loop variable in the following repetitive processes is the variable i. Processes indicated by SA0A2 to SA0A are performed on the variable i having values of 0 to (NumLayerSets−1).

(SA02) The number of layers NumLayresInIdList[i] of the layer set i is initialized so as to be 0 (that is, NumLayersInIdList[i]=0;).

(SA03) SA03 is a start point of a loop relating to addition of an element of the m-th layer (layer m) to the layer ID list of the layer set i. Before the loop is started, a variable m is initialized so as to be 0. A loop variable in the following repetitive processes is the variable m. Processes indicated by SA04 to SA06 are performed on the variable m of 0 to the maximum layer identifier “vps_max_layer_id”. Instead of the maximum layer identifier “vps_max_layer_id”, processes in the loop may be performed by using the maximum number of layers VpsMaxLayers, when the variable m is less than the maximum number of layers VpsMaxLayers. That is, a determination expression of “m<=vps_max_layer_id” may be changed to “m<VpsMaxLayers” in the for-loop.

(SA04) It is determined (layer_id_included_flag[i][m]) whether or not the layer m is included in the layer set i. If layer_id_included_flag[i][m] is 1, the process transitions to Step SA05. If layer_id_included_flag[i][m] is 0, the processes of Steps SA05 and SA06 are skipped, and the process transitions to SA0A.

(SA05) The layer m is added to a (NumLayersInIdList[i])-th element in the layer ID list LayerIdList[i][ ] of the layer set i (that is, LayerIdList[i][NumLayersInIdList[i]]=m;).

(SA06) “1” is added to a value of the number of layers NumLayersInIdList[i] of the layer set i (that is, NumLayersInIdList[i]++;).

(SA0A) SA0A is a loop termination of Step SA03.

(SA0B) SA0B is a loop termination of Step SA01.

With the above procedures, the layer ID list LayerIdList[i] for each layer set i can be derived. An order of a certain layer which is the m-th element in the layer set i, in all layers (layers defined by the VPS) can be recognized by referring to the layer ID list LayerIdList[ ]. The number of layers included in the layer set i can be recognized by referring to a variable NumLayersInIdList[i]. The variable NumLayersInIdList[i] indicates the number of layers in the layer set i. The procedure of the deriving is not limited to the above steps, and may be changed in a range allowed to be performed.

(Inter-Layer Dependency Information)

A direct dependency flag “direct_dependency_flag[i][j]” (SYNVPS0C in FIG. 12) is included in inter-layer dependency information. The inter-layer dependency information is decoded, for example, from VPS extension data by the inter-layer dependency information decoding means.

The direct dependency flag direct_dependency_flag[i][j] indicates whether or not the i-th layer (below, layer i) directly depends on the j-th layer (below, layer j). In a case where the layer i directly depends on the layer j, the direct dependency flag has a value of 1. In a case where the layer i does not directly depend on the layer j, the direct dependency flag has a value of 0.

Here, in a case where the layer i directly depends on the layer j, in a case where decoding processing is performed on the layer i as a target layer, this means that there is a probability of directly referring to a parameter set relating to the layer j, a decoding picture, and the coded syntax to be associated, by the target layer. Conversely, in a case where the layer i does not directly depend on the layer j, in a case where the decoding processing is performed on the layer i as a target layer, this means that there is a probability of not directly referring to a parameter set relating to the layer j, a decoding picture, and the coded syntax to be associated. In other words, in a case where the direct dependency flag direct_dependency_flag[i][j] of the layer i for the layer j is 1, the layer j is a direct reference layer of the layer Conversely, in a case where the direct dependency flag is 0, the layer j is a non-direct reference layer of the layer

The layer dependency information decoding means derives a list RefLayerId[ ][ ] of direct reference layers (also referred to as a reference layer ID list) of the layer i, and the direct reference number of layers NumDirectRefLayers[ ] of the layer i, based on the direct dependency flag “direct_dependency_flag[i][j]”. Here, the reference layer ID list RefLayerId[ ][ ] is a two-dimensional array. The first dimensional index is the layer identifier (layer_id_in_nuh[i]) of the target layer (layer i). The second dimensional index is an index of an element in the reference layer ID list of the target layer (layer i). Here, layer_id_in_nuh[ ] is an array for deriving the layer identifier nuh_layer_id of the layer i (the same hereinafter).

(Deriving of Reference Layer ID List and Direct Reference Number of Layers)

The reference layer ID list and the direct reference number of layers are derived by using the following pseudo code.

```
for(i=0; i< VpsMaxLayers; i++){
  iNuhLId = layer_id_in_nuh[i];
  NumDirectRefLayers[iNuhLId] = 0;
  for(j=0; j<i; j++){
    if(direct_dependency_flag[i][j]){
      RefLayerId[iNuhLId][NumDirectRefLayers[iNuhLId]] =
layer_id_in_nuh[j];
      NumDirectRefLayers[iNuhLId]++;
    }
  } // end of loop on for(j=0; j<i; i++)
} // end of loop on for(i=0; i< VpsMaxLayers ; i++)
```

The pseudo code is expressed in a form of a step, as follows.

(SL01) SL01 is a start point of a loop relating to deriving of a reference layer ID list and a direct reference number of layers regarding the layer i. Before the loop is started, a variable i is initialized so as to be 0. The process in the loop is performed when the variable i is less than the number of layers VpsMaxLayers. Every time the process in the loop is performed one time, “1” is added to the variable

(SL02) The layer identifier layer_id_in_nuh[i] of the layer i is set in a variable iNuhLid. The direct reference number of layers NumDirectRefLyaers[iNuhLId] of the layer identifier layer_id_in_nuh[i] is set to 0.

(SL03) SL03 is a start point of a loop relating to addition of an element (layer j) to the reference layer ID list regarding the layer i. Before the loop is started, a variable j is initialized so as to be 0. The process in the loop is performed when the variable j (layer j) is less than i (j<i). Every time the process in the loop is performed one time, “1” is added to the variable j.

(SL04) It is determined whether the layer j is a direct reference layer of the layer i. The determination is performed based on the direct dependency flag (direct_dependency_flag[i][j]). If the direct dependency flag is 1 (if the layer j is the direct reference layer), the process transitions to Step SL05 in order to perform the processes of Steps SL05 to SL07. If the direct dependency flag is 0 (if the layer j is a non-direct reference layer), the processes of Steps SL05 to SL07 are skipped, and the process transitions to SL0A.

(SL05) The layer identifier layer_id_in_nuh[j] of the layer j is set in the (NumDirectRefLayers[iNuhLId])-th element in the reference layer ID list RefLayerId[iNuhLId][ ]. That is, RefLayerId[iNuhLId][NumDirectRefLayers[iNuhLId]]=layer_id_in_nuh[j].

(SL06) “1” is added to a value of the direct reference number of layers NumDirectRefLayers[iNuhLId]. That is, NumDirectRefLayers[iNuhLId]++;

(SL0A) SL0A is a termination of the loop relating to the addition of an element (layer j) to the reference layer ID list regarding the layer

(SL0B) SL0B is a termination of the loop relating to the deriving of the reference layer ID list of the layer i and the direct reference number of layers.

The deriving procedure of the reference layer ID list and the direct reference number of layers is not limited to the above steps, and may be changed in a range allowed to be performed.

(Deriving of Dependency Flag)

The layer dependency information decoding means derives a dependency flag recursiveRefLayerFlag[ ][ ] based on the reference layer ID list RefLayerId[ ][ ] and the direct reference number of layers NumDirectRefLayers[ ] which have been derived. The dependency flag recursiveRefLayerFlag[ ][ ] indicates whether the layer j is a dependency layer (direct reference layer or indirect reference layer) of the layer i. For example, the layer dependency information decoding means derives a dependency flag by using a pseudo code as follows.

(Pseudo Code)

```
for(i=0; i<VpsMaxLayers; i++){
  currLayerId = layer_id_in_nuh[i];
  for(j=0; j<NumDirectRefLayers[currLayerId]; j++){
    refLayerId = RefLayerId[currLayerId][j];
    recursiveRefLayerId[currLayerId][refLayerId] = 1;
    for(k=0; k<VpsMaxLayers; k++){
      if(recursiveRefLayerFlag[refLayerId][k]){
        recursiveRefLayerFlag[currLayerId][k] |=
  (recursiveFlag[refLayerId][k]);
      }
    } // end of loop on for(k=0; k<VpsMaxLayers; k++)
  } // end of loop on for(j=0;
j<NumDirectRefLayers[currLayerId]; j++)
} // end of loop on for(i=0; i<VpsMaxLayers; i++)
```

The pseudo code is expressed in a form of a step, as follows. Before Step S001 is started, it is assumed that values of all elements of the dependency flag recursiveRefLayerFlag[ ] H are initialized so as to be 0.

(S001) S001 is a start point of a loop relating to deriving of a dependency flag regarding the layer i. Before the loop is started, a variable i is initialized so as to be 0. Processes in the loop are performed when the variable i is less than the number of layers VpsMaxLayers. Every time the process in the loop is performed one time, “1” is added to the variable i.

(S002) The layer identifier layer_id_in_nuh[i] of the layer i is set in a variable currLayerId (that is, currLayerId=layer_id_in_nuh[i]).

(SO03) SO03 is a start point of a loop relating to the direct reference layer j of the layer i. Before the loop is started, a variable j is initialized so as to be 0. The process in the loop is performed when the variable j (direct reference layer j) is less than the direct reference number of layers NumDirectRefLayers[currLayerId] (j<NumDirectRefLayers[currLayerId]). Every time the process in the loop is performed one time, “1” is added to the variable j.

(SO04) The layer identifier RefLayerId[currLayerId][j] of the direct reference layer j of the layer i (currLayerId) is set in the variable refLayerId (refLayerId=RefLayerId[currLayerId][j]).

(S005) The dependency flag of the direct reference layer j for the layer i is set to 1 (recursiveRefLayerFlag[currLayerId][refLayerId]=1).

(S006) S006 is a start point of a searching loop of whether a layer k is a dependency layer of the layer Before the loop is started, a variable k is initialized so as to be 0. The process in the loop is performed when the variable k (layer k) is less than the number of layers VpsMaxLayers (j<VpsMaxLayers). Every time the process in the loop is performed one time, “1” is added to the variable k.

(S007) It is determined whether or not the layer k is a dependency layer of the direct reference layer j of the layer i. The determination is performed in accordance with a dependency flag recursiveRefLayerFlag[refLayerId][k]. In a case where the layer k is a dependency layer of the direct reference layer j of the layer i (in a case where the dependency flag is 1), the process transitions to Step S008. In a case where the layer k is not a dependency layer of the direct reference layer j of the layer i (in a case where the dependency flag is 0), the process transitions to Step S009.

(S008) The AND operation of the dependency flag of the layer k for the layer i and the dependency flag of the layer k for the direct reference layer j of the layer i is set in the dependency flag of the layer k for the layer

(S009) S009 is a termination of the loop corresponding to Step S006.

(S010) S010 is a termination of the loop corresponding to Step S003.

(S011) S011 is a termination of the loop corresponding to Step S001.

The deriving procedure of the dependency flag is not limited to the above steps, and may be changed in a range allowed to be performed.

(PTL Information)

The PTL information is information indicating a profile and a level which are required for decoding an output layer set. The PTL information is decoded from the VPS or the SPS by the PTL information decoding means.

A notification of the PTL information corresponding to the output layer set OLS#0 is performed in SYNVPS04 on the VPS illustrated in FIG. 11, or FIG. 17(a) on the SPS. PTL information corresponding to an output layer set OLS#i (i=1 . . . NumOutputLayerSets−1) is formed from syntax “vps_num_profile_tier_level_minus1” (SYNVPS0D in FIG. 12), a profile present flag “vps_profile_present_flag[i]” (SYNVPS0E in FIG. 12), and the i-th PTL information “profile_tier_level( )” (SYNVPS0F in FIG. 12). The syntax “vps_num_profile_tier_level_minus1” indicates “the number of pieces of PTL information −1” defined on the VPS. The profile present flag “vps_profile_present_flag[i]” indicates the presence or the absence of profile information of the i-th (i=1 . . . num_profile_tier_level_minus1) PTL information.

Each piece of PTL information is correlated with the output layer set OLS#i by a PTL designation identifier (profile_level_tier_idx[i]) (SYNVPS0J in FIG. 12) which is included in the output layer set OLS#i (which will be described later). For example, if the PTL designation identifier of an output layer set OLS#3 satisfies profile_level_tier_idx[3]=10, pieces of information from the leading PTL information to the tenth PTL information in a list of pieces of PTL information on SYNVPS0F in FIG. 12 are pieces of PTL information applied to the output layer set OLS#3.

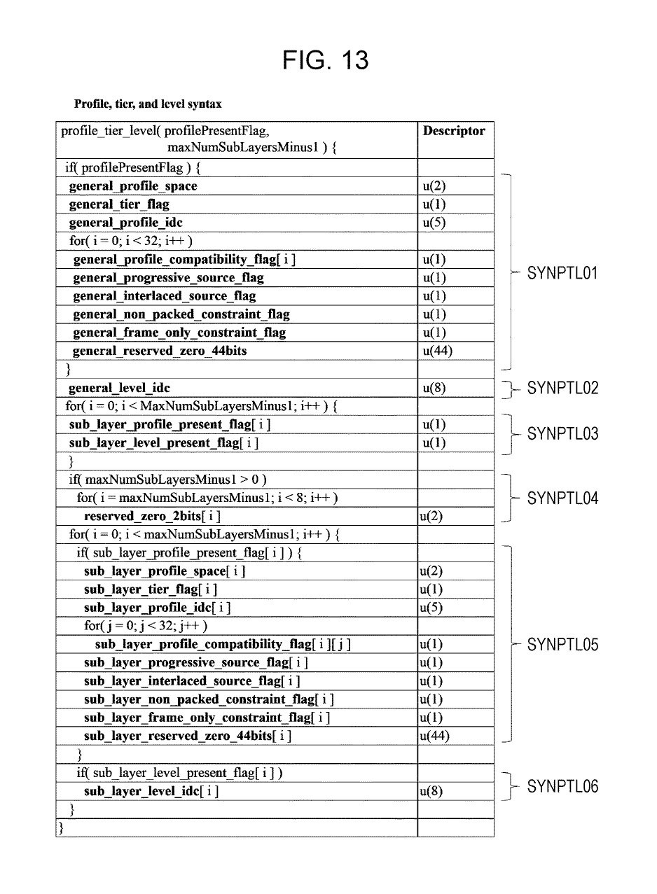

The PTL information (SYNVPS04 and SYNVPS0H) as illustrated in FIG. 13 includes syntax groups (SYNPTL01, SYNPTL02, SYNPTL03, SYNPTL04, SYNPTL05, and SYNPTL06) which relate to the profile and the level. The PTL information (SYNVPS04 and SYNVPS0H) is decoded by the PTL information decoding means.

The syntax group SYNPTL01 includes the following syntax.
Profile space general_profile_space
Tier flag general_tier_flag
Profile identifier general_profile_idc
Profile compatibility flag
   general_profile_compatibility_flag[i]
Profile reservation syntax general_reserved_zero_44 bits

The syntax group SYNPTL02 includes a level identifier general_level_idc.

The syntax group SYNPTL03 includes a sublayer profile present flag and a sublayer level present flag of a sublayer.

The syntax group SYNPTL04 is byte-aligned data (reserved_zero_2 bits[i]) corresponding to the number of bits which are determined based on the number of sublayers (MaxNumSbuLayersMinus1, or MaxNumSubLayers−1).

The syntax group SYNPTL05 includes the following syntax.
Sublayer profile space sub_layer_profile_space[i]
Sublayer tier flag sub_layer_tier_flag[i]
Sublayer profile identifier sub_layer_profile_idc[i]
Sublayer profile compatibility flag
   sub_layer_profile_compatibility_flag[i][j]•sublayer profile reservation syntax sub_layer_reserved_zero_44 bits[i]

The syntax group SYNPTL05 includes a sublayer level identifier sub_layer_level_idc[i] as sublayer level information of a sublayer.

(Scalable Identifier and Auxiliary Picture Layer ID)

The scalable identifier decoding means (not illustrated) decodes a scalable identifier (ScalabilityId) which is allocated in a unit of a layer, from target layer coding data which is input. The scalable identifier ScalabilityId is an ID for identifying properties of a layer among layers. The scalable identifier ScalabilityId may be also referred to as a scalable ID. A scalable ID having a plurality of dimensions can be provided for one layer. The following j-th dimensional scalable ID of the layer i is derived from dimension_id[i][j] of coding data. An index j is assumed to be 0 to 15.

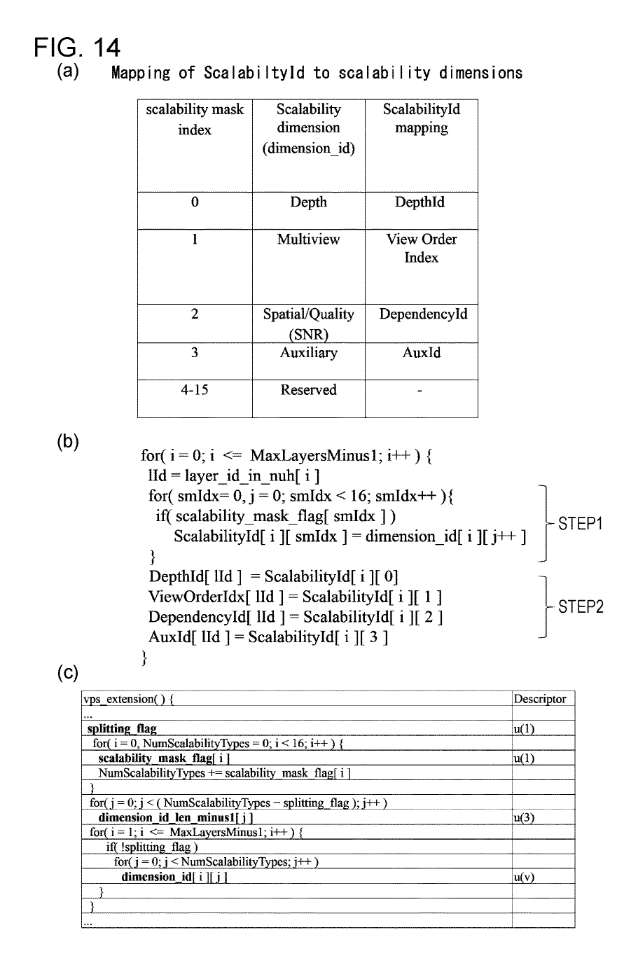

FIG. 14(c) illustrates an example of a syntax table indicating a configuration of VPS extension data. The scalable identifier decoding means decodes a splitting flag splitting_flag, a scalable mask flag scalability_mask_flag, a dimension ID length dimension_id_len_minus1, and a dimension ID dimension_id, from coding data.

splitting_flag is a syntax element indicating a coding position of dimension_id. In a case where splitting_flag is 1, dimension_id is not explicitly coded in the VPS, and is derived from a layer identifier (“layer_id_in_nuh[i]”) corresponding to each layer i. In a case where splitting_flag is 0, dimension_id is coded in VPS extension.

scalability_mask_flag[j] indicates whether or not the dimension ID indicated by an index j is used. The scalable identifier decoding means the number of dimensions NumScalabilityTypes in scalability_mask_flag[j] is 1, based on scalability_mask_flag[j]. dimension_id[i][j] corresponding to a case where scalability_mask_flag[j] is 0 is not decoded.

dimension_id_len_minus1 indicates ((bit length of dimension_id[i][j])−1) of the index j. The scalable identifier decoding means decodes a dimension ID (dimension_id[i][j]) of the j-th dimension of the layer i, in a case where splitting_flag is 0.

FIG. 14(b) illustrates a pseudo code indicating a deriving method of the scalable identifier ScalabilityId. The scalable identifier decoding means derives a scalable identifier ScalabilityId[i][smIdx] from the dimension ID (dimension_id[i][j]), regarding index i of 0 to the maximum number of layers −1 (MaxLayersMinus1).

Specifically, in STEP1 in FIG. 14(b), in a case where the scalable mask scalability_mask_flag[smIdx] of a variable smIdx which indicates a dimension is true (1), the scalable identifier decoding means sets the j-th dimension_id[i][j] in ScalabilityId[i][smIdx]. j is increased by 1 when j is set in ScalabilityId[i][smIdx]. In a case where a dimension_id corresponding to the scalable identifier ScalabilityId[i][smIdx] is not included in the coding data, ScalabilityId[i][smIdx] may be set to 0. That is, in a case where the scalable mask scalability_mask_flag[smIdx] of the index smIdx is 0, the scalable identifier decoding means sets ScalabilityId[i][smIdx] to 0.

In SPEP2 in FIG. 14(b), regarding each layer index i (layer i), the scalable identifier decoding means performs deriving in such a manner that the scalable identifier scalabilityId[i][0] is set in a depth ID DepthId[lId], the scalable identifier ScalabilityId[i][1] is set in a view order ID ViewOrderIdx[lId], the scalable identifier ScalabilityId[i][2] is set in a dependency ID DependencyId[lId], and the scalable identifier ScalabilityId[i][3] is set in an auxiliary picture layer ID AuxId[lId]. The scalable identifiers scalabilityId[i][0], scalabilityId[i][1], scalabilityId[i][2], and scalabilityId[i][3] have been derived in SPTEP1 in FIG. 14(b). That is, the auxiliary picture layer ID (AuxId[ ]) is derived by ScalabilityId[i][3].

The relation in type between the dimension ID and the scalable ID is not limited to FIG. 14(b) which is described above, and another correspondence relation may be set. For example, ScalabilityId[i][0], ScalabilityId[i][1], ScalabilityId[i][2], and ScalabilityId[i][3] may be respectively mapped on ViewOrderIdx[lId], DependencyId[lId], AuxId[lId], and DepthId[lId]. In this case, AuxId is derived from ScalabilityI[i][2], not ScalabilityI[i][3].

The depth ID DepthId[lId] indicates a texture or a depth. 0 in the depth ID corresponds to a texture, and 1 in the depth ID corresponds to a depth.

The view order ID ViewOrderIdx[lId] indicates an order of viewpoints. The order of viewpoints is not required to correspond to a position of a camera. A view ID which is separate from the view order ID can be also determined.

The dependency ID DependencyId[0] is an ID indicating a level of SNR scalability or spatial scalability. For example, in a case where a base layer, Enhancement layer 1 referring to the base layer, Enhancement 2 referring to the Enhancement layer 1 constitute a layer, dependency IDs of the base layer, the Enhancement layer 1, and the Enhancement layer 2 are respectively set to 0, 1, and 2.

The auxiliary picture layer ID AuxId[lId] is used for distinguishing between a primary picture layer and an auxiliary picture layer, and for identifying the type of the auxiliary picture layer. 0 in the auxiliary picture layer ID corresponds to the primary picture layer, and values other than 0 correspond to the auxiliary picture layer. 1 indicates an alpha picture (layer), and 2 indicates a depth picture (layer). A value of 2 or more can be used as the auxiliary picture layer ID.

(Output Layer Set Information)

The output layer set information is defined by combination of a set (output layer information) of layers to be output, and a set (layer set information) of layers. The output layer set information is decoded by the output layer set information decoding means (not illustrated) which is included in the hierarchy video decoding device. The hierarchy video decoding device sets a layer included in a layer set (layer set correlated with an output layer) which is included in an output layer set decoded by the output layer set information decoding means, as a decoding target. The hierarchy video decoding device decodes a decoding picture of the layer, and records the decoded picture in a buffer. The hierarchy video decoding device sets output layer information included in the output layer set, as a target, and selects and outputs a decoding picture of a specific layer, which has been recorded in the buffer.

The output layer set information includes the following syntax elements (E1 to E7).

E1: the number of additional output layer sets (num_add_output_layer_sets) (SYNVPS0G in FIG. 12)

E2: default output layer identifier (default_target_output_layer_idc) (SYNVPS0H in FIG. 12)

E3: layer set identifier (output_layer_set_idx_minus1) (SYNVPS0I in FIG. 12)

E4: output layer information (output_layer_flag) (SYNVPS0J in FIG. 12)

E5: alternative output_layer_flag (alt_output_layer_flag) (SYNVPS0K in FIG. 12)

E6: PTL•DPB information presence flag (ptl_dpb_info_present_flag) (SYNVPS0L in FIG. 12)

E7: PTL designation identifier (profile_level_tier_idx) (SYNVPS0M in FIG. 12)

The output layer set information decoding means in the embodiment decodes at least the layer set identifier and the output layer flag of an output layer set.

(E1: Additional Output Layer Set)

The output layer set is information obtained by combining designation of the corresponding layer set and an output layer in the layer set. A layer set specified by the layer set identifier can be used as the layer set corresponding to the output layer set. The output layer information can be used for designating the output layer. Thus, each output layer set has one associated layer set.

The output layer set can be classified into a basic output layer set and an additional output layer set. In a case where output layer sets are associated with the same layer set, one of the output layer sets corresponds to the basic output layer set. Output layer sets other than the basic output layer set associated in the same layer set correspond to extension output layer sets. The basic output layer set is an output layer set derived based on a layer set which has been decoded by the VPS. In the embodiment, one output layer set corresponding to each layer set which has been decoded by the VPS is derived as the basic output layer set. In the embodiment, in a case where the number of layer sets is set as VpsNumLayerSets, output layer sets having identifiers of 0 to VpsNumLayerSets−1 respectively have one-to-one correspondence with layer sets having identifiers of 0 to VpsNumLayerSets−1. The output layer sets are set to be the basic output layer set. An output layer set corresponding to an identifier which is equal to or more than VpsNumLayerSets is an output layer set other than the basic output layer set, and thus corresponds to an extension output layer set.

More specifically, the output layer set information decoding means in the embodiment decodes the number of layer sets (VpsNumLayerSets), and decodes layer sets corresponding to the number of layer sets, from the VPS. The output layer set information decoding means respectively decodes output layer sets having identifiers of 0 to (VpsNumLayerSets−1), from decoded layer set having identifiers of 0 to (VpsNumLayerSets−1). The output layer set information decoding means decodes the basic output layer set. Here, an output layer set which is associated with a layer set having an identifier i (layer set identifier i) and has an identifier i (output layer set identifier i) is referred to as a basic output layer set corresponding to the layer set having a layer set identifier i. Conversely, a layer set corresponding to the basic output layer set which has an output layer set identifier i is a layer set having a layer set identifier

The additional layer set is an output layer set which is defined so as to be added to the basic output layer set. In the embodiment, the number of additional output layer sets (num_add_output_layer_sets) is decoded from VPS extension, and output layer sets corresponding to the number of additional output layer sets are derived based on a layer set identifier and output layer information which are decoded from VPS extension.

The basic output layer set and the additional output layer set can be defined as follows. That is, the basic output layer set is an output layer set of which a layer set identifier which indicates the corresponding layer set is not explicitly decoded. The additional output layer set is an output layer set of which a layer set identifier which indicates the corresponding layer set is explicitly decoded and output.

The number of output layer sets NumOutputLayerSets is derived by (the number of layer sets VpsNumlayerSets)+(the number of additional output layer sets num_add_output_layer_sets). In the following descriptions, output layer sets having identifiers of 0 to (VpsNumLayerSets−1) are basic output layer sets. Output layer sets having identifiers of VpsNumLayerSets to (NumOutputLayerSet−1) are additional output layer sets.

(E2: Default Output Layer Identifier)

A default output layer identifier default_target_output_layer_idc is a syntax element for designating deriving processing of an output layer set (output layer information). The output layer set information decoding means in the embodiment decodes a default output layer identifier. The output layer set information decoding means performs decoding control or deriving of output layer information by processing in accordance with a value of the default output layer identifier.

(1) Case of default output layer identifier=0: decoding of output layer information (output_layer_flag[i][j]) (which will be described later) for a basic output layer set is omitted. All primary picture layers included in each output layer set are set to be output layers (OutputLayerFlag[i][j]=1). All auxiliary picture layers are set to be non-output layers (OutputLayerFlag[i][j]=0). Regarding the additional output layer set, output layer information (output_layer_flag) is explicitly decoded, and an output layer is set in accordance with the output layer information.

(2) Case of default output layer identifier=1: a primary picture layer which is included in each output layer set and has the highest-ordered layer identifier in the basic output layer set is set to be an output layer. Regarding the additional output layer set, output layer information (output_layer_flag) is explicitly decoded, and an output layer is set in accordance with the output layer information.

(3) Case of default output layer identifier=2: in all output layer sets (basic output layer set and additional output layer set), output layer information (output_layer_flag) is explicitly decoded, and an output layer is set in accordance with the output layer information.

Among values of the default output layer identifier, a value of 3 or more is a reserved value for the future standard expansion.

(E3: Layer Set Identifier)

The layer set identifier is a value for specifying a layer set which is associated with an output layer set. The output layer set information decoding means in the embodiment decodes a syntax element output_layer_set_idx_minus1[i], and uses a value obtained by adding 1 to the syntax element value, as a layer set identifier for the output layer set having an identifier A layer set (LS#(output_layer_set_idx_minus1[i]+1)) indicating the layer set identifier is associated with the output layer set (OLS#i) which has an identifier

The output layer set information decoding means performs estimation in a case where the layer set identifier of the output layer set OLS#i is not in the coding data (in a case where the layer set identifier of the output layer set OLS#i is omitted). For example, in a case of a basic output layer set of which the output layer set identifier is i, the output layer set information decoding means estimates a layer set identifier to be (i−1). In the embodiment, a syntax element which relates to a layer set identifier is expressed as “(value of the layer set identifier)−1”. However, it is not limited thereto. The syntax element may be “the value of the layer set identifier”.

(E4: Output Layer Information)

The output layer information is a set of flags (OutputLayerFlag[i][j]) indicating whether each layer which is included in a layer set and is associated with an output layer set is set as an output target layer. The output layer set information decoding means in the embodiment sets output layer information OutputLayerFlag[i][j] from the decoded syntax element output_layer_flag[i][j]. output_layer_flag[i][j] is a flag indicating whether or not the j-th layer included in the output layer set i is set as an output target layer. In a case where the value of output_layer_flag[i][j] is true (1), the flag indicates that the j-th layer is set as an output target layer. In a case where the value of output_layer_flag[i][j] is false (0), the flag indicates that the j-th layer is not set as an output target layer.

The output layer set information decoding means may omit decoding of some or all pieces of output layer information, and may estimate or determine output layer information by deriving processing based on a value of another syntax element. For example, the output layer set information decoding means may select any deriving processing which is indicated by the following (1) to (3) and may determine output layer information of a basic output layer set, based on the default output layer identifier (default_target_output_layer_idc). The output layer set information decoding means estimates that output layer information of the output layer set OLS#0 configured only from a base layer satisfies OutputLayerFlag[0][0]=1. More specifically, the output layer set information decoding means derives OutputLayerFlag[ ][ ] by the following processing. Regarding i of a starting value si to (the number of output layer sets)−1 (NumOutputLayerSets−1), and j of 0 to the number of layers (NumLayersInIdList[LayerSetIdx[i]]−1) of a layer set corresponding to the output layer set(OLS#i) of the output layer set identifier i excluding i=0 and j=0, the output layer set information decoding means derives OutputLayerFlag[i][j] by using OutputLayerFlag[i][j]=output_layer_flag[i][j]. Regarding OutputLayerFlag[i][j] in which i=0 and j=0, OutputLayerFlag[i][j]=1. That is, the output layer set information decoding means derives an output_layer_flag with OutputLayerFlag[0][0]=1. Thus, deriving can be performed so as to decode output layer information OutputLayerFlag of an output layer set having an identifier 0 of which output layer information output_layer_flag is explicitly not decoded. Even in a case where OLS#0 which is an output layer set configured only from a base layer is decoded, the image decoding device can be operated so as to obtain an output picture. The starting value si is set to 0 in a case of default output layer identifier=2. The starting value si is set to the number of base layers (vps_number_layer_sets_minus1+1) in other cases.

(1) Case of default output layer identifier=0: as indicated by the following pseudo code, the output layer set information decoding means estimates output layer flags OutputLayerFlag[i][j] of all primary picture layers (AuxID[ ]==0) to be 0 for basic output layer set of i=0 . . . VpsNumLayerSets−1. The output layer set information decoding means estimates output layer flags OutputLayerFlag[i][j] of all auxiliary picture layers (AuxID[ ]>0) to be 0. Here, the variable LayerSetldx[i] presents the layer set identifier which indicates a layer set associated with the output layer set OLS#i. The variable LayerSetldx[i] is set to (output_layer_set_idx_minus1[i]+1). The variable NumLayersInIdList[LayerSetldx[i]] corresponds to the number of layers included in a layer set LS#(LayerSetldx[i]) (hereinafter, the same).

```
for(j=0; j<NumLayersInIdList[LayerSetIdx[i]]; j++){
if(AuxID[nuh_layer_id[LayerIdList[LayerSetIdx[i]][j]]]==0)
    OutputLayerFlag[i][j] = 1;
  else
    OuptutLayerFlag[i][j] = 0;
}
```

(2) Case of default output layer identifier=1: the output layer set information decoding means sets a primary picture layer which is included in each output layer set and has the highest-ordered layer identifier, as an output layer for a basic output layer of i=0 . . . vps_number_layer_sets_minus1. The output layer information (OutputLayerFlag) is derived by a pseudo code as follows.

```
for(j=0; j<NumLayersInIdList[LayerSetIdx[i]]; j++){
  if (layer j is a primary picture layer having a highest-
ordered layer identifier in LayerIdList[LayerSetIdx[i]]){
    OutputLayerFlag[i][j] = 1;
  } else{
    OutputLayerFlag[i][j] = 0;
  }
}
```

Whether or not the layer j is a primary picture layer is determined by using a value of an item of “Auxiliary” (auxiliary picture layer ID AuxId[j]=ScalabilityId[j][3]) in a correspondence table between a scalable identifier (scalability ID) and a scalability type (Scalability Dimension), which is illustrated in FIG. 14(a). The determination is performed with reference to a scalable identifier (scalability ID) (ScalabilityId) and the correspondence table. The scalable identifier is derived from a syntax “dimension_id[i][j]” indicating a dimension ID which relates to the layer j. That is, in a case where the value of the above item is 0 (AuxId[j]==0), the value indicates that the layer j is a primary picture layer. In a case where the value of the above item is more than 0 (AuxId[j]>0), the value indicates that the layer j is an auxiliary picture layer (or AUX layer). The auxiliary picture layer is a layer for a notification of a depth mask for a picture belonging to the primary picture layer, or a notification of an auxiliary picture such as an alpha channel. Details of the scalable identifier and the auxiliary picture layer ID are already described in the section of (Scalable Identifier and Auxiliary Picture Layer ID).

(3) Case of default output layer identifier=2: the output layer set information decoding means decodes the syntax element output_layer_flag[i][j] and derives an output layer, for all output layer sets (output layer set of i=1 . . . NumOutputLayerSets) except for i=0. That is, as indicated by the following pseudo code, the output layer set information decoding means sets a value of the syntax element output_layer_flag[i][j] in output layer information(OutputLayerFlag[i][j]) of the j-th layer (layer j) of the output layer set OLS#i.

for(j=0; j<NumLayersInIdList[LayerSetIdx[i]]; j++){
OutputLayerFlag[i][j] = output_layer_flag[i][j];
}

The output layer set information decoding means may derive the number of output layers NumOptLayersInOLS[i] of the output layer set OLS#i (i=0 . . . NumOutputLayerSets−1), and a layer identifier OlsHighestOutputLayerId[i] of the highest-ordered output layer. The output layer set information decoding means may perform deriving based on the derived output layer information (OutputLayerFlag), by a pseudo code as follows. That is, the number of output layers NumOptLayersInOLS[i] of the output layer set OLS#i is the number of flags indicating that the output layer flag OutputLayerFlag[i][j] of the layer j is an “output layer”. The layer identifier of the highest-ordered output layer is a layer identifier of the highest-ordered layer of which OuputLayerFlag[i][ ] is 1 (true) in the layer ID list LayerIdList[LayerSetIdx[i]][ ] of the output layer set OLS#i.

```
NumOptLayersInOLS[i]=0;
for(j=0; j<NumLayersInIdList[LayerSetIdx[i]]; j++){
  NumOptLayersInOLS[i] += OuputLayerFlag[i][j];
  if(OuputLayerFlag[i][j]){
    OlsHighestOutputLayerId[i] =
LayerIdList[ LayerSetIdx[i] ][j];
  }
}
```

(E5: Alternative Output Layer Flag)

The alternative output_layer_flag (alt_output_layer_flag[i]) (SYNVPS0K in FIG. 12) is information indicating whether or not applying of alternative layer decoding picture output is possible. When the alternative layer decoding picture output is applied, in a case where a decoding picture of a layer designated by the output layer information is not provided, an alternative layer is designated, and a decoding picture of the alternative layer is substitutingly output. In the embodiment, a syntax element value alt_output_layer_flag[i] corresponds to alternative output layer information for the output layer set i. In a case where the value of alt_output_layer_flag[i] is true (1), the alternative layer decoding picture output is applied when the output layer set OLS#i is decoded. In a case where the value there of is false (0), the alternative layer decoding picture output is not applied.

For example, in a case where both of the following conditions (A1) and (A2) are satisfied, the output layer set information decoding means decodes the syntax element alt_output_layer_flag[i] by the coding data, and sets the value of alt_output_layer_flag[i] in the alternative output layer flag AltOutputLayerFlag[i].

(A1) Case where the number of output layers NumOptLayerslnOLS[i] of the output layer set OLS#i is 1. The case corresponds to a condition of “NumOuputlayersInOLS[i]==0” in SYNVPS0K in FIG. 12.

(A2) Case where the number of direct reference layers of an output layer which has the highest-ordered layer identifier in the output layer set OLS#i is equal to or more than 1. The case corresponds to a condition of “NumDirectRefLayers[OlsHighestOutputLayerId[i]]>0” in SYNVPS0K in FIG. 12.

In a case where the syntax element alt_output_layer_flag[i] is not decoded, the output layer set information decoding means estimates the value of the syntax element to be 0, and sets a value corresponding to not applying of the alternative layer decoding picture output, in the alternative layer output flag AltOutputLayerFlag[i]. In the embodiment, the value of AltOutputLayerFlag[i] is set to 0.

(E6: PTL•DPB Information Presence Flag)

The PTL•DPB information presence flag (ptl_dpb_present_flag[i]) (SYNVPS0L in FIG. 12) is a flag indicating whether or not a PTL designation identifier to be applied to the output layer set, and DPB information are provided in the coding data.

The output layer set information decoding means decodes the PTL•DPB information presence flag ptl_dpb_info_present_flag[i] for the output layer set Specifically, the PTL•DPB information presence flag is used for omitting decoding of the PTL•DPB information presence flag which relates to i<=vps_num_layer_sets_minus1, that is, the basic output layer set. In a case where the PTL•DPB information presence flag ptl_dpb_info_present_flag[i] is not provided in the coding data, the output layer set information decoding means estimates that the value of the PTL•DPB information presence flag is 1 (true) (ptl_dpb_info_present_flag[i]=1). In a case of i>vps_num_layer_sets_minus1, that is, the output layer set information decoding means decodes the PTL•DPB information presence flag which relates to the additional output layer set, by using the coding data.

According to the output layer set information decoding means having the above configuration, it is possible to omit decoding which relates to the PTL•DPB information presence flag regarding the basic output layer set. That is, there is an advantages in that the PTL•DPB information presence flag which relates to the basic output layer set and the additional output layer set can be decode/coded with the smaller coding amount.

Instead of the PTL•DPB information presence flag ptl_dpb_info_present_flag which is a flag for controlling the PTL identifier and the DPB information, a flag ptl_info_present_flag for controlling the PTL identifier, a flag for controlling the DPB information, or a DPB information presence flag dpb_info_present_flag may be provided. In this case, the output layer set information decoding means decodes the PTL information presence flag ptl_info_present_flag or the DPB information presence flag dpb_info_present_flag by similar processing, instead of the PTL•DPB information presence flag ptl_dpb_info_present_flag. The output layer set information decoding means may decode the PTL information presence flag ptl_info_present_flag and the DPB information presence flag dpb_info_present_flag by similar processing.

The output layer set information decoding means may decode one PTL•DPB information presence flag as ptl_dpb_info_present_flag, without decoding ptl_dpb_info_present_flag[i] for each output layer set

(E7: PTL designation identifier)

The PTL designation identifier (profile_level_tier_idx) (SYNVPS0M in FIG. 12) is a syntax element for designating PTL information which is applied to the output layer set. PTL information designated by the PTL designation identifier (profile_level_tier_idx[i]) is applied to the output layer set OLS#i.

In a case where the value of the PTL•DPB information presence flag (ptl_dpb_info_present_flag[i]) of the output layer set OLS#i is 1 (true), the output layer set information decoding means decodes the PTL designation identifier (profile_level_tier_idx[i]) by using the coding data.

In a case where a plurality of output layer sets associated with the same layer set is provided, the output layer set information decoding means in the embodiment decodes the PTL designation identifier of one output layer set (basic output layer set), from the coding data. PTL designation identifiers of other output layer sets (additional output layer sets) are not provided in the coding data, and the output layer set information decoding means derives the PTL designation identifier of an output layer set which is not provided by allocating the PTL designation identifier (which has been already decoded) of an output layer set associated with the same layer set.

Specifically, in a case where the value of the PTL•DPB information present flag (ptl_dpb_info_present_flag[i]) of the output layer set OLS#i is 0 (false), the output layer set information decoding means omits decoding of the PTL designation identifier, and estimates the value of the same identifier to be equal to the value of the PTL designation identifier of the basic output layer set OLS#lsIdx indicated by the layer set identifier (lsIdx=output_layer_set_index_minus1[i]+1) of the output layer set OLS#i.

The output layer set information decoding means applies PTL information designated by the PTL designation identifier (profile_level_tier_idx [i]) which has been decoded or estimated, to the output layer set OLS#i.

According to the output layer set information decoding means having the above configuration, in a case where the PTL•DPB information present flag of the output layer set OLS#i is 0, it is possible to omit decoding/coding of the PTL designation identifier (profile_level_tier_idx[i]). That is, there is an advantage in that the PTL designation identifier which relates to the basic output layer set and the additional output layer set can be decoded/coded with the smaller coding amount.

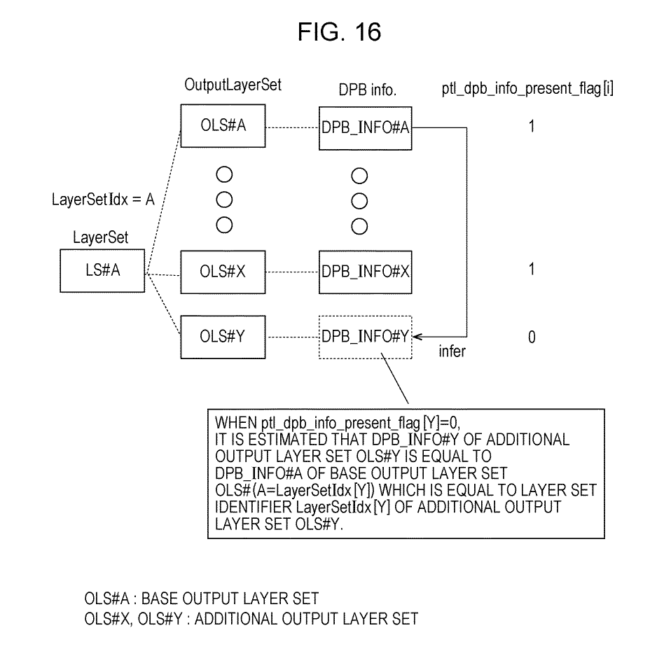

In the example, as illustrated in FIG. 16, regarding the basic output layer set OLS#A which is one out of output layer sets associated with the same layer set, the PTL designation identifier and the DPB information are explicitly decoded. Regarding the additional output layer set OLS#X which is an output layer other than the output layer which is associated with the same layer set, if the PTL•DPB information present flag is 1 (true), the PTL designation identifier and the DPB information of OLS#X are explicitly decoded. If the PTL•DPB information present flag of the additional output layer set OLS#Y is 0 (false), estimation is performed from the PTL designation identifier and the DPB information of the basic output layer set OLS#A associated with a layer set which is the same as that of the additional output layer set. Thus, the PTL designation identifier and the DPB information of the output layer set can be decoded/coded with the smaller coding amount.

In a case where a flag dpb_info_present_flag for controlling coding of the PTL identifier is provided instead of the PTL•DPB information present flag ptl_dpb_info_present_flag which is a flag for controlling the PTL designation identifier and the DPB information, the output layer set information decoding means replaces the PTL•DPB information present flag ptl_dpb_info_present_flag with a PTL information present flag dpb_info_present_flag in the above processing. In this case, the above advantage for the PTL designation identifier is also obtained.

In a case where not ptl_dpb_info_present_flag[i] for each output layer set i, but one PTL•DPB information present flag ptl_dpb_info_present_flag is used, the output layer set information decoding means normally decodes the PTL designation identifier for an output layer set (basic output layer set) of i<=vps_num_layer_sets_minus1, among output layer sets having index i. The output layer set information decoding means performs decoding for an output layer set (extension output layer set) of i>vps_num_layer_sets_minus1 other than the basic output layer set, in a case where ptl_dpb_info_present_flag is 1. The PTL designation identifier of an output layer set which is not provided is derived by profile_level_tier_idx[i]=profile_level_tier_idx[output_layer_set_idx_minus1[i]].

(Modification Example of Output Layer Set Information Decoding Means)

The output layer set information decoding means decodes or estimates the PTL designation identifier based on the PTL•DPB information present flag. However, it is not limited thereto. For example, the output layer set information decoding means may decode the PTL designation identifier based on whether an output layer set is a basic output layer set or an additional output layer set, without decoding the PTL•DPB information present flag.

That is, in a case where an output layer set OLS#i is a basic output layer set OLS#i (i=1 . . . VpsNumLayerSets−1), the output layer set information decoding means decodes the PTL designation identifier (profile_level_tier_idx[i]) by using the coding data. In a case where the output layer set OLS#i is an additional output layer set OLS#i (i=VpsNumLayerSets . . . NumOutputLayerSets−1), the output layer set information decoding means omits decoding of the PTL designation identifier, and estimates the value of the same identifier to be equal to the value of the PTL designation identifier of the basic output layer set OLS#lsIdx indicated by the layer set identifier (lsIdx=output_layer_set_index_minus1[i]+1) of the output layer set OLS#i. In other words, in a case where an index of the output layer set OLS#i satisfies i<VpsNumLayerSets, the output layer set information decoding means decodes PTL designation identifier. In a case of i>=VpsNumLayerSets, the output layer set information decoding means estimates the PTL designation identifier. Thus, there are advantages in that it is possible to omit decoding/coding of the PTL designation identifier (profile_level_tier_idx[i]) which relates to the additional output layer set OLS#i (i=VpsNumLayerSets . . . NumOutputLayerSets−1), and it is possible to decode/code the PTL designation identifier which relates to the basic output layer set and the additional output layer set, with the smaller coding amount.

(DPB Information)

The DPB information is information indicating the maximum size and the like for a decoding picture held in the buffer (DPB) by a decoder in order to decode an output layer set. The DPB information is decoded from the VPS or the SPS by the DPB information decoding means.

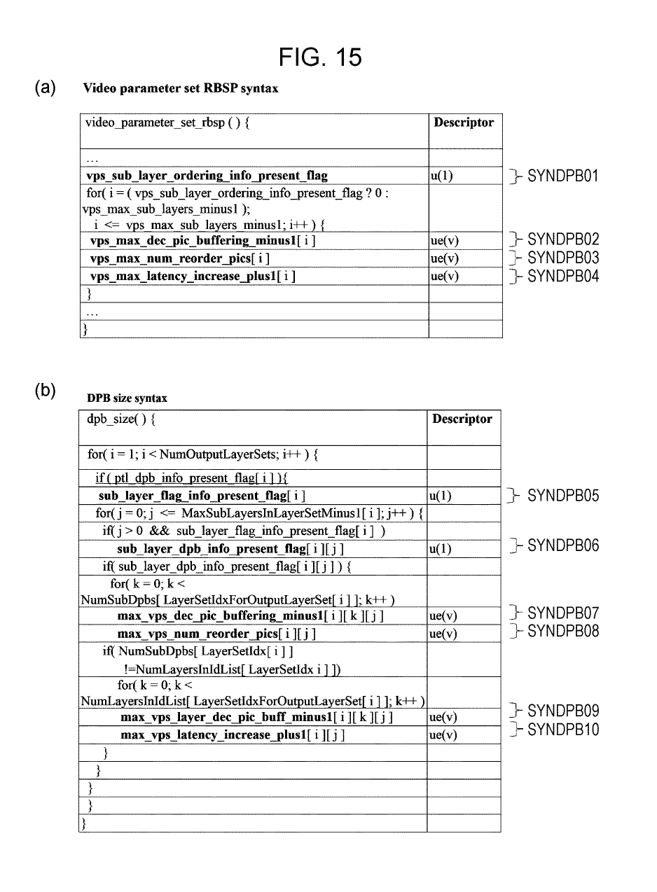

The DPB information decoding means decodes DPB information corresponding to the output layer set OLS#0, from pieces of syntax SYNDPB01 to SYNDPB04 (vps_sub_layer_ordering_info_present_flag, vps_max_dec_pic_buffering_minus1[ ], vps_max_num_reorder_pics[ ], and vps_max_latency_increase_plus1[ ]), or syntax in which “vps” in the pieces of syntax SYNDPB01 to SYNDPB04 is replaced with “sps” on the SPS. The pieces of syntax SYNDPB01 to SYNDPB04 are on the VPS included in the coding data, and illustrated in FIG. 15(a). The meaning of each of the pieces of syntax is as follows. In the following syntax, “x” at the leading corresponds to “vps” or “sps”.

x_sub_layer_ordering_info_present_flag: x_sub_layer_ordering_info_present_flag indicates that the DPB information (x_dec_pic_buffering_minus1[ ], x_max_num_reorder_pics[ ], and x_max_latency_increase_plus1[ ]) is provided in all sublayers of the output layer set OLS#0, in a case where the same flag is 1. In a case where the same flag is 0, the (vps_max_sub_layers_minus1)-th value of the three types of syntax sequences is applied to all sublayers.

x_max_dec_pic_buffering_minus1 [ ]:x_max_dec_pic_buffering_minus1[ ] indicates “the maximum number of requests −1” of the number of pictures stored in the buffer (DPB).

x_max_num_reorder_pics[ ]:x_max_num_reorder_pics[ ] indicates the maximum allowable number of pictures which can be ahead of a picture in a decoding order, and follow the picture in a display order, in a case of the picture such as a B picture, of which the decoding order and the display order are different from each other in a hierarchy structure.

x_max_latency_increase_plus1[ ]:x_max_latency_increase_plus1[ ] indicates a value used when a variable x_MaxLatencyPictures[ ] is calculated. The variable x_MaxLatencyPictures[ ] indicates the maximum number of pictures which are ahead of a picture in a display order and follow the picture in a decoding order. The variable x_MaxLatencyPictures[ ]=(x_max_num_reorder_pics[ ]+x_max_vps_latency_increase_plus1[ ][ ]−1).

The DPB information decoding means decodes DPB information corresponding to the output layer set OLS#i (i=1 . . . NumOutputLayerSets−1), from pieces of syntax SYNDPB05 to SYNDPB10 illustrated in FIG. 15(b), in DPB_SIZE( ) (FIG. 15(b)) indicated by SYNVPS0M on the VPS which is included in the coding data. The meaning of each of the pieces of syntax is as follows.

sub_layer_flag_info_present_flag[i] (SYNDPB05): sub_layer_flag_info_present_flag[i] indicates that a sublayer DPB information present flag (sub_layer_dpb_info_present_flag[i][j]) of the output layer set OLS#i is provided in the coding data, in a case where a sublayer information present flag [i] (the same flag) is 1. In a case where the same flag is 0, the sublayer DPB information present flag is not provided in the coding data, and the value of the sublayer DPB information present flag is estimated to be 0.

sub_layer_dpb_info_prenset_flag[i][j] (SYNDPB06): sub_layer_dpb_info_prenset_flag[i][j] indicates that max_vps_dec_pic_buffering_minus1[i][k][j], max_vps_num_reorder_pics[i][k][j], and max_vps_latency_increase_plus1[i][k][j]) which relate to a sublayer j are provided, in a case where a matrix [i][j](the same flag) is 1. In a case where the same flag is 0, the three types of syntax is estimated to be equal to the value of the syntax sequence of a sublayer (j−1).

max_vps_dec_pic_buffering_minus1[i][k][j] (SYNDPB07): max_vps_dec_pic_buffering_minus1[i][k][j] indicates “maximum number of requests −1” of the number of pictures stored in the k-th sub-buffer (sub-DPB), in the output layer set OLS#i.

max_vps_layer_dec_pic_buff_minus1[i][k][j] (SYNDPB08): max_vps_layer_dec_pic_buff_minus1[i][k][j] indicates “maximum number of requests −1” of the number of pictures of the k-th picture stored in the buffer (DPB), in the output layer set OLS#i.

max_vps_num_reorder_pic[i][j] (SYNDPB09): max_vps_num_reorder_pic[i][j] indicates the maximum allowable number of pictures which can be ahead of a picture in a decoding order, and follow the picture in a display order, in the k-th layer k in the output layer set OLS#i, in a case of the picture such as a B picture, of which the decoding order and the display order are different from each other in a hierarchy structure.

max_vps_latency_increase_plus1[i][j] (SYNDPB10): max_vps_latency_increase_plus1[i][j] indicates a value used when a variable MaxLatencyPictures[ ] is calculated. The variable MaxLatencyPictures[ ] indicates the maximum number of pictures which are ahead of a picture in a display order and follow the picture in a decoding order. The variable MaxLatencyPictures[i][j]=(max_vps_num_reorder_pics[i][j]+max_vps_latency_increase_plus1[i][j]−1).

In a case where a plurality of output layer sets associated with the same layer set is provided, the output layer set information decoding means in the embodiment decodes a PTL designation identifier of one output layer set (basic output layer set) from coding data. PTL designation identifiers of other output layer sets (additional output layer sets) are not provided in the coding data. The output layer set information decoding means derives the PTL designation identifier of an output layer set which is not provided by allocating the PTL designation identifier (which has been already decoded) of an output layer set associated with the same layer set.

More specifically, in a case where the value of the PTL•DPB information present flag (ptl_dpb_info_present_flag[i]) of the output layer set OLS#i (i=1 . . . NumOutputLayerSets−1) is 1 (true), the DPB information decoding means decodes syntax SYNDPB05 to SYNDPB10 illustrated in FIG. 15(b), as DPB_INFO#i, by using the coding data.

In a case where the value of the PTL•DPB information present flag (ptl_dpb_info_present_flag[i]) of the output layer set OLS#i is 0 (false), the DPB information decoding means omits decoding of the syntax SYNDPB05 to SYNDPB10 illustrated in FIG. 15(b), and estimates DPB information DPB_INFO#i of the output layer set OLS#i to be equal to DPB information DPB_INFO#lsIdx of the basic output layer set OLS#lsIdx indicated by the layer set identifier (lsIdx=output_layer_set_index_minus1[i]+1) of the output layer set OLS#i. That is, DPB_INFO#i=DPB_INFO#lsIdx is satisfied.

The DPB information decoding means applies the DPB information DPB_INFO#i which has been decoded or estimated, to the output layer set OLS#i. Thus, in a case where the PTL•DPB information present flag of the output layer set OLS#i is 0, decoding/coding of the DPB information DPB_INFO#i (syntax SYNDPB05 to SYNDPB10 illustrated in FIG. 15(b)) can be omitted. That is, there is an advantage in that the DPB information DPB_INFO#i of the basic output layer set and the additional output layer set can be decoded/coded with the smaller coding amount.

In the example, as illustrated in FIG. 16, regarding the basic output layer set OLS#A which is one out of output layer sets associated with the same layer set, the DPB information and the PTL designation identifier are explicitly decoded. Regarding the additional output layer set OLS#X which is an output layer other than the output layer which is associated with the same layer set, if the PTL•DPB information present flag is 1 (true), the DPB information and the PTL designation identifier of OLS#X are explicitly decoded. If the PTL•DPB information present flag of the additional output layer set OLS#Y is 0 (false), estimation is performed from the DPB information and the PTL designation identifier of the basic output layer set OLS#A associated with a layer set which is the same as that of the additional output layer set. Thus, the DPB information and the PTL designation identifier of the output layer set can be decoded/coded with the smaller coding amount. In a case where a flag dpb_info_present_flag for controlling coding of the DPB information is provided instead of the PTL•DPB information present flag ptl_dpb_info_present_flag which is a flag for controlling the PTL designation identifier and the DPB information, the output layer set information decoding means replaces the PTL•DPB information present flag ptl_dpb_info_present_flag with a DPB information present flag dpb_info_present_flag in the above processing. In this case, the above advantage for the DPB information is also obtained.

In a case where not ptl_dpb_info_present_flag[i] for each output layer set i, but one PTL•DPB information present flag ptl_dpb_info_present_flag is used, the output layer set information decoding means decodes the DPB information for an output layer set (basic output layer set) of i<=vps_num_layer_sets_minus1, among output layer sets having index i. The output layer set information decoding means decodes the DPB information for an output layer set (extension output layer set) of i>vps_num_layer_sets_minus1 other than the basic output layer set, in a case where ptl_dpb_info_present_flag is 1. The DPB information of an output layer set which is not provided and has an identifier i is derived by the DPB having an identifier output_layer_set_idx_minus1[i].

(Modification Example of DPB Information Decoding Means)

The DPB information decoding means decodes or estimates the DPB information based on the PTL•DPB information present flag. However, it is not limited thereto. For example, the DPB information decoding means may decode the DPB information based on whether an output layer set is a basic output layer set or an additional output layer set, without using the PTL•DPB information present flag.

That is, in a case where an output layer set OLS#i is a basic output layer set OLS#i (i=1 . . . VpsNumLayerSets−1), the DPB information decoding means decodes DPB information DPB_INFO#i corresponding to the output layer set OLS#i, by using the coding data. In a case where the output layer set OLS#i is an additional output layer set OLS#i (i=VpsNumLayerSets . . . NumOutputLayerSets−1), the DPB information decoding means does not decode the DPB information DPB_INOF#i corresponding to the output layer set OLS#i, by using the coding data, and estimates the DPB information DPB_INOF#i to be equal to DPB information DPB_INOF#lsIdx of the basic output layer set OLS#lsIdx indicated by the layer set identifier (lsIdx=output_layer_set_index_minus1[i]+1) of the output layer set OLS#i. In other words, in a case where an index of the output layer set OLS#i satisfies i<VpsNumLayerSets, the DPB information decoding means decodes the DPB information DPB_INFO#i. In a case of i>=VpsNumLayerSets, the DPB information decoding means estimates the DPB information DPB_INFO#i. Thus, there are advantages in that it is possible to omit decoding/coding of the DPB information DPB_INFO#i which relates to the additional output layer set OLS#i (i=VpsNumLayerSets . . . NumOutputLayerSets−1), and it is possible to decode/code the DPB information DPB_INFO#i which relates to the basic output layer set and the additional output layer set, with the smaller coding amount.

(Output Control Unit 16)

The output control unit 16 derives a target output layer ID list TargetOptLayerIdList[ ] and a decoding layer ID list, and outputs the derived target output layer ID list TargetOptLayerIdList[ ] and decoding layer ID list to the decoding picture management unit 15.

The output control unit 16 derives the target output layer ID list TargetOptLayerIdList[ ] as output control information, based on an output layer set identifier TargetOLSIdx), a layer set LayerIdList[ ][ ], and an output layer flag OutputLayerFlag[ ][ ]. The output layer set identifier TargetOLSIdx) is output designation information supplied from the outside.

Syntax of an active parameter set (active VPS) to which the output control unit 16 refers, and a variable derived by the syntax are assumed to be completely decoded, and to be stored in the parameter memory 13. In order to specify the active VPS, an active VPS identifier may be included in the output designation information.

Firstly, the output control unit 16 selects an output layer set OLS#TargetOLSIdx as a processing target. The output layer set OLS#TargetOLSIdx is designated by an output layer set identifier TargetOLSIdx which is included in the output designation information. The output control unit 16 derives a target output layer ID list TargetOptLayerIdList[ ] by using the following pseudo code (output layer ID list deriving means).

(Pseudo Code Indicating Deriving of TargetOptLayerIdList)

```
for(k=0; j=0; j<
NumLayersInIdList[LayerSetIdx[TargetOLSIdx]]; j++){ //SA01
  if(OutputLayerFlag[TargetOLSIdx][j]){ //SA02
    TargetOptLayerIdList[k] =
LayerIdList[LayerSetIdx[TargetOLSIdx]][j]; //SA03
    k++; //SA04
  }
} // end of loop //SA05
```

The pseudo code is expressed in a form of a step, as follows.

(SA01) SA01 is a start point of a loop relating to deriving of a target output layer ID list TargetOptLayerIdList[ ]. Before the loop is started, a variable k and a variable j are initialized so as to be 0. A loop variable in the following repetitive processes is the variable j. The output control unit 16 performs processes indicated by SA02 to SA04 for the variable j of 0 to (NumLayersInIdList[LayerSetIdx[TargetOLSIdx]]−1).

Here, LayerSetldx[TargetOLSIdx] is a layer set identifier indicated by TargetOLSIdx, and NumLayersInIdList[x] is the number of layers in a layer set indicated by a layer set identifier x. Thus, NumLayersInIdList[LayerSetldx[TargetOLSIdx]] is the number of layers included in a layer set LS#(LayerSetldx[TargetOLSIdx]) which is associated with the target output layer set OLS# (TargetOLSIdx).

(SA02) It is determined whether or not each layer included in the target output layer set is an output layer. Specifically, in the target output layer set, in a case where an output layer flag OutputLayerFlag[TargetOLSIdx][j] of a layer indicated by the variable j is 1 (true) (in a case of being an output layer), the process transitions to Step SA04. In a case where the output layer flag OutputLayerFlag[TargetOLSIdx][j] is 0 (false) (in a case of not being an output layer), the process transitions to Step SA0A.

(SA03) A layer of which an output_layer_flag is 1 (output layer) in the target output layer set is derived as the output layer ID list TargetOptLayerIdList[ ]. Specifically, the j-th element of the layer set LS#(LayerSetldx[TargetOLSIdx]) associated with the output layer set OLS#(TargetOLSIdx) is added to the k-th element of the output layer ID list TargetOptLayerIdList[ ] of the output layer set OLS#(TargetOLSIdx). That is, TargetOptLayerIdList[k]=LayerIdList[LayerSetIdx[TargetOLSIdx]][j];

(SA04) “1” is added to the variable k.

(SA05) SA05 is a termination of the loop which relates to deriving the layer ID list TargetOptLayerIdList[ ] of the target output layer set OLS#(TargetOLSIdx).

(Deriving of Target Decoding Layer ID List)

Decoding layer ID list deriving means (not illustrated) included in the output control unit 16 derives a target decoding layer ID list TargetDecLayerIdList[ ] based on the target output layer ID list TargetOptLayerIdList, the layer set LayerIdList[ ][ ] of the active VPS, which is held in the parameter memory 13, and a dependency flag derived by the inter-layer dependency information. The target decoding layer ID list TargetDecLayerIdList[ ] indicates a configuration of layers required for decoding a target output layer set. TargetDecLayerIdList[ ] which has been derived is supplied as a portion of the output control information, to the bitstream extraction unit 17 and the target set picture unit 10.

The decoding layer ID list deriving means derives the target decoding layer ID list by using the following pseudo code, for example.

(Pseudo Code 1 Indicating Deriving of Targetdeclayeridlist)

```
for(i=0,j=0; j<
NumLayersInIdList[LayerSetIdx[TargetOLSIdx]]; j++){ //SB01
  iNuhLId =
layer_id_in_nuh[LayerIdList[LayerSetIdx[TargetOLSIdx]][j]];
  //SB02
  for(refLayerFlag=0, k=0; k<
NumOptLayersInOLS[TargetOLSIdx]; k++){ //SB03
    iOptLayerId = layer_id_in_nuh[TargetOptLayerIdList[k]];
//SB04
    refLayerFlag =
(refLayerFlag|recursiveRefLayerFlag[iOptLayerId][iNuhLId]);
//SB05
  } //SB06
  if(OutputLayerFlag[TargetOLSIdx][j] ||
refLayerFlag){ //SB07
    TargetDecLayerId[i] =
LayerIdList[LayerSetIdx[TargetOLSIdx]][j]; //SB08
    i++; //SB09
  }
} //SB10
```

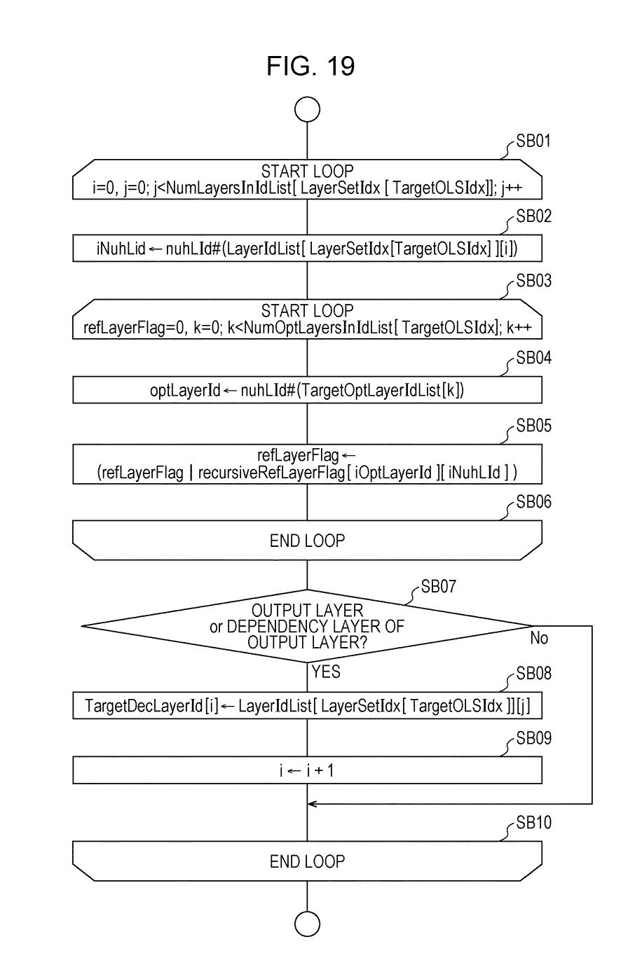

The pseudo code is expressed in a form of a step, as follows. The step numbers SB01 to SB10 respectively correspond to the step number SB01 to SB10 of the pseudo code, and the flowchart which relates to deriving of the target decoding layer ID list and is illustrated in FIG. 19.

(SB01) SB01 is a start point of a loop relating to deriving of the target decoding layer ID list TargetDecLayerIdList[ ]. The variable i and the variable j are initialized so as to be 0. A loop variable in the following repetitive processes is the variable j. The decoding layer ID list deriving means performs the processes indicated by SB02 to SB08, for the variable j of 0 to (NumLayersInIdList[LayerSetIdx[TargetOLSIdx]]−1).

(SB02) The decoding layer ID list deriving means derives a layer identifier of a layer (below, target layer j) which is included in the output layer set and is identified by the variable j. Specifically, the decoding layer ID list deriving means sets a layer identifier of the j-th element (target layer j) (LayerIdList[LayerSetIdx[TargetOLSIdx]][j]) of the layer set LS#(LayerSetldx[TargetOLSIdx]) associated with the output layer set OLS#(TargetOLSIdx), in the variable iNuhLId.

(SB03) The decoding layer ID list deriving means derives a flag refLayerFlag by the processes of SB03 to SB05. The flag refLayerFlag indicates whether or not a layer (target layer j) of a layer set associated with the output layer set is a dependency layer (direct reference layer or indirect reference layer) of a target output layer TargetOptLayerIdList[k] which is a layer of which the output layer flag is 1.

The decoding layer ID list deriving means determines a dependency flag recursiveRefLayerFlag[layer ID of output layer k][layer ID of target layer j], for each of layers (below, output layer k) belonging to the target output layer TargetOptLayerIdList[k]. The dependency flag recursiveRefLayerFlag[layer ID of output layer k][layer ID of target layer j] indicates whether or not the target layer j depends on the output layer k. If even one layer in which the dependency flag recursiveRefLayerFlag[ ][ ] is 1 is provided, the decoding layer ID list deriving means sets a target layer dependency flag refLayerFlag to 1. The target layer dependency flag refLayerFlag indicates whether or not the target layer j is a dependency layer of the output layer k.

In SB03, before the loop is started, the variable k and the flag refLayerFlag are initialized so as to be 0. The process in the loop is performed when the variable k is less than the number of output layers “NumOptLayerIdList[TargetOptLayerIdx]”. Every time the process in the loop is performed one time, “1” is added to the variable k.

(SB04) A layer identifier of the output layer TargetOptLayerIdList[k] is set in the variable iOptLayerId.

(SB05) A value of the AND operation between the flag refLayerFlag and the dependency flag recursiveRefLayerFlag of the target layer j having a layer identifier iNuhLId for the output layer TargetOptLayerIdList[k] which has a layer identifier iOptLayerId is set in the flag refLayerFlag.

(SB06) SB06 is a loop termination of Step SB03.

(SB07) The decoding layer ID list deriving means determines whether the target layer j is an output layer or a dependency layer of an output layer in the target output layer set TargetOptLayerSet. In a case where the output layer flag OutputLayerFlag[TargetOLSIdx][j] of the target layer j is 1 (true), or the target layer dependency flag refLayerFlag of the target layer j is 1 (true), Steps SB08 and SB09 are performed.

(SB08) In a case where the target layer j is an output layer or a dependency layer of the output layer, the decoding layer ID list deriving means derives the target layer j as an element of the target decoding layer ID list TargetDecLayerIdList[ ]. Specifically, the decoding layer ID list deriving means adds the j-th element of the layer set LayerSetldx[TargetOLSIdx] associated with the target output layer set TargetOptLayerSet, to the i-th element of the target decoding layer ID list TargetDecLayerIdList[ ].

In the process, a layer of non-output (output layer flag OutputLayerFlag[TargetOLSIdx][j] is 0) and non-dependency (refLayerFlag is 0) is excluded. That is, the decoding layer ID list deriving means includes all layers (output layers or dependency layers) in the target decoding layer ID list, excluding a layer which is a non-output and non-reference layer, in the output layer set TargetOptLayerSet.

(SB09) “1” is added to the variable

(SB10) SB10 is a loop termination of Step SB01.

The deriving procedure of the dependency flag is not limited to the above steps, and may be changed in a range allowed to be performed. For example, in Step SB05, the value of the flag refLayerFlag may use ‘+’ which is an operator of the sum, instead of the operator ‘|’ of the AND operation.

As described above, the target output layer ID list TargetOptLayerIdList is information derived from the output layer flag OutputLayerFlag[ ][ ] by the output control unit 16. Thus, if all cases are assumed, the output control unit 16 derives the target decoding layer ID list by using the output layer set identifier TargetOLSIdx, the layer set LayerIdList[ ][ ], the output layer flag OutputLayerFlag[ ][ ], and the dependency flag recursiveRefLayerFlag.

The output control unit 16 having the above configuration derives the target decoding layer ID list TargetDecLayerIdList[ ] for layers set as a decoding target, in accordance with whether each layer in a layer set associated with the target output layer set TargetOptLayerSet is an output layer of the target output layer set or a dependency layer of the output layer. That is, the output control unit 16 does not include a layer (non-output and non-reference layer) which is not required for decoding an output layer of the target output layer set, in the target decoding layer ID list TargetDecLayerIdList[ ]. Thus, the target set picture decoding unit 10 may omit decoding of the non-output and non-reference layer. Similarly, the output control unit 16 having the above configuration does not include a NAL unit which is not required for decoding an output layer of the target output layer set, and has a layer identifier of the non-output and non-reference layer, in the target decoding layer ID list TargetDecLayerIdList. Thus, the bitstream extraction unit 17 discards these layers.

(Modification Example 1 of Deriving of Target Decoding Layer ID List Targetdeclayeridlist)

Regardless of an output layer or a dependency layer of the output layer, the output control unit may be an output control unit 16a. The output control unit 16a includes a layer which has a layer identifier of a specific layer, in the target decoding layer ID list TargetDecLayerIdList. For example, the output control unit 16a may include a layer (base layer) having a layer identifier of 0, as a specific layer, and derive the target decoding layer ID list TargetDecLayerIdList. In this case, a conditional expression of Step SB07 for a pseudo code which indicates deriving of the target decoding layer ID list TargetDecLayerIdList is changed to the following conditional expression (A1) or (A2).

(SB07a)

if(OutputLayerFlag[TargetOLSIdx][j]
|| refLayerFlag
|| LayerIdList[LayerSetIdx[TargetOLSIdx]][j] == 0) ...(A1)
if(OutputLayerFlag[TargetOLSIdx][j]
|| refLayerFlag
||
layer_id_in_nuh[(LayerIdList[ LayerSetIdx[TargetOLSIdx]][j])
== 0) ...(A2)

According to the expression (A1) or (A2), the output control unit 16a determines whether the target layer j is an output layer, or a dependency layer for an output layer in the target output layer set TargetOptLayerSet, and determines whether the layer identifier of the target layer j is 0. In a case where the output_layer_flag OutputLayerFlag[TargetOLSIdx][j] is 1 (true), the flag refLayerFlag is 1 (true), or the target layer j is a base layer (layer identifier of layer j is 0), the output control unit 16a performs Steps SB08 and SB09.

The output control unit 16a having the above configuration sets an output layer of the target output layer set, a dependency layer of the output layer, and a layer (base layer) which is designated to be required in a profile and the like, as a layer functioning as a decoding target, for the target output layer set TargetOptLayerSet. The output control unit 16a derives the target decoding layer ID list TargetDecLayerIdList[ ] by using the set layers. That is, the output control unit 16a does not include a layer which is not required for decoding the output layer of the target output layer set, and is a non-output, non-reference layer, and non-base layer, in the target decoding layer ID list TargetDecLayerIdList[ ]. Thus, the target set picture decoding unit 10 may omit a non-output and non-reference layer which is not required for decoding the output layer, in a case where the layer is not a layer (here, base layer) designated as being required in a profile. Similarly, the output control unit 16 having the above configuration does not include a NAL unit which is not required for decoding an output layer of the target output layer set and has a layer identifier of a non-output and non-reference layer, in the target decoding layer ID list TargetDecLayerIdList in a case where the layer is not a layer (here, base layer) designated as being required in a profile. Thus, the bitstream extraction unit 17 discards these layers.

(Modification Example 2 of Deriving of Target Decoding Layer ID List TargetDecLayerIdList)

The output control unit may be an output control unit 16b. The output control unit 16b includes a primary picture layer in the target output layer set, in the target decoding layer ID list TargetDecLayerIdList.

That is, the decoding layer ID list deriving means (not illustrated) included in the output control unit 16b derives a target decoding layer ID list TargetDecLayerIdList[ ], based on the layer set LayerIdList[ ][ ] of the active VPS, which is held in the parameter memory 13, and the auxiliary picture layer ID (AuxId[ ]) derived by the scalable identifier. The target decoding layer ID list TargetDecLayerIdList[ ] indicates a configuration of layers required for decoding the target output layer set. TargetDecLayerIdList[ ] which has been derived is supplied as a portion of the output control information, to the bitstream extraction unit 17 and the target set picture unit 10. Because target output layer ID list means included in the output control unit 16b is the same as the target output layer ID list deriving means included in the output control unit 16, descriptions thereof will be omitted.

The decoding layer ID list deriving means derives a target decoding layer ID list by using the following pseudo code, for example.

(Pseudo Code 2 Indicating Deriving of TargetDecLayerIdList)

```
for(i=0,j=0; j<
NumLayersInIdList[LayerSetIdx[TargetOLSIdx]]; j++){ //SC01
  iNuhLId =
layer_id_in_nuh[ LayerIdList[LayerSetIdx[TargetOLSIdx]][j]];
  //SC02
  if(AuxId[iNuhLId] == 0){ //SC03
    TargetDecLayerId[i] =
LayerIdList[LayerSetIdx[TargetOLSIdx]][j]; //SC04
    i++; //SC05
  }
} //SC06
```

The pseudo code is expressed in a form of a step, as follows. The step numbers SC01 . . . SC06 respectively correspond to the step numbers SC01 . . . SC06 of the pseudo code.

(SC01) SC01 is a start point of a loop relating to deriving of the target decoding layer ID list TargetDecLayerIdList[ ]. The variable i and the variable j are initialized so as to be 0. A loop variable in the following repetitive processes is the variable j. The decoding layer ID list deriving means performs processes indicated by SC02 to SC06 for the variable j of 0 to (NumLayersInIdList[LayerSetldx[TargetOLSIdx] ]−1).

(SC02) The decoding layer ID list deriving means derives a layer identifier of a layer (below, target layer j) which is included in the output layer set and is identified by the variable j. Specifically, the decoding layer ID list deriving means sets a layer identifier of the j-th element (target layer j)(LayerIdList[LayerSetIdx[TargetOLSIdx]][j]) of the layer set LS#(LayerSetldx[TargetOLSIdx]) associated with the output layer set OLS#(TargetOLSIdx), in the variable iNuhLId.

(SC03) The decoding layer ID list deriving means determines whether the target layer j is a primary picture layer. In a case where an auxiliary picture layer ID (AuxId[iNuhLId]) of the target layer j is 0, the decoding layer ID list deriving means determines that the target layer j is a primary picture layer, and performs Steps SC04 and SC05.

(SC04) In a case where the target layer j is a primary picture layer, the decoding layer ID list deriving means derives the target layer j as an element of the target decoding layer ID list TargetDecLayerIdList[ ]. Specifically, the decoding layer ID list deriving means adds the j-th element of the layer set LayerSetldx[TargetOLSIdx] associated with the target output layer set TargetOptLayerSet, to the i-th element of the target decoding layer ID list TargetDecLayerIdList[ ].

In the process, a layer of which the auxiliary picture layer ID is more than 0 (which is an auxiliary picture layer) is excluded. That is, the decoding layer ID list deriving means includes all primary picture layers in the target decoding layer ID list, excluding an auxiliary picture layer, in the output layer set TargetOptLayerSet.

(SC05) “1” is added to the variable

(SC06) SC06 is a loop termination of Step SC01.

The deriving procedure of the target decoding layer ID list is not limited to the above steps, and may be changed in a range allowed to be performed.

The output control unit 16b having the above configuration derives the target decoding layer ID list TargetDecLayerIdList[ ] for layers set as a decoding target, in accordance with whether each layer in a layer set associated with the target output layer set TargetOptLayerSet is a primary picture layer (not an auxiliary picture layer). That is, the output control unit 16b does not include an auxiliary picture layer (AuxId[ ]>0) which is not required for decoding a primary picture layer of the target output layer set, in the target decoding layer ID list TargetDecLayerIdList[ ]. Thus, the target set picture decoding unit 10 may omit decoding of an auxiliary picture layer. Similarly, the output control unit 16b having the above configuration does not include a NAL unit which is not required for decoding a primary picture layer of the target output layer set, and has a layer identifier of an auxiliary picture layer, in the target decoding layer ID list TargetDecLayerIdList. Thus, the bitstream extraction unit 17 discards a NAL unit which has a layer identifier of the auxiliary picture layer.

(Modification Example 3 of Deriving of Target Decoding Layer ID List TargetDecLayerIdList)

The output control unit 16 may be an output control unit 16c. The output control unit 16c includes an auxiliary picture layer which is an output layer, and a primary picture layer in a target output layer set, in the target decoding layer ID list TargetDecLayerIdList.

That is, the decoding layer ID list deriving means (not illustrated) included in the output control unit 16c derives a target decoding layer ID list TargetDecLayerIdList[ ], based on an output_layer_flag OutputLayerFlag[TargetOLSIdx][ ] of the target output layer set, a layer set LayerIdList[ ][ ] of the active VPS, which is held in the parameter memory 13, and an auxiliary picture layer ID (AuxId[ ]) derived by the scalable identifier. The target decoding layer ID list TargetDecLayerIdList[ ] indicates a configuration of layers required for decoding the target output layer set. TargetDecLayerIdList[ ] which has been derived is supplied as a portion of the output control information, to the bitstream extraction unit 17 and the target set picture unit 10. Because the target output layer ID list means included in the output control unit 16c is the same as the target output layer ID list deriving means included in the output control unit 16, descriptions thereof will be omitted.

The decoding layer ID list deriving means derives a target decoding layer ID list by using the following pseudo code, for example.

(Pseudo Code 3 Indicating Deriving of TargetDecLayerIdList)

```
for(i=0,j=0; j<
NumLayersInIdList[LayerSetIdx[TargetOLSIdx]]; j++){ //SD01
  iNuhLId =
layer_id_in_nuh[LayerIdList[LayerSetIdx[TargetOLSIdx]][j]];
  //SD02
  if(AuxId[iNuhLId] == 0 ||
  (AuxId[iNuhLId] > 0 &&
OutputLayerFlag[TargetOLSIdx][j]>0)){ //SD03
  TargetDecLayerId[i] =
LayerIdList[ LayerSetIdx[TargetOLSIdx]][j]; //SD04
    i++; //SB05
  }
} //SB06
```

The pseudo code is expressed in a form of a step, as follows. The step numbers SD01 . . . SD06 respectively correspond to the step number SD01 . . . SD06 of the pseudo code.

(SD01) SD01 is a start point of a loop relating to deriving of the target decoding layer ID list TargetDecLayerIdList[ ]. The variable k and the variable j are initialized so as to be 0. A loop variable in the following repetitive processes is the variable j. The decoding layer ID list deriving means performs the processes indicated by SD02 to SD06, for the variable j of 0 to (NumLayersInIdList[LayerSetIdx[TargetOLSIdx]]−1).

(SD02) The decoding layer ID list deriving means derives a layer identifier of a layer (below, layer j) which is included in the output layer set and is identified by the variable j. Specifically, the decoding layer ID list deriving means sets a layer identifier of the j-th element (target layer j) (LayerIdList[LayerSetIdx[TargetOLSIdx]][j]) of the layer set LS#(LayerSetldx[TargetOLSIdx]) associated with the output layer set OLS#(TargetOLSIdx), in the variable iNuhLId.

(SD03) The decoding layer ID list deriving means determines whether the target layer j is a primary picture layer or an auxiliary picture layer which is an output layer. In a case where an auxiliary picture layer ID (AuxId[iNuhLId]) of the target layer j is 0 or in a case where the auxiliary picture layer ID of the target layer j is more than 0, and the output_layer_flag of the target layer j is 1, the decoding layer ID list deriving means performs Steps SD04 and SD05.

(SD04) In a case where the target layer j is a primary picture layer or an auxiliary picture layer which is an output layer, the decoding layer ID list deriving means derives the target layer j as an element of the target decoding layer ID list TargetDecLayerIdList[ ]. Specifically, the decoding layer ID list deriving means adds the j-th element of the layer set LayerSetldx[TargetOLSIdx] associated with the target output layer set TargetOptLayerSet, to the i-th element of the target decoding layer ID list TargetDecLayerIdList[ ].

In the process, a layer of which an output_layer_flag is 0, and an auxiliary picture layer ID is more than 0 (which is an auxiliary picture layer) is excluded. That is, the decoding layer ID list deriving means includes all layers (primary picture layer or auxiliary picture layer which is an output layer) in the target decoding layer ID list, excluding an auxiliary picture layer which is not an output layer, in the output layer set TargetOptLayerSet.

(SD05) “1” is added to the variable

(SD06) SD06 is a loop termination of Step SD01.

The deriving procedure of the target decoding layer ID list is not limited to the above steps, and may be changed in a range allowed to be performed.

The output control unit 16c having the above configuration derives the target decoding layer ID list TargetDecLayerIdList[ ] for layers set as a decoding target, in accordance with whether each layer in a layer set associated with the target output layer set TargetOptLayerSet is a primary picture layer (not an auxiliary picture layer), or an auxiliary picture which is an output layer. That is, the output control unit 16c does not include an auxiliary picture layer (AuxId[ ]>0) which is not required for decoding a primary picture layer of the target output layer set, and of which the output layer flag is 0, in the target decoding layer ID list TargetDecLayerIdList[ ]. Thus, the target set picture decoding unit 10 may omit decoding of an auxiliary picture layer of which the output_layer_flag is 0. Similarly, the output control unit 16c having the above configuration does not include a NAL unit which is not required for decoding a primary picture layer of the target output layer set, and has a layer identifier of an auxiliary picture layer of which the output_layer_flag is 0, in the target decoding layer ID list TargetDecLayerIdList. Thus, the bitstream extraction unit 17 discards a NAL unit which has a layer identifier of the auxiliary picture layer which is not an output layer.

In a case where the designated output layer set OLS#(TargetOLSIdx) does not have an output layer, the output control unit 16 (including those in the modification examples) preferably designates at least one layer or more which are included in the output layer set, as an output layer. For example, the output control unit 16 may designate all layers included in an output layer set, or a primary picture layer having a highest-ordered layer identifier, as an output layer.

(Modification Example 4 of Deriving of Target Decoding Layer ID List TargetDecLayerIdList)

The output control unit 16 may be an output control unit 16d which changes an operation in accordance with whether or not decoding for a conformance test is performed. Determination of whether or not decoding for the conformance test is performed is given from the outside of the hierarchy video decoding device. Decoding for the conformance test is decoding for a test of whether or not an operation is performed on the designated parameter (for example, DPB parameter and the like). In other cases, the decoding for the conformance test is normally decoding which is used for actually watching a video. The output control unit 16d changes an operation in accordance with whether or not the decoding for the conformance test is performed.

In a case where the decoding for the conformance test is performed, the decoding layer ID list deriving means in the output control unit 16d derives a target decoding layer ID list by using the following pseudo code, for example.

```
    for(i=0,j=0; j<
NumLayersInIdList[LayerSetIdx[TargetOLSIdx]]; j++){
  iNuhLId =
layer_id_in_nuh[LayerIdList[LayerSetIdx[TargetOLSIdx]][j]];
  TargetDecLayerId[i] =
LayerIdList[LayerSetIdx[TargetOLSIdx]][j];
  i++;
}
```

That is, in a case where the decoding for the conformance test is performed, the decoding layer ID list deriving means adds layer IDs of all layers included in a layer set (layer set indicated by LayerSetIdx[TargetOLSIdx]) which corresponds to an output layer set indicated by TargetOLSIdx, to the target decoding layer ID list TargetDecLayerIdList.

In a case where the decoding for the conformance test is not performed, the output control unit 16d derives the target decoding layer ID list TargetDecLayerIdList by any of the output control unit 16, the output control unit 16b, and the output control unit 16c which are described already. That is, the output control unit 16d derives the target decoding layer ID list TargetDecLayerIdList, by any of the methods: a non-output and non-reference layer which does not relate to an output layer is not added (output control unit 16); an auxiliary picture layer is not added (output control unit 16b); and a non-output auxiliary picture layer is not added (output control unit 16c).

In the above configuration, in a case where decoding for the conformance test is performed, all layers included in the output layer set are decoded. In other cases (in a case of general reproduction), only a layer (or layer which is not associated with an auxiliary picture layer) which is associated with an output among layers included in a layer set which corresponds to the output layer set is decoded. The DPB parameter tested in the conformance test is tested by decoding all layers which are included in all output layer sets.

Conversely, the DPB parameter added to the output layer set which is added so as to satisfy the conformance test has a value corresponding to a case where all layers including an auxiliary picture layer are decoded. Thus, there is an advantage in that the hierarchy video decoding device can determine whether or not decoding is performed based on the DPB parameter in a case where a layer including an auxiliary picture layer is decoded, and can prepare a decoding memory in accordance with the DPB parameter which is added to the output layer set. In a case of performing an operation other than decoding for the conformance test (in a case of general reproduction), as described above, there is an advantage in that decoding of a layer which does not relates to an output or decoding of an auxiliary layer is omitted, and thus processing is simplified.

(Picture Decoding Unit 14)

The picture decoding unit 14 generates and outputs a decoding picture based on an input VCL NAL unit and an active parameter set.

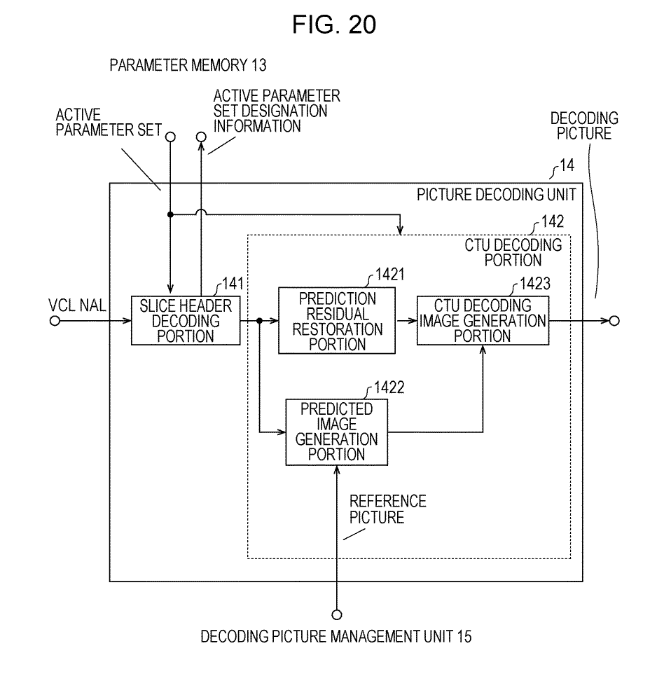

A schematic configuration of the picture decoding unit 14 will be described with reference to FIG. 20. FIG. 20 is a functional block diagram illustrating a schematic configuration of the picture decoding unit 14.

The picture decoding unit 14 includes a slice header decoding portion 141 and a CTU decoding portion 142. The CTU decoding portion 142 includes a prediction residual restoration portion 1421, a predicted image generation portion 1422, and a CTU decoding image generation portion 1423.

(Slice Header Decoding Portion 141)

The slice header decoding portion 141 decodes a slice header based on the input VCL NAL unit and an active parameter set. The decoded slice header is output to the CTU decoding portion 142, in combination with the input VCL NAL unit.

(CTU Decoding Portion 142)

The CTU decoding portion 142 decodes a decoding image of an area corresponding to each CTU which is included in a slice constituting a picture, based on a slice segment (slice header and slice data) which is included in the input VCL NAL unit, and an active parameter set. Thus, the CTU decoding portion 142 generates a decoding image of the slice. The decoding image of the CTU is generated by the prediction residual restoration portion 1421, the predicted image generation portion 1422, and the CTU decoding image generation portion 1423 in the CTU decoding portion 142.

The prediction residual restoration portion 1421 decodes prediction residual information (TT information) included in the input slice data, and generates and outputs a prediction residual of the target CTU.

The predicted image generation portion 1422 generates and outputs a predicted image based on a prediction method and a prediction parameter which are indicated by prediction information (PT information) included in the input slice data. At this time, if necessary, a decoding image or a coding parameter of the reference picture is used. For example, in a case where inter-prediction or inter-layer image prediction is used, the decoding picture management unit 15 reads the corresponding reference picture.

The CTU decoding image generation portion 1423 adds the input predicted image and the input prediction residual to each other, so as to generate and output a decoding image of the target CTU.

<Decoding Process of Picture Decoding Unit 14>

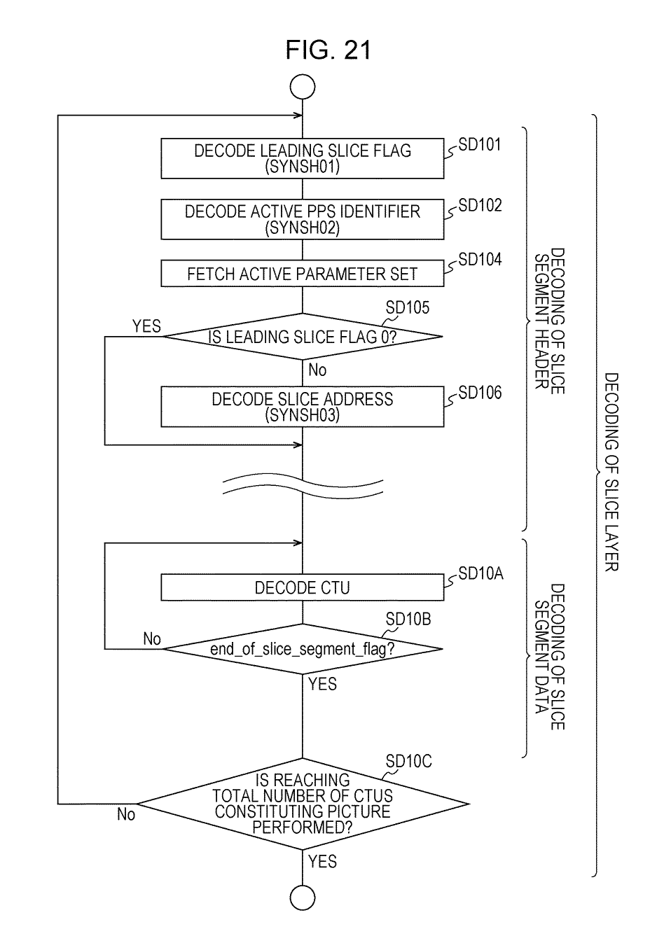

A schematic operation of decoding a picture of a target layer i in the picture decoding unit 14 will be described below with reference to FIG. 21. FIG. 21 is a flowchart illustrating the decoding process in a unit of a slice constituting a picture of the target layer i in the picture decoding unit 14.

(SD101) The leading slice flag (first slice segment_pic_flag) (SYNSH01 in FIG. 17(d)) of a decoding target slice is decoded. In a case where the leading slice flag is 1, the decoding target slice is the leading slice in a decoding order (below, processing order) in a picture. A position (below, CTU address) of the leading CTU of the decoding target slice in a picture in a raster scanning order is set to 0. A counter numCtu (below, the number of processed CTUs numCtu) of the number of processed CTUs in a picture is set to 0. In a case where the leading slice flag is 0, the leading CTU address of the decoding target slice is set based on a slice address decoded in SD106 (which will be described later).

(SD102) An active PPS identifier (slice_pic_paramter_set_id) (SYNSH02 in FIG. 17(d)) for designating an active PPS which is referred when the decoding target slice is decoded is decoded.

(SD104) The active parameter set is fetched by the parameter memory 13. That is, a PPS having a PPS identifier (pps_pic_parameter_set_id) which is the same as an active PPS identifier (slice_pic_parameter_set_id) to which the decoding target slice refers is set as an active PPS. The coding parameter of the active PPS is fetched (read) from the parameter memory 13. An SPS having an SPS identifier (sps_seq_parameter_set_id) which is the same as the active SPS identifier (pps_seq_parameter_set_id) in the active PPS is set as an active SPS. The coding parameter of the active SPS is fetched from the parameter memory 13. A VPS having a VPS identifier (vps_video_parameter_set_id) which is the same as the active VPS identifier (sps_video_parameter_set_id) in the active SPS is set as an active VPS, and the coding parameter of the active VPS is fetched from the parameter memory 13.

(SD105) It is determined whether or not the decoding target slice is the leading slice in an processing order for the picture, based on the leading slice flag. In a case where the leading slice flag is 0 (Yes in SD105), the process transitions to Step SD106. In other cases (No in SD105), the process of Step SD106 is skipped. In a case where the leading slice flag is 1, the slice address of the decoding target slice is 0.

(SD106) The slice address (slice_segment_address) (SYNSH03 in FIG. 17(d)) of the decoding target slice is decoded, and the leading CTU address of the decoding target slice is set. For example, leading slice CTU address=slice_segment_address.

(SD10A) The CTU decoding portion 142 generates a CTU decoding image of an area corresponding to each CTU which is included in a slice constituting the picture, based on the input slice header, the active parameter set, and CTU information (SYNSD01 in FIG. 17(e)) in a slice data included in the VCL NAL unit. A slice termination flag (end_of_slice_segment_flag) (SYNSD2 in FIG. 17(e)) is provided after the CTU information. The slice termination flag indicates whether the CTU is a termination of the decoding target slice. After each CTU is decoded, the value of the number of processed CTUs numCtu is added by 1 (numCtu++).

(SD10B) It is determined whether or not the CTU is a termination of the decoding target slice, based on the slice termination flag. In a case where the slice termination flag is 1 (Yes in SD10B), the process transitions to Step SD10C. In other cases (No in SD10B), the process transitions to Step SD10A in order to decode the subsequent CTU information.

(SD10C) It is determined whether the number of processed CTUs numCtu reaches the total number of CTUs (PicSizeInCtbsY) constituting the picture. That is, it is determined whether numCtu==PicSizeInCtbsY is satisfied. In a case where numCtu is equal to PicSizeInCtbsY (Yes in SD10C), the decoding process in a unit of a slice constituting the decoding target picture is ended. In other cases ((numCtu<PicSizeInCtbsY) (No in SD10C), the process transitions to Step SD101 in order to continue the decoding process in a unit of a slice constituting the decoding target picture.

Hitherto, the operation of the picture decoding unit 14 according to Example 1 is described. However, it is not limited to the above steps, and the steps may be changes in a range allowed to be performed.

(Bitstream Extraction Unit 17)

The bitstream extraction unit 17 performs bitstream extraction processing based on output control information (target decoding layer ID list TargetDecLayerIdList indicating a configuration of layers set as decoding targets in the output layer set, and target highest-ordered temporal identifier TargetHighestTid) which is supplied by the output control unit 16. The bitstream extraction unit 17 removes (discards) a NAL unit which is not included in a set (referred to as a target set TargetSet) determined by the target highest-ordered temporal identifier TargetHighestTid and the target decoding layer ID list TargetDecLayerIdList, from the input hierarchy coding data DATA. The bitstream extraction unit 17 extracts target layer set coding data DATA#T (BitstreamToDecode) configured from NAL units which are included in the target set TargetSet, and outputs the extracted target layer set coding data DATA#T.

More specifically, the bitstream extraction unit 17 includes NAL unit decoding means (not illustrated) that decodes a NAL unit header.

(Bitstream Extraction Processing 1)

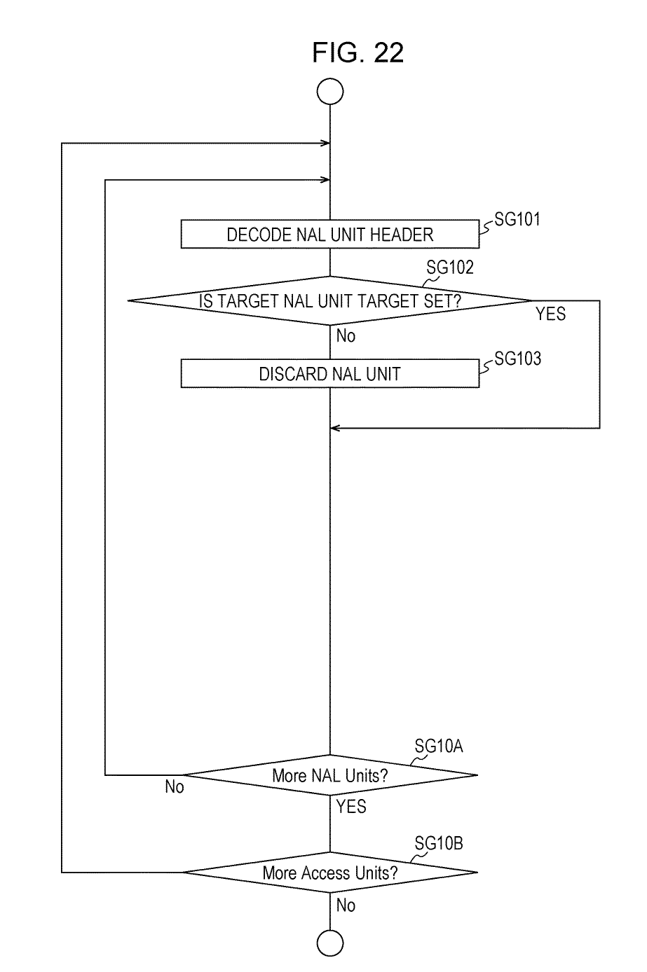

A schematic operation of the bitstream extraction unit 17 will be described below with reference to FIG. 22. FIG. 22 is a flowchart illustrating the bitstream extraction processing in a unit of an access unit in the bitstream extraction unit 17.

(SG101) The bitstream extraction unit 17 decodes a NAL unit header of the supplied target NAL unit in accordance with the syntax table illustrated in FIG. 5(b). That is, the bitstream extraction unit 17 decodes a NAL unit type (nal_unit_type), a layer identifier (nuh_layer_id), and a temporal identifier (nuh_temporal_id_plus1). The layer identifier nuhLayerId of a target NAL unit is set to be “nuh_layer_id”. The temporal identifier temporalId of the target NAL unit is set to be “nuh_temporal_id_plus1−1”.

(SG102) The bitstream extraction unit 17 determines whether or not the layer identifier and the temporal identifier of the target NAL unit are included in the target set TargetSet. The determination is performed based on the target decoding layer ID list TargetDecLayerIdList and the target highest-ordered temporal identifier. More specifically, in a case where at least one of the following conditions of (C1) and (C2) is determined to be false (No in SG102), the process transitions to Step SG103. In other cases ((C1) and (C2) are determined so as to be true) (Yes in SG102), Step SG103 is omitted.

(C1) “In a case where a value which is the same as the layer identifier of the target NAL unit is in the target decoding layer ID list TargetDecLayerIdList”, it is determined to be true. In other cases (where a value which is the same as the layer identifier of the target NAL unit is not in the target decoding layer ID list TargetDecLayerIdList), it is determined to be false.

(C2) “In a case where the temporal identifier of the target NAL unit is equal to or less than the target highest-ordered temporal identifier TargetHighestTid”, it is determined to be true. In other cases (where the temporal identifier of the target NAL unit is more than the target highest-ordered temporal identifier TargetHighestTid), it is determined to be false.

(SG103) The bitstream extraction unit 17 discards the target NAL unit. That is, since the target NAL unit is not included in the target set TargetSet, the bitstream extraction unit 17 removes the target NAL unit from the input hierarchy coding data DATA.

(SG10A) The bitstream extraction unit 17 determines whether a NAL unit which has not been processed is in the same access unit. In a case where there is a NAL unit which has not been processed (No in SG10A), the process transitions to Step SG101 in order to continue bitstream extraction in a unit of a NAL unit constituting a target access unit. In other cases (Yes in SG10A), the process transitions to Step SG10B.

(SG10B) The bitstream extraction unit 17 determines whether the next access unit of the target access unit is in the input hierarchy coding data DATA. In a case where there is the next access unit (Yes in SG10B), the process transitions to Step SG101 in order to continue processing for the next access unit. In a case where there is no next access unit (No in SG10B), the bitstream extraction processing is ended.

Hitherto, the operation of the bitstream extraction unit 17 according to Example 1 is described. However, it is not limited to the above steps, and the steps may be changes in a range allowed to be performed.

According to the above-described bitstream extraction unit 17, the bitstream extraction processing can be performed based on the layer ID list LayerIdListTarget of layers constituting the target layer set LayerSetTarget which is supplied from the outside, and the target highest-ordered temporal identifier HighestTidTarget. A NAL unit which is not included in the target set TargetSet determined by the target highest-ordered temporal identifier HighestTidTarget and the layer ID list LayerIdListTarget of the target layer set LayerSetTarget can be removed (discarded) from the input hierarchy coding data DATA. Coding data BitstreamToDecode configured from NAL units included in the target set TargetSet can be extracted and generated.

(Advantages of Video Decoding Device 1)

The above-described hierarchy video decoding device (hierarchy image decoding device) 1 according to the embodiment includes the output control unit 16 (or output control unit 16a). The output control unit 16 (or output control unit 16a) derives a target output layer ID list indicating a layer configuration of output layers in the target output layer set TargetOptLayerSet, based on the output layer set identifier TargetOLSIdx supplied from the outside, the layer set information of the active VPS held in the parameter memory 13, and the output layer set information. The output control unit 16 (or output control unit 16a) derives the target decoding layer ID list TargetDecLayerIdList indicating a configuration of layers required for decoding the target output layer set TargetOptLayerSet, based on the output layer set identifier TargetOLSIdx, the layer set information of the active VPS held in the parameter memory 13, and the output layer set information, the dependency flag derived by the inter-layer dependency information, and the derived target output layer ID list TargetOptLayerIdList.

Particularly, the output control unit 16 (and output control unit 16a) removes a non-output layer and non-dependency layer which is not necessary for decoding an output layer, from the target decoding layer ID list. That is, the output control unit 16 can instruct the hierarchy video decoding device 1 to omit decoding of a non-output and non-reference layer which is not necessary for decoding an output layer in the target output layer set. Thus, the hierarchy video decoding device 1 which decodes layers included in the target decoding layer ID list TargetDecLayerIdList can decode an output layer necessary for decoding, and coding data of a dependency layer of the output layer in the target output layer set TargetOptLayerSet, and can omit decoding processing of a non-output layer and non-dependency layer.

The output control unit 16 can instruct the bitstream extraction unit 17 to discard a NAL unit which has a layer identifier of the non-output and non-reference layer which is not necessary for decoding an output layer in the target output layer set. That is, the bitstream extraction unit 17 in the hierarchy video decoding device 1 can remove (discard) a NAL unit which is not included in the target set TargetSet determined by the target decoding layer ID list TargetDecLayerIdList which is supplied by the output control unit 16, and the target highest-ordered temporal identifier TargetHighestTid. The target highest-ordered temporal identifier TargetHighestTid is for designating a highest-ordered sublayer which appends to a layer set as a decoding target which is supplied from the outside. The bitstream extraction unit 17 can extract target set coding data DATA#T (BitstreamToDecode) configured from NAL units which are included in the target set TargetSet.

The above-described hierarchy video decoding device (hierarchy image decoding device) 1 according to the embodiment may include an output control unit 16b to an output control unit 16c, instead of the output control unit 16 (or output control unit 16a).

The output control unit 16b excludes an auxiliary picture layer which is not necessary for decoding a primary picture layer in the target output layer set, from the target decoding layer ID list. That is, the output control unit 16b constructs a target decoding layer ID list which does not include an auxiliary picture layer. Thus, the output control unit 16b can instruct the hierarchy video decoding device 1 to omit decoding of the auxiliary picture layer which is not necessary for decoding a primary picture layer in the target output layer set. Accordingly, the hierarchy video decoding device 1 which decodes a layer included in the target decoding layer ID list TargetDecLayerIdList can decode coding data of the primary picture layer in the target output layer set TargetOptLayerSet and can omit the decoding processing of the auxiliary picture layer.

The output control unit 16b can instruct the bitstream extraction unit 17 to discard a NAL unit which has a layer identifier of an auxiliary picture layer which is not necessary for decoding a primary picture layer in the target output layer set. That is, the bitstream extraction unit 17 in the hierarchy video decoding device 1 can remove (discard) a NAL unit which is not included in the target set TargetSet determined by the target decoding layer ID list TargetDecLayerIdList which is supplied by the output control unit 16b, and the target highest-ordered temporal identifier TargetHighestTid. The target highest-ordered temporal identifier TargetHighestTid is for designating a highest-ordered sublayer which appends to a layer set as a decoding target which is supplied from the outside. The bitstream extraction unit 17 can extract target set coding data DATA#T (BitstreamToDecode) configured from NAL units which are included in the target set TargetSet.

The output control unit 16c excludes an auxiliary picture layer which is not an output layer in the target output layer set, from the target decoding layer ID list. That is, the output control unit 16c constructs a target decoding layer ID list which does not include an auxiliary picture layer which is a non-output layer. Thus, the output control unit 16c can instruct the hierarchy video decoding device 1 to omit decoding of the auxiliary picture layer in which the output_layer_flag of the target output layer set is 0. Accordingly, the hierarchy video decoding device 1 which decodes a layer included in the target decoding layer ID list TargetDecLayerIdList can decode coding data of the primary picture layer and coding data of the auxiliary picture layer which is the output layer, in the target output layer set TargetOptLayerSet, and can omit the decoding processing of the auxiliary picture layer which is not the output layer.

The output control unit 16c can instruct the bitstream extraction unit 17 to discard a NAL unit having a layer identifier of the auxiliary picture layer which is not an output layer. That is, the bitstream extraction unit 17 in the hierarchy video decoding device 1 can remove (discard) a NAL unit which is not included in the target set TargetSet determined by the target decoding layer ID list TargetDecLayerIdList which is supplied by the output control unit 16c, and the target highest-ordered temporal identifier TargetHighestTid for designating a highest-ordered sublayer which appends to a layer as a decoding target which is supplied from the outside. The bitstream extraction unit 17 can extract target set coding data DATA#T (BitstreamToDecode) configured from NAL units which are included in the target set TargetSet.

(Modification Example 1 of Hierarchy Video Decoding Device 1: Hierarchy Video Decoding Device 1A)

A hierarchy video decoding device 1A decodes hierarchy coding data DATA which is supplied from the hierarchy video coding device 2, and generates a decoding picture of each layer included in the target set TargetSet which is determined by the output designation information supplied from the outside. The hierarchy video decoding device 1A outputs the decoding picture of the output layer as an output picture POUT#T.

That is, the hierarchy video decoding device 1A decodes coding data of a picture of a layer i in an order of elements TargetDecLayerIdList [0] . . . TargetDecLayerIdList [N−1](N is the number of layers included in the target set) of the target decoding layer ID list TargetDecLayerIdList. The target decoding layer ID list TargetDecLayerIdList indicates a configuration of layers required for decoding the target output layer set TargetOptLayerSet which is indicated by the output designation information. The hierarchy video decoding device 1A generates a decoding picture thereof. In a case where the output layer information OutputLayerFlag[i] of the layer i indicates an “output layer”, the hierarchy video decoding device 1A outputs the decoding picture of the layer i at a predetermined timing.

The hierarchy video decoding device 1A includes a NAL demultiplexing unit 11 and a target set picture decoding unit 10. The target set picture decoding unit 10 includes a non-VCL DECODING UNIT 12, a parameter memory 13, a picture decoding unit 14, a decoding picture management unit 15, and an output control unit 16A. The NAL demultiplexing unit 11 includes a bitstream extraction unit 17A. The same elements as those of the hierarchy video decoding device 1 are denoted by the same reference signs and descriptions thereof will be omitted.

(Output Control Unit 16A)

The output control unit 16A basically has the same functions as those of the output control unit 16. That is, the output control unit 16A selects an output layer set OLS#TargetOLSIdx designated by the output layer set identifier TargetOLSIdx which is included in output designation information, as a processing target. The output control unit 16A derives an output layer ID list TargetOptLayerIdList by processing which is the same as deriving of the output layer ID list in the output control unit 16.

In the following descriptions, only the deriving processing of the decoding layer ID list TargetDecLayerIdList in target decoding layer ID list deriving means (not illustrated) which is included in the output control unit 16A having a different function will be described.

The decoding layer ID list deriving means (not illustrated) in the output control unit 16A derives a target decoding layer ID list TargetDecLayerIdList indicating a configuration of layers required for decoding the target output layer set, based on the output layer set identifier TargetOLSIdx included in the output designation information, the layer set information of the active VPS held in the parameter memory 13, and the output layer set information. The decoding layer ID list deriving means supplies the derived target decoding layer ID list TargetDecLayerIdList to the bitstream extraction unit 17A and the target set picture unit 10, as a portion of the output control information. For example, the target decoding layer ID list is derived by the following pseudo code. That is, the decoding layer ID list deriving means sets a layer ID list LayerIdList[LayerSetldx[TargetOLSIdx]] of a layer set associated with the target output layer set TargetOptLayerSet, as the target decoding layer ID list TargetDecLayerIdList.

(Pseudo Code 4 Indicating Deriving of TargetDecLayerIdList)

for(j=0; j< NumLayersInIdList[LayerSetIdx[TargetOLSIdx]];
j++){ //SC01
TargetDecLayerId[i] =
LayerIdList[LayerSetIdx[TargetOLSIdx]][j]; //SC02
} //SC03

The deriving procedure is not limited to the above steps, and may be changed in a range allowed to be performed.

(Bitstream Extraction Unit 17A)

The bitstream extraction processing is performed based on the target decoding layer ID list TargetDecLayerIdList indicating a configuration of layers set as decoding targets, and the target highest-ordered temporal identifier TargetHighestTid, in the output control information (output layer set) supplied by the bitstream extraction unit 17A and the output control unit 16A. Then, a NAL unit which is not included in a set (referred to as the target set TargetSet) determined by the target highest-ordered temporal identifier TargetHighestTid and the target decoding layer ID list TargetDecLayerIdList is removed (discarded) from the input hierarchy coding data DATA.

The bitstream extraction unit 17A removes (discards) a NAL unit of a non-output layer and non-dependency layer in the target output layer set, based on the target decoding layer ID list TargetDecLayerIdList indicating a configuration of layers set as decoding targets, the target output layer ID list TargetOptLayerIdList[ ], the layer set LayerIdList[ ][ ] of the active VPS held in the parameter memory 13, and the dependency flag recursiveRefLayerFlag[ ][ ] derived by the inter-layer dependency information. The bitstream extraction unit 17A removes (discards) a NAL unit which is not included in the target set TargetSet, from the input hierarchy coding data DATA by the bitstream extraction processing. The bitstream extraction unit 17A extracts target set coding data DATA#T (BitstreamToDecode) configured from NAL units which are included in the target set TargetSet, and outputs the extracted target set coding data DATA#T (BitstreamToDecode).

(Bitstream Extraction Processing 2)

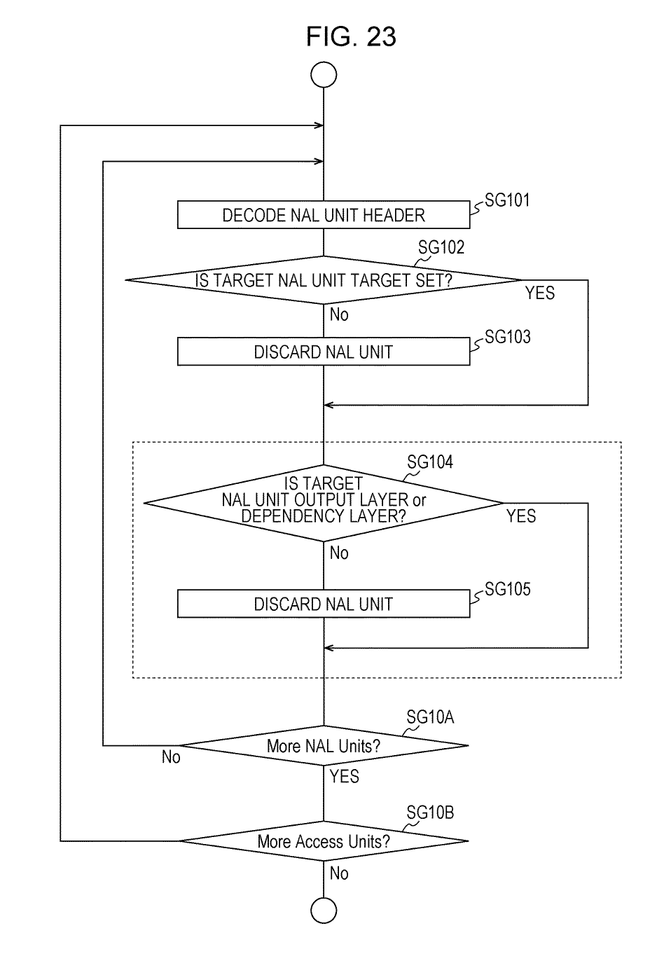

In the following descriptions, an operation of the bitstream extraction unit 17A according to the example will be described with reference to FIG. 23. The common operations with those in the bitstream extraction unit 17 are SG101 to SG103 and SG10A to SG10B, are denoted by the same step numbers, and descriptions thereof will be omitted. In the following descriptions, only Steps SG104 and SG105 which are added so as to be subsequent to SG101 to SG103 will be described.

(SG104) It is determined whether a layer having a layer identifier of the target NAL unit is an output layer included in the target output layer ID list TargetOptLayerIdList[ ], or a dependency layer of the output layer.

More specifically, the bitstream extraction unit 17A determines the following conditions of (C3) and (C4). That is, in a case where all of the conditions of (C3) and (C4) are false (No in SG104), the process transitions to Step SG105. In other cases (any of (C3) and (C4) is true) (Yes in SG104), the process transitions to Step SG10A.

(C3) In a case where “the same value as the layer identifier of the target NAL unit is in the target output layer ID list TargetOptLayerIdList[ ]” (in a case where the layer identifier of the target NAL unit is equal to the layer identifier of the output layer), (C3) is determined to be true. In other cases (the same value as the layer identifier of the target NAL unit is not in the target output layer ID list TargetOptLayerIdList), (C3) is determined to be false.

(C4) In a case where “a layer having the layer identifier of the target NAL unit is a dependency layer of any output layer included in the target output layer ID list TargetOptLayerIdList[ ]”, (C4) is determined to be true. In other cases (layer having the layer identifier of the target NAL unit is a non-dependency layer of the output layer), (C4) is determined to be false.

(SG105) The target NAL unit is discarded. That is, since the target NAL unit is a NAL unit of a non-output layer and non-dependency layer, the bitstream extraction unit 17A removes the target NAL unit from the hierarchy coding data DATA. Only a VCL NAL unit of the non-output layer and non-dependency layer may be discarded.

Hitherto, an operation of the bitstream extraction unit 17A will be described. However, it is not limited to the above steps, and may be changed in a range allowed to be performed.

Here, the condition (C4) in Step SG104 may be used, for example, for determining whether the flag refLayerFlag derived by the following pseudo code is true or false.

(Pseudo Code)

```
iNuhLId = nuh_layer_id; //SC01
for(refLayerFlag=0, k=0; k< NumOptLayersInOLS[TargetOLSIdx];
k++){ //SC02
  iOptLayerId = layer_id_in_nuh[(TargetOptLayerIdList[k])];
//SC03
  refLayerFlag =
(refLayerFlag |
recursiveRefLayerFlag[iOptLayerId][iNuhLId]); //SC04
} //SC05
```

The pseudo code is expressed in a form of a step, as follows.

(SC01) The layer identifier nuh_layer_id of the target NAL unit is set in the variable iNuhLId.

(SC02) SC02 is a start point of a loop relating to deriving of the flag refLayerFlag. The flag refLayerFlag indicates whether a layer of the layer identifier nuh_layer_id is a dependency layer (direct reference layer or indirect reference layer) of an output layer TargetOptLayerIdList[k]. Before the loop is started, the variable k and the flag refLayerFlag are initialized so as to be 0. Processing indicated by SC03 . . . SC04 is performed on the variable k of 0 to (NumOptLayerslnOLS[TargetOLSIdx]−1).

(SC03) The layer identifier of the output layer TargetOptLayerIdList[k] is set in the variable iOptLayerId.

(SC04) A value of the AND operation of the flag refLayerFlag and the dependency flag recursiveRefLayerFlag of a layer having a layer identifier iNuhLId for the output layer TargetOptLayerIdList[k] having a layer identifier iOptLayerId is set in the flag refLayerFlag.

(SC05) SC05 is a loop termination of Step SC01.

Hitherto, deriving processing of the flag refLayerFlag indicating whether a target NAL unit corresponds to a dependency layer of the output layer, in the bitstream extraction unit 17A is described. However, it is not limited to the above steps, and may be changed in a range allowed to be performed.

The bitstream extraction unit 17A having the above configuration discards a NAL unit having a layer identifier of a non-output and non-reference layer, from NAL units included in the target set TargetSet. That is, the bitstream extraction unit 17A has an advantage of generating target set coding data BitstreamToDecode which does not include a NAL unit of a layer which is not necessary for decoding an output layer in the target output layer set. Thus, the target set picture decoding unit 10 which decodes target set coding data BitstreamToDecode supplied from the bitstream extraction unit 17A can omit decoding of a non-output and non-reference layer.

(Modification Example 1 Of Step SG102 Of Bitstream Extraction Unit 17A)

The following condition (D1) may be added, in addition to condition determination (C3) and (C4) of SGB104 of the bitstream extraction unit 17A.

(D1) In a case where “the layer identifier of the target NAL unit is equal to the layer identifier of the base layer” (nuh_layer_id==0), (D1) is determined to be true. In other cases (nuh_layer_id>0), (D1) is determined to be false.

A modification example of the bitstream extraction unit 17A having the above configuration includes a base layer into the target set TargetSet. Thus, when coding data including a layer set B which is generated from coding data including a certain layer set A by the bitstream extraction processing and is a subset of the layer set A is decoded, in a case where the parameter set (VPS/SPS/PPS) having a layer identifier for the base layer is referred to as an active parameter set in a certain layer C (layer identifier >0) in the layer set B, it is possible to prevent a case in that the base layer is not included in the coding data including the layer set B, and decoding of the certain layer C is not possible.

(Modification Example 1 of Bitstream Extraction Unit 17A: Bitstream Extraction Unit 17A1)

In the above-described bitstream extraction 17A, a non-output layer and non-dependency layer which is not necessary for decoding an output layer is excluded from the target set, and it is not limited thereto. For example, a bitstream extraction unit 17A1 may be provided. The bitstream extraction unit 17A1 excludes the auxiliary picture layer which is not necessary for decoding the primary picture layer, from the target set, and discards a NAL unit having a layer identifier of the auxiliary picture layer, in a case where the output layer set is configured from one or more primary picture layers and one or more auxiliary picture layers.

In the following descriptions, the bitstream extraction unit 17A1 will be specifically described. The bitstream extraction unit 17A1 removes (discards) a NAL unit having a layer identifier of an auxiliary picture layer in the target output layer set, and a NAL unit which is not included in the target set TargetSet, based on the target decoding layer ID list TargetDecLayerIdList indicating a configuration of layers set as decoding targets, the target output layer ID list TargetOptLayerIdList[ ], the layer set LayerIdList[ ][ ] of the active VPS held in the parameter memory 13, and the auxiliary picture layer ID derived by the scalable identifier. The bitstream extraction unit 17A1 extracts target set coding data DATA#T (BitstreamToDecode) configured from NAL units which are included in the target set TargetSet, and outputs the extracted target set coding data DATA#T.

(Bitstream Extraction Processing 3)

In the following descriptions, an operation of the bitstream extraction unit 17A1 according to the example will be described. The common operations with those in the bitstream extraction unit 17 are SG101 to SG103 and SG10A and SG10B, are denoted by the same step numbers, and descriptions thereof will be omitted. In the following descriptions, only Steps SG104A to SG105A which are added so as to be subsequent to SG101 to SG103 will be described.

(SG104A) It is determined whether a layer having a layer identifier of the target NAL unit is a primary picture layer.

More specifically, the bitstream extraction unit 17A1 determines the following condition of (C5). That is, in a case where the condition of (C5) is false (No in SG104A), the process transitions to Step SG105A. In other cases ((C5) is true) (Yes in SG104A), the process transitions to Step SG10A.

(C5) In a case where “the value of the auxiliary picture layer ID relating to a layer which has a layer identifier of the target NAL unit is 0” (in a case where a layer having a layer identifier of the target NAL unit is a primary picture layer), (C5) is determined to be true. In other cases (the value of the auxiliary picture layer ID relating to a layer which has a layer identifier of the target NAL unit is more than 0 (a layer having a layer identifier of the target NAL unit is an auxiliary picture layer)), (C5) is determined to be false.

Hitherto, an operation of the bitstream extraction unit 17A1 will be described. However, it is not limited to the above steps, and may be changed in a range allowed to be performed.

The bitstream extraction unit 17A1 having the above configuration discards a NAL unit having a layer identifier of an auxiliary picture layer, from NAL units included in the target set TargetSet. That is, the bitstream extraction unit 17A1 has an advantage of generating target set coding data BitstreamToDecode which does not include a NAL unit of an auxiliary picture layer which is not necessary for decoding a primary picture layer in the target output layer set. Thus, the target set picture decoding unit 10 which decodes target set coding data BitstreamToDecode supplied from the bitstream extraction unit 17A1 can omit decoding of an auxiliary picture layer.

(Modification Example 2 of Bitstream Extraction Unit 17A: Bitstream Extraction Unit 17A2)

The bitstream extraction 17A may be a bitstream extraction unit 17A2 which discards a NAL unit having a layer identifier of an auxiliary picture layer which is a non-output layer, in an output layer set.

In the following descriptions, the bitstream extraction unit 17A2 will be specifically described. The bitstream extraction unit 17A2 removes (discards) a NAL unit having a layer identifier of an auxiliary picture layer which is a non-output layer in the target output layer set, and a NAL unit which is not included in the target set TargetSet, based on the target decoding layer ID list TargetDecLayerIdList indicating a configuration of layers set as decoding targets, the layer set LayerIdList[ ][ ] of the active VPS held in the parameter memory 13, the output layer flag OutputLayerFlag[ ][ ], and the auxiliary picture layer ID derived by the scalable identifier. The bitstream extraction unit 17A2 extracts target set coding data DATA#T (BitstreamToDecode) configured from NAL units which are included in the target set TargetSet, and outputs the extracted target set coding data DATA#T.

(Bitstream Extraction Processing 4)

In the following descriptions, an operation of the bitstream extraction unit 17A2 according to the example will be described. The common operations with those in the bitstream extraction unit 17 are SG101 to SG103 and SG10A to SG10B, are denoted by the same step numbers, and descriptions thereof will be omitted. In the following descriptions, only Steps SG104B and SG105B which are added so as to be subsequent to SG101 to SG103 will be described.

(SG104B) It is determined whether a layer having a layer identifier of the target NAL unit is a primary picture layer, or an auxiliary picture layer which is an output layer.

More specifically, the bitstream extraction unit 17A2 determines the following conditions of (C5) and (C6). That is, in a case where all of the conditions of (C5) and (C6) are false (No in SG104B), the process transitions to Step SG105B. In other cases (any of (C5) and (C6) is true) (Yes in SG104B), the process transitions to Step SG10A. Because the condition (C5) is the same as the condition (C5) in the Bitstream extraction processing 3, descriptions thereof will be omitted.

(C6) In a case where “a value of an auxiliary picture layer ID relating to a layer which has a layer identifier of the target NAL unit is more than 0, and an output_layer_flag is 1” (a layer having a layer identifier of the target NAL unit is an output layer and an auxiliary picture layer), (C6) is determined to be true. In other cases, (C6) is determined to be false.

Hitherto, an operation of the bitstream extraction unit 17A2 will be described. However, it is not limited to the above steps, and may be changed in a range allowed to be performed.

The bitstream extraction unit 17A2 having the above configuration discards a NAL unit having a layer identifier of an auxiliary picture layer which is a non-output layer, from NAL units included in the target set TargetSet. That is, the bitstream extraction unit 17A2 has an advantage of generating target set coding data BitstreamToDecode which does not include a NAL unit of an auxiliary picture layer which is a non-output layer in the target output layer set. Thus, the target set picture decoding unit 10 which decodes target set coding data BitstreamToDecode supplied from the bitstream extraction unit 17A2 can omit decoding of an auxiliary picture layer.

(Advantages of Hierarchy Video Decoding Device 1A)

The bitstream extraction unit 17A in the above-described hierarchy video decoding device (hierarchy image decoding device) 1A according to the embodiment generates target set coding data BitstreamToDecode configured from NAL units which are included in the target set, from coding data input from the outside by the bitstream extraction processing. The generation is performed based on the output layer ID list TargetOptLayerIdList supplied from the output control unit 16A, the target decoding layer ID list TargetDecLayerIdList, the target highest-ordered temporal identifier TargetHighestTId, and the dependency flag recursiveRefLayerFlag[ ][ ] derived by the inter-layer dependency information.

Particularly, the bitstream extraction unit 17A excludes a non-output layer and non-dependency layer which is not necessary for decoding an output layer, from the target set. Thus, the hierarchy video decoding device 1A which decodes the target set coding data BitstreamToDecode which has been generated by the bitstream extraction unit 17A has an advantage in that decoding a non-output layer and non-reference layer which is not necessary for decoding an output layer in the target output layer set can be omitted.

The bitstream extraction unit 17A1 excludes an auxiliary picture layer from the target set. Thus, the hierarchy video decoding device 1A which decodes target set coding data BitstreamToDecode which has been generated by the bitstream extraction unit 17A1 has an advantage in that decoding of an auxiliary picture layer can be omitted.

The bitstream extraction unit 17A1 excludes an auxiliary picture layer which is a non-output layer, from the target set. Thus, the hierarchy video decoding device 1A which decodes target set coding data BitstreamToDecode which has been generated by the bitstream extraction unit 17A2 has an advantage in that decoding of an auxiliary picture layer which is a non-output layer can be omitted.

(Modification Example 2 of Hierarchy Video Decoding Device 1: Hierarchy Video Decoding Device 1B)

The hierarchy video decoding device 1B may cause the bitstream extraction unit 17B to perform coding data extraction processing from hierarchy coding data DATA supplied from the hierarchy video coding device 2. The coding data extraction processing is designated by the output designation information supplied from the outside, and the sub-bitstream characteristic information decoded by the non-VCL decoding unit 12B in the hierarchy video decoding device 1B. The hierarchy video decoding device 1B may generate the target set coding data BitstreamToDecode, and decode the generated target set coding data BitstreamToDecode. The hierarchy video decoding device 1B may generate a decoding picture of each layer included in the target set TargetSet, and output the decoding picture of the output layer as the output picture POUT#T.

That is, the hierarchy video decoding device 1B decodes coding data of a picture of a layer i in an order of elements TargetDecLayerIdList [0] . . . TargetDecLayerIdList [N−1](N is the number of layers included in the target set) of the target decoding layer ID list TargetDecLayerIdList. The target decoding layer ID list TargetDecLayerIdList indicates a configuration of layers required for decoding the target output layer set TargetOptLayerSet which is indicated by the output designation information. The hierarchy video decoding device 1B generates a decoding picture thereof. In a case where the output layer information OutputLayerFlag[i] of the layer i indicates an “output layer”, the hierarchy video decoding device 1A outputs the decoding picture of the layer i at a predetermined timing.

The hierarchy video decoding device 1B includes a NAL demultiplexing unit 11 and a target set picture decoding unit 10. The target set picture decoding unit 10 includes a non-VCL decoding unit 12B, a parameter memory 13, a picture decoding unit 14, a decoding picture management unit 15, and an output control unit 16A. The NAL demultiplexing unit 11 includes a bitstream extraction unit 17B. The same elements as those of the hierarchy video decoding device 1 or the hierarchy video decoding device 1A are denoted by the same reference signs and descriptions thereof will be omitted.

(Non-VCL Decoding Unit 12B)

The non-VCL decoding unit 12B has the same functions as those of the non-VCL decoding unit 12 which is included in the hierarchy video decoding device 1. The non-VCL decoding unit 12B further includes sub-bitstream characteristic information decoding means which decodes sub-bitstream characteristic information. The sub-bitstream characteristic information indicates bitstream extraction processing of the output layer set unit, and characteristics (bitrate information and the like) of a sub-bitstream which is generated by the bitstream extraction processing.

(Sub-Bitstream Characteristic Information)

The sub-bitstream characteristic information schematically provides bitrate information of a sub-bitstream generated by discarding a picture (NAL unit) of a layer which does not have an influence on (is not necessary for) decoding of an output layer in the output layer set which is defined by the active VPS. In a case where the sub-bitstream characteristic information is provided, the sub-bitstream characteristic information is applied for a CVS which is associated with an initial IRAP access unit and is associated with an initial IRAP.

The sub-bitstream characteristic information includes syntax indicated by F1 to F7. The pieces of syntax is decoded from a parameter set or SEI, and output to the bitstream extraction means 17B by the sub-bitstream characteristic information decoding means.

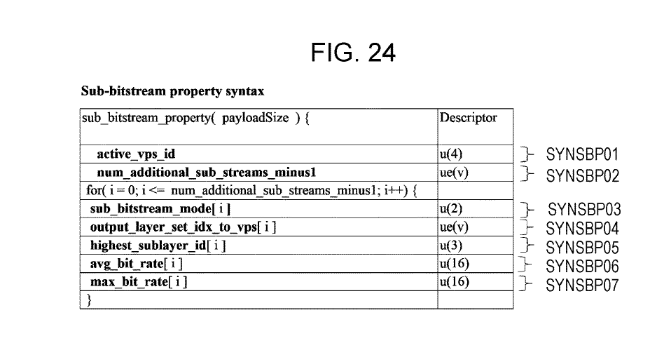

F1: An active VPS identifier active_vps_id (SYNSBP01 in FIG. 24) is an identifier for specifying an active VPS to which the sub-bitstream characteristic information refers.

F2: The number of additional sub-bitstreams num_additional sub stream_minus1 (SYNSBP02 in FIG. 24) is a value of the number of sub-bitstreams −1. The number of sub-bitstreams is designated in the sub-bitstream characteristic information. The number of additional sub-bitstreams NumAddSubStream is num_additional_sbu_stream_minus1+1. The sub-bitstream characteristic information decoding means decodes the syntax of F3 to F7 by the coding data, regarding a sub-bitstream 0 to a sub-bitstream (NumAddSubStream−1).

F3: A bitstream extraction mode sub_bitstream_mode[i] (SYNSBP03 in FIG. 24) is syntax for designating the bitstream extraction processing which is used for generating a sub-bitstream (also referred to as a sub-stream i) having an index i. The bitstream extraction processing corresponding to each bitstream extraction mode will be described in descriptions for the bitstream extraction unit 17B.

F4: The output layer set identifier output_layer_set_idx_to_vps[i] (SYNSBP04 in FIG. 24) is syntax of an output layer set corresponding to a sub-stream i. That is, a sub-stream i corresponds to an output layer set OLS# (output_layer_set_idx_to_vps[i]).

F5: The highest-ordered temporal identifier highest_sublayer id[i] (SYNSBP05 in FIG. 24) is a highest-ordered temporal identifier of an output layer set corresponding to a sub-bitstream

F6: An average bitrate avg_bit_rate[i] (SYNSBP06 in FIG. 24) is an average bitrate (bits/sec) of a sub-bitstream

F7: The maximum bitrate max_bit_rate[i] (SYNSBP07 in FIG. 24) is the maximum bitrate (bits/sec) of a sub-bitstream

(F5: bitstream extraction mode sub_bit_stream_mode[i]) The bitstream extraction processing indicated by the bitstream extraction mode sub_bitstream_mode[i] will be described below.

Case of bitstream extraction mode sub_bitstream_mode[i]=0: A case where the value of the bitstream extraction mode is 0 indicates the followings. The bitstream extraction unit 17B performs the aforementioned Bitstream extraction processing 1 by using the layer ID list LayerIdList[output_layer_set_idx_to_vps[i]] and the highest-ordered temporal identifier highest_sublayer id[i] as an input. The bitstream extraction unit 17B generates a sub-bitstream i corresponding to an output layer set OSL# (output_layer_set_idx_to_vps[i]), from a CVS associated with sub-bitstream characteristic information.

Case of bitstream extraction mode sub_bitstream_mode[i]=1: A case where the value of the bitstream extraction mode is 1 indicates the followings. The bitstream extraction unit 17B performs the aforementioned Bitstream extraction processing 2 by using the layer ID list LayerIdList[LayerSetIdx[output_layer_set_idx_to_vps[i]]], the highest-ordered temporal identifier highest_sublayer_id[i], the output layer ID list TargetOptLayeridList of the output layer set OLS#output_layer_set_idx_to_vps[i], and the dependency flag recursiveRefLayrFlag[ ][ ]. The bitstream extraction unit 17B generates a sub-bitstream i corresponding to the output layer set OSL# (output_layer_set_idx_to_vps[i]), from the CVS associated with the sub-bitstream characteristic information. The output layer ID list TargetOptLayerIdList of the output layer set OLS#ouptut_layer_set_idx_to_vps[i] is derived by the aforementioned pseudo code indicating deriving of the TargetOptLayerIdList, for example.

A case where the value of the bitstream extraction mode sub_bitstream_mode[i] is X (for example, 2) may indicate the followings. The bitstream extraction unit 17B performs the aforementioned Bitstream extraction processing 3 by using the layer ID list LayerIdList[LayerSetIdx[output_layer_set_idx_to_vps[i]]], the highest-ordered temporal identifier highest_sublayer_id[i], and the auxiliary picture layer ID AuxID[ ], as an input. The bitstream extraction unit 17B generates a sub-bitstream i corresponding to the output layer set OSL# (output_layer_set_idx_to_vps[i]), from the CVS associated with the sub-bitstream characteristic information.

A case where the value of the bitstream extraction mode sub_bitstream_mode[i] is Y (for example, 3) may indicate the followings. The bitstream extraction unit 17B performs the aforementioned Bitstream extraction processing 4 by using the layer ID list LayerIdList[LayerSetIdx[output_layer_set_idx_to_vps[i]]], the highest-ordered temporal identifier highest_sublayer_id[i], the auxiliary picture layer ID AuxID[ ], and the output_layer_flag OutputLayerFlag[LayerSetIdx[output_layer_set_idx_to_vps[i]]] [ ], as an input. The bitstream extraction unit 17B generates a sub-bitstream i corresponding to the output layer set OSL# (output_layer_set_idx_to_vps[i]), from the CVS associated with the sub-bitstream characteristic information.

(Bitstream Extraction Unit 17B)

The bitstream extraction unit 17B includes at least Bitstream extraction processing 1 in the bitstream extraction unit 17 and Bitstream extraction processing 2 in the bitstream extraction unit 17A. The bitstream extraction unit 17B may include Bitstream extraction processing 3 in the bitstream extraction unit 17A1, and/or Bitstream extraction processing 4 in the bitstream extraction unit 17A2.

The bitstream extraction processing corresponding to the bitstream extraction mode sub_bitstream_mode[i] which is indicated by the decoded bitstream characteristic information is performed.

In a case where the bitstream extraction mode sub_bitstream_mode[i] is 0, the bitstream extraction unit 17B performs the aforementioned Bitstream extraction processing 2 by using the layer ID list LayerIdList[LayerSetIdx[output_layer_set_idx_to_vps[i]]] and the highest-ordered temporal identifier highest_sublayer_id[i], as an input. The bitstream extraction unit 17B generates a sub-bitstream i corresponding to the output layer set OSL#(output_layer_set_idx_to_vps[i]), from the CVS associated with the sub-bitstream characteristic information.

In a case where the bitstream extraction mode sub_bitstream_mode[i] is 1, the bitstream extraction unit 17B performs the aforementioned Bitstream extraction processing 2 by using the layer ID list LayerIdList[LayerSetIdx[output_layer_set_idx_to_vps[i]]], the highest-ordered temporal identifier highest_sublayer_id[i], the output layer ID list TargetOptLayeridList of the output layer set OLS#output_layer_set_idx_to_vps[i], and the dependency flag recursiveRefLayrFlag[ ][ ], as an input. The bitstream extraction unit 17B generates a sub-bitstream i corresponding to the output layer set OSL#(output_layer_set_idx_to_vps[i]), from the CVS associated with the sub-bitstream characteristic information.

In a case where the value of the bitstream extraction mode sub_bitstream_mode[i] is X (for example, 2), the bitstream extraction unit 17B may perform the aforementioned Bitstream extraction processing 3 by using the layer ID list LayerIdList[LayerSetIdx[output_layer_set_idx_to_vps[i]]], the highest-ordered temporal identifier highest_sublayer_id[i], and the auxiliary picture layer ID AuxID[ ], as an input. The bitstream extraction unit 17B may generate a sub-bitstream i corresponding to the output layer set OSL#(output_layer_set_idx_to_vps[i]), from the CVS associated with the sub-bitstream characteristic information.

In a case where the value of the bitstream extraction mode sub_bitstream_mode[i] is Y (for example, 3), the bitstream extraction unit 17B may perform the aforementioned Bitstream extraction processing 4 by using the layer ID list LayerIdList[LayerSetIdx[output_layer_set_idx_to_vps[i]]], the highest-ordered temporal identifier highest_sublayer_id[i], the auxiliary picture layer ID AuxID[ ], and the output_layer_flag OutputLayerFlag[LayerSetIdx[output_layer_set_idx_to_vps[i]]] [ ], as an input. The bitstream extraction unit 17B may generate a sub-bitstream i corresponding to the output layer set OSL# (output_layer_set_idx_to_vps[i]), from the CVS associated with the sub-bitstream characteristic information.

According to the bitstream extraction unit 17B which has the above configuration, the bitstream extraction unit 17B performs the bitstream extraction processing corresponding to the bitstream extraction mode sub_bitstream_mode[i] of the sub-bitstream characteristic information, and generates a sub-bitstream i. Particularly, in a case of the bitstream extraction mode sub_bitstream_mode[i]=1, the bitstream extraction unit 17B generates a sub-bitstream i in which a NAL unit of a non-output layer and non-reference layer (non-dependency layer) which is not necessary for decoding an output layer of the output layer set OLS#(output_layer_set_to_vps[i]) is discarded, from the CVS (coding data) associated with the sub-bitstream characteristic information. Thus, the image decoding device 1B which decodes a sub-bitstream i has an advantage in that decoding of a non-output layer and non-dependency layer which is not necessary for decoding the output layer set OLS# (output_layer_set_to_vps[i]) can be omitted.

In a case of the bitstream extraction mode sub_bitstream_mode[i]=X (for example, 2), the bitstream extraction unit 17B generates a sub-bitstream i in which a NAL unit of an auxiliary picture layer which is not necessary for decoding a primary picture of the output layer set OLS# (output_layer_set_to_vps[i]), from the CVS (coding data) associated with the sub-bitstream characteristic information. Thus, the image decoding device 1B which decodes a sub-bitstream i has an advantage in that decoding of an auxiliary picture layer of an output layer set OLS# (output_layer_set_to_vps[i]) can be omitted.

In a case of the bitstream extraction mode sub_bitstream_mode[i]=Y (for example, 3), the bitstream extraction unit 17B generates a sub-bitstream i in which a NAL unit of an auxiliary picture layer which is a non-output layer and is not necessary for decoding a primary picture of the output layer set OLS# (output_layer_set_to_vps[i]) is discarded, from the CVS (coding data) associated with the sub-bitstream characteristic information. Thus, the image decoding device 1B which decodes a sub-bitstream i has an advantage in that decoding of an auxiliary picture layer which is a non-output layer of the output layer set OLS# (output_layer_set_to_vps[i]) can be omitted.

(Device 1 that Codes•Decodes Coding Data of Restricted Output Layer Set)

A hierarchy video coding device which codes coding data satisfying a restriction (bitstream conformance) which relates to an output layer set, and a hierarchy video decoding device which decodes the coding data will be described below.

The hierarchy video decoding device 1 (and including the modification example (hierarchy video decoding device 1A and hierarchy video decoding device 1B))/hierarchy video coding device 2 decodes/generates coding data satisfying a conformance condition CC1 which relates to a layer set associated with an output layer set as follows.

Condition CC1: The layer set LS#i (i=0 . . . VpsNumLayerSets−1) includes a base layer.

The condition CC1 may be also referred to as conditions CC2 to CC4.

CC2: The layer set LS#i (i=0 . . . VpsNumLayerSets−1) includes a layer of which the layer identifier is 0.

CC3: The 0-th element LayerIdList[i][0] in the layer ID list LayerIdList[i][ ] of the layer set LS#i (i=0 . . . VpsNumLayerSets−1) is a layer of which the layer identifier is 0.

CC4: The value of the flag layer_id_included_flag[i][0] is 1 (layer_id_included_flag[i][0]=1 for i=0 . . . VpsNumLayerSets−1). The flag layer_id_included_flag[i][0] indicates whether or not the layer 0 is included in the layer set LS#i (i=0 . . . VpsNumLayerSets−1).

In other words, the conditions CC1 to CC4 mean that a base layer (layer of which the layer identifier is 0) is normally included as a layer set as a decoding target, in the output layer set. The hierarchy video decoding device 1 which decodes coding data satisfying the conformance condition CC (CC is any of CC1 to CC4) which relates to layer sets (that is, all layer set) associated with the output layer set are ensured to necessarily decode the base layer. Thus, when coding data including a layer set B which is generated from coding data including a certain layer set A by the bitstream extraction processing and is a subset of the layer set A is decoded, even a decoding device V1 (for example, which performs decoding processing defined by the HEVC Main profile) which only corresponds to decoding of a base layer (layer having a layer identifier of 0) can be operated without a problem. The reason is as follows.
Coding data including the extracted layer set B includes a VCL (slice segment) having a layer identifier of 0 and a nonVCL (parameter set (VPS/SPS/PPS).
The decoding device V1 decodes a slice segment having a layer identifier of 0. In a case where the slice segment having a layer identifier of 0 indicates that the referring profile of the SPS can be decoded, the decoding device V1 can perform decoding. In a case where the slice segment having a layer identifier of 0 does not indicate that PTL information such as the referring profile of the SPS can be decoded, the decoding device V1 can stop decoding of the coding data.

The decoding device V1 can perform decoding or stop decoding. That is, the decoding device V1 can perform decoding (can perform corresponding) without a problem.

Conversely, the layer set decoding device V1 decodes coding data which does not satisfy the conditions CC1 to CC4. That is, in a case where the decoding device V1 decodes a layer set which does not include the base layer, the following problem occurs.
Since a slice segment having a layer identifier of 0 is not in the coding data, the decoding device V1 does not decode the slice segment.
Since slice_pic_parameter_set_id of the slice segment is not decoded, the PPS is not activated (similarly, the SPS and the VPS are also not activated).
Since the decoding device V1 does not decode the activated SPS (and VPS), the decoding device V1 does not decode the PTL information such as the profile, which is included in the SPS (VPS).
If coding data in an internal buffer is exhausted, the decoding device V1 transmits a request of coding data to a coding device (or coding data transmission device, a coding data buffering device). The requested coding data also does not have a target to be decoded, and thus there is a probability of continuing a request and decoding of coding data so as to decode the requested output image (for example, one sheet of a picture).

In a case where the conformance condition CC (CC corresponds to CC1 to CC4) is satisfied, there is an advantage of ensuring that coding data including the layer set A (or the layer set B which is a subset of the layer set A which is generated from coding data including the layer set A by bitstream extraction) can be decoded (correspondence can be performed).

(Device 2 that Codes•Decodes Coding Data Of Restricted Output Layer Set)

A hierarchy video coding device which codes coding data satisfying a restriction (bitstream conformance) which relates to an output layer set, and a hierarchy video decoding device which decodes the coding data will be described below.

The hierarchy video decoding device 1 (and including the modification example (hierarchy video decoding device 1A and hierarchy video decoding device 1B))/hierarchy video coding device 2 decodes/generates coding data satisfying a conformance condition CX1 which relates to a layer set associated with an output layer set as follows.

Condition CX1: The output layer set OLS#i (i=0 . . . NumOuputLayerSets−1) includes one or more primary picture layers.

The condition CX1 may be also referred to as a condition CX2.

CX2: The output layer set OLS#i (i=0 . . . NumOutputLayerSets−1) includes a layer (AuxID[ ]==0) of which one auxiliary picture layer ID or more are 0.

In other words, the conditions CX1 and CX2 mean that at least one primary picture layer or more are included as a layer as a decoding target, in the output layer set. The hierarchy video decoding device 1 decodes coding data satisfying the conformance condition CX (CX is any of CX1 and CX2) which relates to the output layer set, and thus it is ensured that one primary picture or more in the output layer set decoded from the coding data are necessarily decoded. That is, it is possible to prevent occurrence of a case in that a layer (primary picture layer) to be decoded is not present in the target decoding layer ID list derived by the output control unit 16b and the output control 16c.

The hierarchy video decoding device 1 (and including the modification example (hierarchy video decoding device 1A and hierarchy video decoding device 1B))/hierarchy video coding device 2 preferably decodes/generates coding data which satisfies the conformance condition CX (CX is either of CX1 and CX2), and further satisfies a conformance condition CY1.

Condition CY1: In a case where a layer j (j=0 . . . NumLayersInIdList[LayerSetIdx[i]]−1) is an auxiliary picture layer in the output layer set OLS#i (i=0 . . . NumOuputLayerSets−1) (AuxID[nuh_layer_id[LayerIdList[LayerSetIdx]][j]]>0), the layer j is a non-output layer of the output layer set.

The condition CY1 may be also referred to as conditions CY2 and CY3.

Condition CY2: In a case where the layer j (j=0 . . . NumLayersInIdList[LayerSetIdx[i]]−1) is an auxiliary picture layer in the output layer set OLS#i (i=0 . . . NumOuputLayerSets−1) (AuxID[nuh_layer_id[LayerIdList[LayerSetIdx]][j]]>0), the output_layer_flag of the layer j is 0 (OutputLayerFlag[i][j]=0).

Condition CY3: In a case where the layer j (j=0 . . . NumLayersInIdList[LayerSetIdx[i]]−1) is an auxiliary picture layer in the output layer set OLS#(i=0 . . . NumOutputLayerSets−1) (AuxID[nuh_layer_id[LayerIdList[LayerSetIdx]][j]]>0), the value of output layer information output_layer_flag[i][j] of the layer j is 0.

The hierarchy video decoding device 1 which includes the output control unit 16b or the output control unit 16c which decodes coding data satisfying the conformance condition CX (CX is either of CX1 and CX2) and the conformance condition CY (CY is any of CY1 to CY3) can omit decoding of an auxiliary picture layer since it is ensured that the auxiliary picture layer in the output layer set decoded from the coding data is excluded from the decoding target layer ID list.

[Hierarchy Video Coding Device]

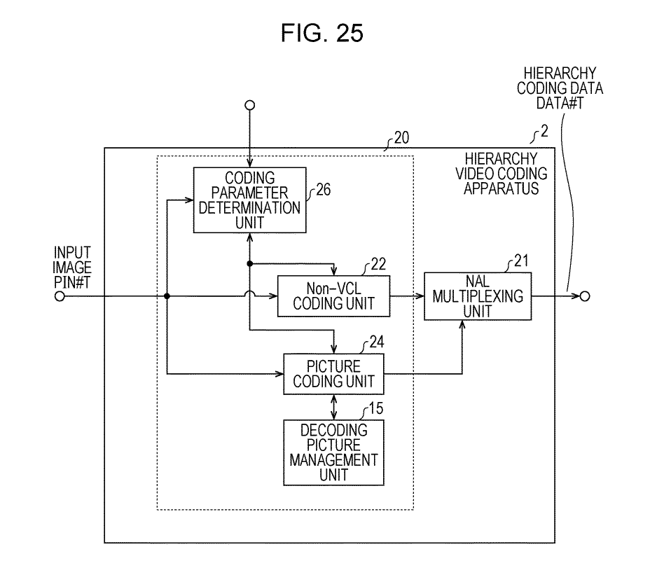

In the following descriptions, a configuration of the hierarchy video coding device 2 according to the embodiment will be described with reference to FIG. 25.

(Configuration of Hierarchy Video Coding Device)

A schematic configuration of the hierarchy video coding device 2 will be described with reference to FIG. 25. FIG. 25 is a functional block diagram illustrating the schematic configuration of the hierarchy video coding device 2. That is, the hierarchy video coding device 2 codes an input image PIN#T (picture) of each layer/sublayer included in a target set which is set as a coding target, and generates hierarchy coding data DATA of the target set. That is, the video coding device 2 codes a picture of each layer in an order of elements TargetLayerIdList [0] . . . TargetLayerIdList [N−1] (N is the number of layers included in a target set (target layer set)) of a layer ID list of a target set TargetSet. The video coding device 2 generates coding data thereof. The hierarchy video decoding device 1 (and including a modification example thereof) preferably generates hierarchy coding data DATA of a target set so as to satisfy the aforementioned conformance conditions CC (CC corresponds to CC1 to CC4), in order to ensure that a base layer is included in the layer set. Further, the hierarchy video decoding device 1 (and including a modification example thereof) which includes the output control unit 16b or the output control unit 16c preferably generates the hierarchy coding data DATA of a target set so as to satisfy the aforementioned conformance condition CX (CX is either of CX1 and CX2), in order to ensure that a primary picture layer is included in the output layer set. The hierarchy video decoding device 1 (and including a modification example thereof) which includes the output control unit 16b or the output control unit 16c preferably generates the hierarchy coding data DATA of a target set so as to satisfy the conformance condition CY (CY is any of CY1 to CY3) in addition to the aforementioned conformance condition CX (CX is either of CX1 and CX2), in order to ensure that decoding processing of an auxiliary picture layer can be omitted.

The hierarchy video coding device 2 as illustrated in FIG. 25 includes a target set picture coding unit 20 and a NAL multiplexing unit 21. The target set picture coding unit 20 includes a non-VCL coding unit 22, a picture coding unit 24, a decoding picture management unit 15, and a coding parameter determination unit 26.

The decoding picture management unit 15 is the same component as the decoding picture management unit 15 in the above-described hierarchy video decoding device 1. In the decoding picture management unit 15 included in the hierarchy video coding device 2, since a picture recorded in the internal DPB is not required to be output as an output picture, the output can be omitted. The descriptions of “decoding” in the descriptions for the decoding picture management unit 15 of the hierarchy video decoding device 1 is replaced with those of “coding”, and this can be also applied to the decoding picture management unit 15 in the hierarchy video coding device 2.

The NAL multiplexing unit 21 generates hierarchy video coding data DATA#T and outputs the generated hierarchy video coding data DATA#T to the outside. The hierarchy video coding data DATA#T is obtained in such a manner a VCL and a non-VCL of each layer in the input target set is stored in a NAL unit so as to perform NAL multiplexing. In other words, the NAL multiplexing unit 21 stores (codes) coding data of the non-VCL and coding data of the VCL which are supplied from the target set picture coding unit 20, and a NAL unit type, a layer identifier, and a temporal identifier for each non-VCL and each VCL in a NAL unit, and generates the hierarchy coding data DATA#T which is subjected to NAL multiplexing.

The coding parameter determination unit 26 sets one set among a plurality of sets of coding parameters. The coding parameter corresponds to various parameters associated with each parameter sets (VPS, SPS, and PPS), a prediction parameter for decoding a picture, or a parameter which is generated in association with the prediction parameter, and is set as a target of coding. The coding parameter determination unit 26 calculates a cost value indicating the size of the information quantity and a coding error regarding each of the plurality of sets of the coding parameters. The cost value is, for example, the sum of the coding amount and a value obtained by multiplying a square error by a coefficient X. The coding amount is the information quantity of coding data of each layer/sublayer of the target set obtained by performing variable length coding on the quantization error and the coding parameter. The square error is the total sum of a square value of a different value between the input image PIN#T and the predicted image, between pixels. The coefficient X is a real number which is predetermined and is more than zero. The coding parameter determination unit 26 selects a set of coding parameters which cause the calculated cost value to be the minimum, and supplies the selected set of coding parameters to the parameter set coding unit 22 and the picture coding unit 24.

The non-VCL coding unit 22 corresponds to reverse processing of the non-VCL decoding unit 12 in the hierarchy video decoding device 1. The non-VCL coding unit 22 sets a parameter set (VPS, SPS, and SPS) or another non-VCL which is used for decoding the input image, based on the coding parameter of each non-VCL input from the coding parameter determination unit 26, and the input image. The non-VCL coding unit 22 supplies the parameter set or the other non-VCL as data stored in the non-VCL NAL unit, to the NAL multiplexing unit 21. The non-VCL coded by the non-VCL coding unit 22 includes the layer set information, the output layer set information, the PTL information, and the DPB information which are described for the non-VCL decoding unit 12 included in the hierarchy video decoding device 1. That is, the non-VCL coding unit 22 includes parameter set coding means (not illustrated). The parameter set coding means includes layer set information coding means for coding (generating) the layer set information, output layer set information coding means for coding (generating) the output layer set information, PTL information coding means for coding the PTL information, DPB information coding means for coding the DPB information, sub-bitstream characteristic information coding means for coding the sub-bitstream characteristic information, and scalable identifier coding means for coding a scalable identifier of each layer. The above-described means are not illustrated. The coding units, and functions and operations of the coding means are assumed to respectively correspond to reverse processing of the corresponding decoding units, and the decoding means. “Decoding” in the decoding units and the decoding means is assumed to be replaced with “coding” and interpreted. The non-VCL coding unit 22 applies the NAL unit type, the layer identifier, and the temporal identifier which correspond to a non-VCL, to the non-VCL, and outputs a result of the application when the non-VCL coding unit 22 supplies coding data of the non-VCL to the NAL multiplexing unit 21.

The parameter set generated by the non-VCL coding unit 22 includes an identifier for identifying the parameter set, and an active parameter set identifier. The active parameter set identifier is used for designating a parameter set (active parameter set) to which the parameter set referring in order to decode a picture of each layer refers. Specifically, if the parameter set is a video parameter set VPS, a VPS identifier for identifying the VPS is included. If the parameter set is a sequence parameter set SPS, an SPS identifier (sps_seq_parameter_set_id) for identifying the SPS, and an active VPS identifier (sps_video_parameter_set_id) for specifying a VPS to which the SPS or another syntax refers are included. If the parameter set is a picture parameter set PPS, a PPS identifier (pps_pic_parameter_set_id) for identifying the PPS, and an active SPS identifier (pps_seq_parameter_set_id) for specifying an SPS to which the PPS or another syntax refers are included.

The picture coding unit 24 decodes a portion of an input image of each layer corresponding to a slice constituting a picture, based on the input image PIN#T of the input layer, a Non-VCL (particularly, parameter set) supplied by the coding parameter determination unit 26, and a reference picture recorded in the decoding picture management unit 15. The picture coding unit 24 generates coding data of the portion, and supplies the generated coding data as data stored in a VCL NAL unit, to the NAL multiplexing unit 21. The picture coding unit 24 will be described later in detail. The picture coding unit 24 applies a NAL unit type, a layer identifier, and a temporal identifier which correspond to a VCL, to coding data, and outputs a result of the application, when the picture coding unit 24 supplies the coding data of the VCL to the NAL multiplexing unit 21.

(Picture Coding Unit 24)

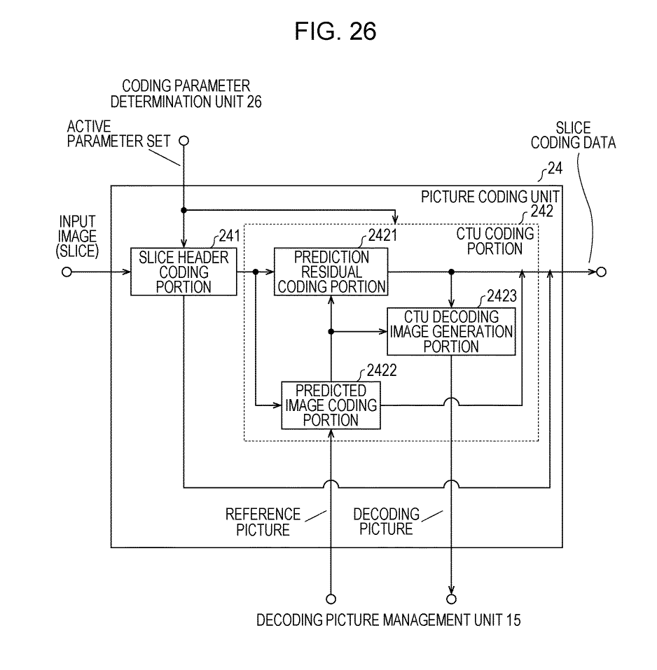

A configuration of the picture coding unit 24 will be described in detail with reference to FIG. 26. FIG. 26 is a functional block diagram illustrating a schematic configuration of the picture coding unit 24.

As illustrated in FIG. 26, the picture coding unit 24 includes a slice header coding portion 241 and a CTU coding portion 242.

The slice header coding portion 241 generates a slice header used for coding an input image of each layer which is input in a unit of a slice, based on the input active parameter set. The generated slice header is output as a portion of slice coding data, and is supplied to the CTU coding portion 242 along with the input image. The slice header generated by the slice header coding portion 241 includes an active PPS identifier for designating a picture parameter set PPS (active PPS) which is used for decoding a picture of each layer.

The CTU coding portion 242 codes an input image (target slice portion) in a unit of a CTU, based on the input active parameter set and the slice header. The CTU coding portion 242 generates and outputs slice data relating to a target slice, and a decoding image (decoding picture). More specifically, the CTU coding portion 242 splits an input image of the target slice by using a CTB having the same size of a CTB size included in the parameter set, as a unit. The CTU coding portion 242 codes an image corresponding to each CTB, as one CTU. The CTU is coded by a prediction residual coding portion 2421, a predicted image coding portion 2422, and a CTU decoding image generation portion 2423.

The prediction residual coding portion 2421 outputs quantization residual information (TT information) as a portion of the slice data included in the slice coding data. The quantization residual information is obtained by transforming and quantizing a differential image between the input input image and a predicted image. The prediction residual coding portion 2421 applies reverse transform and reverse quantization to the quantization residual information, so as to restore a prediction residual. The prediction residual coding portion 2421 outputs the restored prediction residual to the CTU decoding image generation portion 2423.

The predicted image coding portion 2422 generates a predicted image based on a prediction method and a prediction parameter of a target CTU included in the target slice, and outputs the generated predicted image to the prediction residual coding portion 2421 and the CTU decoding image generation portion 2423. The prediction method and a prediction parameter are determined by the coding parameter determination unit 26. Information of the prediction method or the prediction parameter is subjected to variable length coding as prediction information (PT information). The information subjected to the variable length coding is output as a portion of the slice data included in the slice coding data. In a case of using inter-prediction or inter-layer image prediction, the decoding picture management unit 15 reads the corresponding reference picture.

The CTU decoding image generation portion 2423 is the same component as the CTU decoding image generation portion 1423 included in the hierarchy video decoding device 1. Thus, descriptions for the CTU decoding image generation portion 2423 will be omitted. The decoding image of the target CTU is supplied to the decoding picture management unit 15, and is recorded in an internal DPB.

<Coding Process of Picture Coding Unit 24>

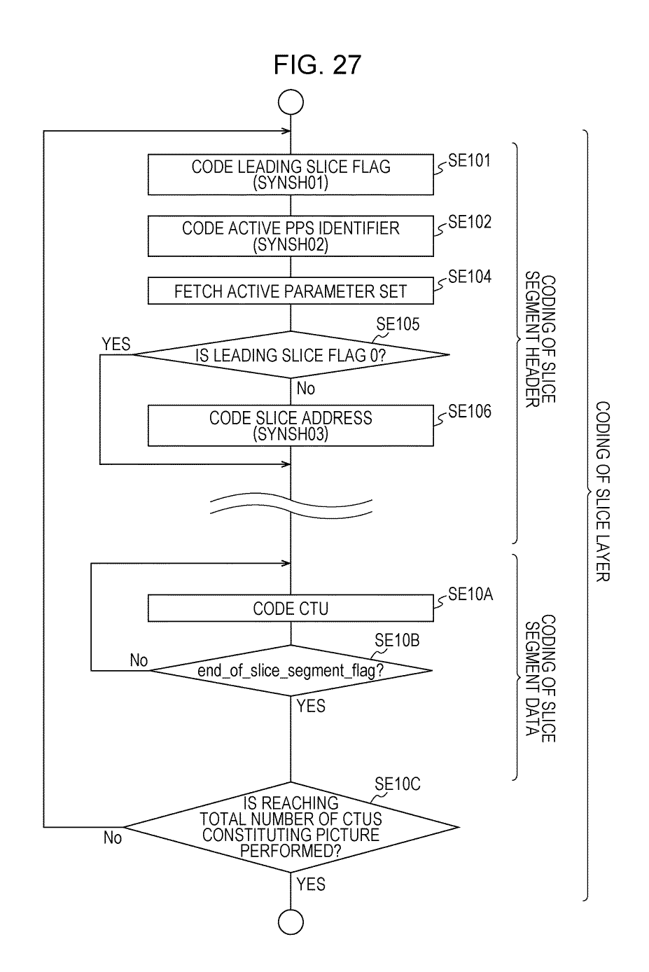

A schematic operation of coding a picture of a target layer i in the picture coding unit 24 will be described below with reference to FIG. 27. FIG. 27 is a flowchart illustrating a coding process in a unit of a slice constituting a picture of the target layer i in the picture coding unit 24.

(SE101) The leading slice flag (first_slice_segment_pic_flag) (SYNSH01 in FIG. 17(d)) of a coding target slice is coded. That is, if an input image (below, coding target slice) slit in a unit of a slice is the leading slice in a coding order (decoding order) (below, processing order) of a picture, the leading slice flag (first_slice_segment_in_pic_flag) is 1. If the coding target slice is not a leading slice, the leading slice flag is 0. In a case where the leading slice flag is 1, a leading CTU address of the coding target slice is set to 0. A counter numCtu (below, the number of processed CTUs numCtu) of the number of processed CTUs in a picture is set to 0. In a case where the leading slice flag is 0, the leading CTU address of the coding target slice is set based on a slice address coded in SE106 (which will be described later).

(SE102) An active PPS identifier (slice_pic_paramter_set_id) (SYNSH02 in FIG. 17(d)) for designating an active PPS referring when the coding target slice is coded is coded.

(SE104) The active parameter set determined by the coding parameter determination unit 26 is fetched. That is, a PPS having a PPS identifier (pps_pic_parameter_set_id) which is the same as an active PPS identifier (slice_pic_parameter_set_id) to which the coding target slice refers is set as an active PPS. Then, a coding parameter of the active PPS is fetched (read) from the coding parameter determination unit 26. An SPS having an SPS identifier (sps_seq_parameter_set_id) which is the same as an active SPS identifier (pps_seq_parameter_set_id) in the active PPS is set as an active SPS. A coding parameter of the active SPS is fetched from the coding parameter determination unit 26. A VPS having a VPS identifier (vps_video_parameter_set_id) which is the same as an active VPS identifier (sps_video_parameter_set_id) in the active SPS is set as an active VPS. Then, a coding parameter of the active VPS is fetched from the coding parameter determination unit 26.

The picture coding unit 24 may verify whether the target set satisfies the conformance condition, with reference to layer set information included in the active VPS, output layer set information, PTL information, a layer identifier of the active parameter set (VPS, SPS, PPS), a layer identifier of a target layer, and the like. Descriptions for the conformance condition will be omitted because of being described already in the hierarchy video decoding device 1. In the hierarchy video decoding device 1 corresponding to the hierarchy image coding device 2, it is ensured that hierarchy coding data DATA of the target set can be decoded without satisfying the conformance condition.

(SE105) It is determined whether or not the coding target slice is a leading slice in the picture in the processing order, based on the leading slice flag. In a case where the leading slice flag is 0 (Yes in SE105), the process transitions to Step SE106. In other cases (No in SE105), the process of Step SE106 is skipped. In a case where the leading slice flag is 1, the slice address of the coding target slice is 0.

(SE106) The slice address (slice_segment_address) (SYNSH03 in FIG. 17(d)) of the coding target slice is coded. The slice address (leading CUT address of coding target slice) of the coding target slice can be set based on the counter numCtu of the number of processed CTUs in a picture, for example. In this case, slice address slice_segment_adress=numCtu is satisfied. That is, leading CTU address of coding target slice=numCtu is also satisfied. A determination method of the slice address is not limited thereto, and can be changed in a range allowed to be performed.

(SE10A) The CTU coding portion 242 codes the input image (coding target slice) in a unit of a CTU, based on the input active parameter set and the slice header. The CTU coding portion 242 outputs coding data (SYNSD01 in FIG. 17(d)) of the CTU information as a portion of the slice data of the coding target slice. The CTU coding portion 242 generates and outputs a CTU decoding image of an area corresponding to each CTU. After the coding data of the CTU information, a slice termination flag (end_of_slice_segment_flag) (SYNSD02 in FIG. 17(d)) is coded. The slice termination flag indicates whether or not the CTU is a termination of the coding target slice. In a case where the CTU is a termination of the coding target slice, the slice termination flag is set to 1. In other cases, the slice termination flag is set to 0. Then, the slice termination flag is coded. After each CTU is coded, 1 is added to the value of the number of processed CTUs numCtu (numCtu++).

(SE10B) It is determined whether or not the CTU is a termination of the coding target slice, based on the slice termination flag. In a case where the slice termination flag is 1 (Yes in SE10B), the process transitions to Step SE10C. In other cases (No in SE10B), the process transitions to Step SE10A in order to decode the subsequent CTU.

(SE10C) It is determined whether or not the number of processed CTUs numCtu reaches the total number (PicSizeInCtbsY) of CTUs constituting a picture. That is, it is determined whether numCtu==PicSizeInCtbsY is satisfied. In a case where numCtu is equal to PicSizeInCtbsY (Yes in SE10C), coding processing in a unit of a slice constituting a coding target picture is ended. In other cases (numCtu<PicSizeInCtbsY) (No in SE10C), the process transitions to Step SE101 in order to continue coding processing in a unit of a slice constituting the coding target picture.

Hitherto, the operation of the picture coding unit 24 according to Example 1 is described. However, it is not limited to the above steps, and the steps may be changes in a range allowed to be performed.

(Advantages of Video Coding Device 2)

The above-described hierarchy video coding device 2 according to the embodiment generates hierarchy coding data DATA of a target set so as to satisfy the aforementioned conformance condition CC1 (or CC2 to CC4) since the hierarchy video decoding device 1 (and the modification example (hierarchy video decoding device 1A, hierarchy video decoding device 1B) ensures that a base layer is included in a layer set. Thus, in the hierarchy image decoding device 1, it is ensured that the base layer is necessarily decoded in an output layer set decoded from the coding data. Accordingly, when coding data including a layer set B which is generated from coding data including a certain layer set A by the bitstream extraction processing and is a subset of the layer set A is decoded, in a case where the parameter set (VPS/SPS/PPS) having a layer identifier for the base layer is referred to as an active parameter set in a certain layer C (layer identifier >0) in the layer set B, it is possible to prevent a case in that the base layer is not included in the coding data including the layer set B, and decoding of the certain layer C is not possible. That is, the conformance condition CC1 (C2C to CC4) is satisfied, and thus it is possible to ensure that the coding data including the layer set B which is a subset of the layer set A generated by bitstream extraction can be decoded from the coding data including the layer set A.

The hierarchy video coding device 2 generates hierarchy coding data DATA of a target set so as to satisfy the aforementioned conformance condition CX (CX is either of CX1 and CX2) since the hierarchy video decoding device 1 (and including the modification example) ensures that one primary picture or more in an output layer set which is decoded from the coding data are necessarily decoded. Thus, the hierarchy video decoding device 1 ensures that one primary picture or more in the output layer set decoded from the coding data are necessarily decoded. That is, it is possible to prevent occurrence of a case in that a layer (primary picture layer) to be decoded is not present in the target decoding layer ID list derived by the output control unit 16b and the output control 16c.

Further, the hierarchy video coding device 2 generates the hierarchy coding data DATA of a target set so as to satisfy the conformance condition CY (CY is any of CY1 to CY3) in addition to the aforementioned conformance condition CX (CX is either of CX1 and CX2), in order to cause the hierarchy video decoding device including the output control unit 16b or the output control 16c to ensure that decoding processing of an auxiliary picture layer can be omitted. Accordingly, in the hierarchy video decoding device 1 including the output control unit 16b or the output control unit 16c, it is possible to ensure that decoding processing of an auxiliary picture layer can be omitted in the output layer set decoded from the coding data.

(Application Example to Another Hierarchy Video Coding/Decoding System)

The hierarchy video coding device 2 and the hierarchy video decoding device 1 which are described above can be mounted in various devices which perform transmission, reception, recording, and reproduction of a video, and be used. The video may be a natural video captured by a camera and the like, or be an artificial video (including CG and a GUI) generated by a computer and the like.

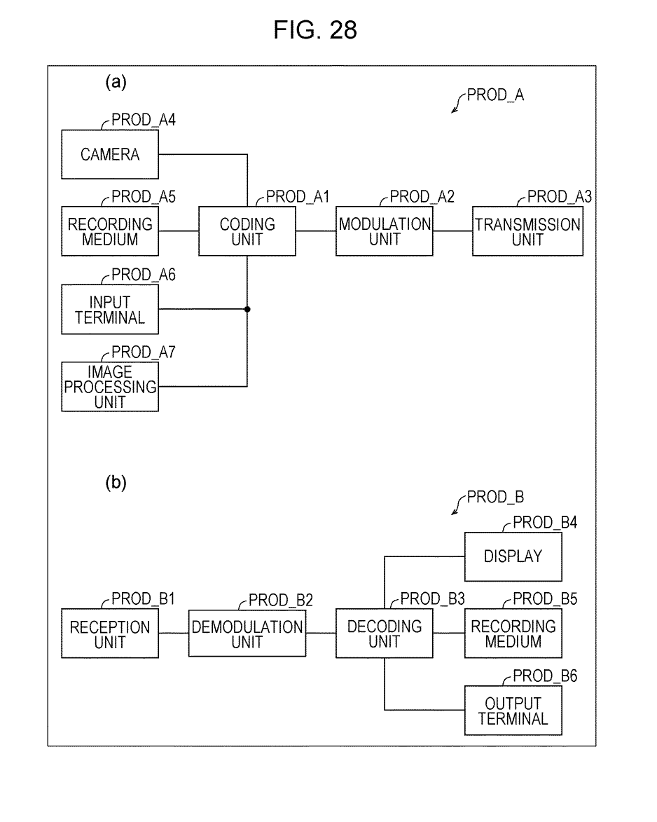

A case where the hierarchy video coding device 2 and the hierarchy video decoding device 1 which are described above can be used when a video is transmitted and received will be described with reference to FIG. 28. FIG. 28(a) is a block diagram illustrating a configuration of a transmission device PROD_A in which the hierarchy video coding device 2 is mounted.

As illustrated in FIG. 28(a), the transmission device PROD_A includes a coding unit PROD_A1, a modulation unit PROD_A2, and a transmission unit PROD_A3. The coding unit PROD_A1 obtains coding data by coding a video. The modulation unit PROD_A2 obtains a modulation signal by modulating the coding data which is obtained by the coding unit PROD_A1, with a carrier wave. The transmission unit PROD_A3 transmits the modulation signal obtained by the modulation unit PROD_A2. The above-described hierarchy video coding device 2 is used as the coding unit PROD_A1.

The transmission device PROD_A may include a camera PROD_A4, a recording medium PROD_A5, an input terminal PROD_A6, and an image processing unit A7. The camera PROD_A4 is used as a supply source of a video input to the coding unit PROD_A1, and captures a video. The recording medium PROD_A5 records a video. The input terminal PROD_A6 is used for input a video from the outside of the device. The image processing unit A7 generates or processes an image.

FIG. 28(a) illustrates a configuration in which the transmission device PROD_A includes all of the above-described units. However, some thereof may be omitted.

The recording medium PROD_A5 may be used for recording a video which is not coded, or may be used for recording a video coded by a coding method for recording which is different from a coding method for transmission. In a case of the latter, a decoding unit (not illustrated) may be interposed between the recording medium PROD_A5 and the coding unit PROD_A1. The decoding unit decodes coding data which has been read from the recording medium PROD_A5, in accordance with the coding method for recording.

FIG. 28(b) is a block diagram illustrating a configuration of a reception device PROD_B in which the hierarchy video decoding device 1 is mounted. As illustrated in FIG. 28(b), the reception device PROD_B includes a reception unit PROD_B1, a demodulation unit PROD_B2, and a decoding unit PROD_B3. The reception unit PROD_B1 receives a modulation signal. The demodulation unit PROD_B2 obtains coding data by demodulating the modulation signal which has been received by the reception unit PROD_B1. The decoding unit PROD_B3 obtains a video by decoding the coding data which has been obtained by the demodulation unit PROD_B2. The above-described hierarchy video decoding device 1 is used as the decoding unit PROD_B3.

The reception device PROD_B may include a display PROD_B4, a recording medium PROD_B5, and an output terminal PROD_B6. The display PROD_B4 displays a video as a supply destination of a video output by the decoding unit PROD_B3. The recording medium PROD_B5 records a video. The output terminal PROD_B6 outputs a video to the outside of the device. FIG. 28(b) illustrates a configuration in which the reception device PROD_B includes all of the above-described units. However, some thereof may be omitted.

The recording medium PROD_B5 may be used for recording a video which is not coded, or may be used for recording a video coded by a coding method for recording which is different from a coding method for transmission. In a case of the latter, a coding unit (not illustrated) may be interposed between the decoding unit PROD_B3 and the recording medium PROD_B5. The coding unit codes a video acquired from the decoding unit PROD_B3, in accordance with the coding method for recording.

A transmission medium for transmitting the modulation signal may be wireless or wired. A transmission form in which the modulation signal is transmitted may be broadcasting (which means a transmission form in which a transmission destination is not specified in advance, here), or communication (which means a transmission form in which a transmission destination is specified in advance, here). That is, transmission of the modulation signal may be realized by any of radio broadcasting, cable broadcasting, wireless communication, and wired communication.

For example, a broadcast station (broadcasting facilities and the like)/receiving station (television receiver and the like) for digital terrestrial broadcasting is an example of the transmission device PROD_A/reception device PROD_B which transmits and receives a modulation signal in radio broadcasting. A broadcast station (broadcasting facilities and the like)/receiving station (television receiver and the like) for cable television broadcasting is an example of the transmission device PROD_A/reception device PROD_B which transmits and receives a modulation signal in cable broadcasting.

A server (workstation and the like)/client (television receiver, personal computer, smart phone and the like) for a VOD (Video On Demand) service or a video sharing service which uses the Internet is an example of the transmission device PROD_A/reception device PROD_B which transmits and receives a modulation signal in communication (generally, either of wireless and a cable is used as a transmission medium in the LAN, and a cable is used as a transmission medium in the WAN). Here, the personal computer includes a desktop PC, a laptop PC, and a tablet PC. The smart phone includes a multi-function mobile phone.

The client of the video sharing service has a function of coding a video which has been captured by a camera, and uploading the coded video to the server, in addition to a function of decoding coding data which has been downloaded from the server, and displaying the decoded data in the display. That is, the client of the video sharing service functions as both of the transmission device PROD_A and the reception device PROD_B.

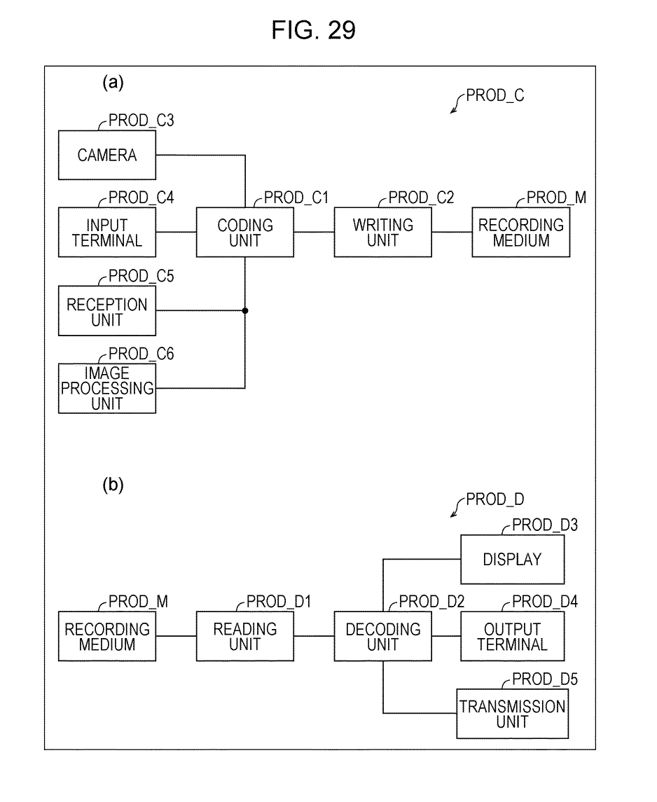

A case where the hierarchy video coding device 2 and the hierarchy video decoding device 1 which are described above are used in recording and reproducing of a video will be described with reference to FIG. 29. FIG. 29(a) is a block diagram illustrating a configuration of the recording device PROD_C in which the above-described hierarchy video coding device 2 is mounted.

As illustrated in FIG. 29(a), the recording device PROD_C includes a coding unit PROD_C1, and a writing unit PROD_C2. The coding unit PROD_C1 obtains coding data by coding a video. The writing unit PROD_C2 writes the coding data which has been obtained by the coding unit PROD_C1, in a recording medium PROD_M. The above-described hierarchy video coding device 2 is used as the coding unit PROD_C1.

The recording medium PROD_M may have (1) a type of being mounted in the recording device PROD_C, such as a hard disk drive (HDD) and a solid state drive (SSD), may have (2) a type of being connected to the recording device PROD_C, such as an SD memory card, and a USB (Universal Serial Bus) flash memory, or may (3) be loaded in a drive device (not illustrated) mounted in the recording device PROD_C, such as a digital versatile disc (DVD) and a Blu-ray Disc (BD: registered trademark).

The recording device PROD_C includes a camera PROD_C3, an input terminal PROD_C4, a reception unit PROD_C5, and an image processing unit C6. The camera PROD_C3 is used as a supply source of a video input to the coding unit PROD_C1, and captures a video. The input terminal PROD_C4 inputs a video from the outside of the device. The reception unit PROD_C5 receives a video. The image processing unit C6 generates or processes an image. FIG. 29(a) illustrates a configuration in which the recording device PROD_C includes all of the above-described units. However, some thereof may be omitted.

The reception unit PROD_C5 may receive a video which is not coded, or may receive coding data coded by a coding method for transmission which is different from a coding method for recording. In a case of the latter, a decoding unit (not illustrated) for transmission may be interposed between the reception unit PROD_C5 and the coding unit PROD_C1. The decoding unit for transmission decodes coding data which has been coded by using the coding method for transmission.

Examples of such a recording device PROD_C include a DVD recorder, a BD recorder, a HDD (Hard Disk Drive) recorder, and the like (in this case, the input terminal PROD_C4 or the reception unit PROD_C5 functions as the main supply source of a video). In addition, a camcorder (in this case, the camera PROD_C3 functions as the main supply source of a video), a personal computer (in this case, the reception unit PROD_C5 or the image processing unit C6 functions as the main supply source of a video), a smart phone (in this case, the camera PROD_C3 or the reception unit PROD_C5 functions as the main supply source of a video), and the like are an example of such a recording device PROD_C.

FIG. 29(b) is a block diagram illustrating a configuration of a reproduction device PROD_D in which the hierarchy video decoding device 1 is mounted. As illustrated in FIG. 29(b), the reproduction device PROD_D includes a reading unit PROD_D1 and a decoding unit PROD_D2. The reading unit PROD_D1 reads coding data which has been written in the recording medium PROD_M. The decoding unit PROD_D2 obtains a video by decoding the coding data which has been read by the reading unit PROD_D1. The above-described hierarchy video decoding device 1 is used as the decoding unit PROD_D2.

The recording medium PROD_M may have (1) a type of being mounted in the reproduction device PROD_D, such as a HDD and a SSD, may have (2) a type of being connected to the reproduction device PROD_D, such as an SD memory card, and a USB flash memory, or may (3) be loaded in a drive device (not illustrated) mounted in the reproduction device PROD_D, such as a DVD and a BD.

The reproduction device PROD_D includes a display PROD_D3, an output terminal PROD_D4, and a transmission unit PROD_D5. The display PROD_D3 is used as a supply destination of a video output by the decoding unit PROD_D2, and displays a video. The output terminal PROD_D4 is used for outputting a video to the outside of the device. The transmission unit PROD_D5 transmits a video. FIG. 29(b) illustrates a configuration in which the reproduction device PROD_D includes all of the above-described units. However, some thereof may be omitted.

The transmission unit PROD_D5 may transmit a video which is not coded, or may transmit coding data which has been coded by using a coding method for transmission which is different from a coding method for recording. In a case of the latter, a coding unit (not illustrated) may be interposed between the decoding unit PROD_D2 and the transmission unit PROD_D5. The coding unit codes a video by using the coding method for transmission.

Examples of such a reproduction device PROD_D include a DVD player, a BD player, a HDD player, and the like (in this case, the output terminal PROD_D4 to which the television receiver and the like are connected functions as the main supply destination). A television receiver (in this case, the display PROD_D3 functions as the main supply destination), a digital signage (which is also referred to as an electronic signboard, an electric bulletin board, or the like, and the display PROD_D3 or the transmission unit PROD_D5 functions as the main supply destination), a desktop PC (in this case, the output terminal PROD_D4 or the transmission unit PROD_D5 functions as the main supply destination), a laptop or tablet PC (in this case, the display PROD_D3 or the transmission unit PROD_D5 functions as the main supply destination), a smart phone (in this case, the display PROD_D3 or the transmission unit PROD_D5 functions as the main supply destination), and the like are an example of such a reproduction device PROD_D.

(Realization by Hardware and Realization by Software)

Finally, the blocks of the hierarchy video decoding device 1 and the hierarchy video coding device 2 may be realized by hardware of a logical circuit which is formed on an integrated circuit (IC chip), or may be realized by software of using a central processing unit (CPU).

In a case of the latter, each of the devices includes a CPU, a read only memory (ROM), a random access memory (RAM), a storage device (recording medium) such as a memory, and the like. The CPU executes a command of a control program for realizing functions. The ROM stores the program. In the RAM, the program is developed. The storage device stores the program and various types of data. An object of the present invention can be achieved in such a manner that a recording medium is supplied to each of the device, and a computer (CPU or a micro processing unit (MPU)) thereof reads and executes program codes recorded in the recording medium. In the recording medium, program codes (execution format program, intermediate code program, and source program) of a control program for each of the devices are recorded so as to be allowed to be read by a computer. The control program is software for realizing the above-described functions.

As the recording medium, for example, tapes such as a magnetic tape or a cassette tape, disks, cards such as an IC card (including a memory card)/optical card, semiconductor memories such as a mask ROM/EPROM (Erasable Programmable Read-only Memory)/EEPROM (registered trademark) (Electrically Erasable and Programmable Read-only Memory)/flash ROM, logical circuits such as a programmable logic device (PLD) or a field programmable gate array (FPGA), or the like can be used. The disks includes a magnetic disk such as a floppy (registered trademark) disk/hard disk, and an optical disk such as a CD-ROM(Compact Disc Read-Only Memory)/MO(Magneto-Optical)/MD(Mini Disc)/DVD(Digital Versatile Disk)/CD-R(CD Recordable).

Each of the devices may be configured so as to be allowed to be connected to a communication network, and the program code may be supplied through the communication network. The communication network may be used for transmitting the program code, but is not limited thereto. For example, the Internet, an intranet, an extranet, a local area network (LAN), an integrated services digital network (ISDN), a value-added network (VAN), a CATV (community antenna television) communication network, a virtual private network, a mobile communication network, a satellite communication network, and the like may be used. A transmission medium constituting the communication network may be a medium allowing transmission of the program code, and is not limited to a specific configuration or a specific type. For example, the transmission medium can be used in cable communication and wireless communication. Examples of the cable communication include IEEE (Institute of Electrical and Electronic Engineers) 1394, USB, power-line transmission, a cable TV line, a telecommunication line, and an asymmetric digital subscriber line (ADSL) line. Examples of the wireless communication include infrared communication such as Infrared Data Association (IrDA) or remote control, Bluetooth (registered trademark), IEEE 802.11 wireless communication, high data rate (HDR), near field communication (NFC), digital living network alliance (DLNA) (registered trademark), a mobile phone network, a satellite line, and a terrestrial digital network. The present invention may be also realized in a form of a computer data signal which is obtained by implementation of the program codes by electronic transmission, and is embedded to a carrier wave.

### CONCLUSION

In the present invention, an image decoding device indicated by at least the first aspect to the 23th aspect, and an image coding device indicated by the 24th aspect to the 33th aspect are included.

An image decoding device according to a first aspect of the present invention is an image decoding device which decodes hierarchy image coding data. The image decoding device includes layer set information decoding means for decoding a layer set, output layer set information decoding means for decoding a layer set identifier of an output layer set, and an output layer flag, scalable identifier decoding means for decoding a scalable identifier, output layer set selection means for selecting one of output layer sets as a target output layer set, output layer ID list deriving means for deriving an output layer ID list indicating a configuration of the target output layer based on a layer set corresponding to the output layer set, and the output layer flag, decoding layer ID list deriving means for deriving a decoding layer ID list indicating a configuration of layers set as decoding targets, based on a layer set corresponding to the layer set, and the scalable identifier, and picture decoding means for generating a decoding picture of each picture included in the derived decoding layer ID list.

In the image decoding device according to a second aspect of the present invention, in the first aspect, the decoding layer ID list deriving means derives a layer indicated as a primary picture layer by the scalable identifier, as a decoding layer ID list among layers included in the output layer set.

In the image decoding device according to a third aspect of the present invention, in the first aspect to the second aspect, the decoding layer ID list deriving means determines whether a layer is a primary picture layer, for each layer included in the output layer set. In a case where the layer is a primary picture layer, the decoding layer ID list deriving means adds the layer as an element of the decoding layer ID list. In a case where the layer is an auxiliary picture layer, the decoding layer ID list deriving means does not add the layer as an element of the decoding layer ID list.

An image decoding device according to a fourth aspect of the present invention is an image decoding device which decodes hierarchy image coding data. The image decoding device includes layer set information decoding means for decoding a layer set, output layer set information decoding means for decoding a layer set identifier of an output layer set, and an output layer flag, scalable identifier decoding means for decoding a scalable identifier, output layer set selection means for selecting one of output layer sets as a target output layer set, output layer ID list deriving means for deriving an output layer ID list indicating a configuration of the target output layer based on a layer set corresponding to the output layer set, and the output layer flag, decoding layer ID list deriving means for deriving a decoding layer ID list indicating a configuration of layers set as decoding targets, based on a layer set corresponding to the layer set, the output layer flag, and the scalable identifier, and picture decoding means for generating a decoding picture of each picture included in the derived decoding layer ID list.

In the image decoding device according to a fifth aspect of the present invention, in the fourth aspect, the decoding layer ID list deriving means derives a layer indicated as a primary picture layer by the scalable identifier, and a layer which is indicated as an auxiliary picture layer by the scalable identifier, and has an output layer flag of 1, as a decoding layer ID list among layers included in the output layer set.

In the image decoding device according to a sixth aspect of the present invention, in the fourth aspect to the fifth aspect, the decoding layer ID list deriving means determines whether a layer is a primary picture layer or an auxiliary picture layer, for each layer included in the selected output layer set. In a case where the layer is a primary picture layer, or an auxiliary picture layer of which an output layer flag is 1, the decoding layer ID list deriving means adds the layer as an element of the decoding layer ID list. In a case where the layer is an auxiliary picture layer of which the output layer flag is 0, the decoding layer ID list deriving means does not add the layer as an element of the decoding layer ID list.

In the image decoding device according to a seventh aspect of the present invention, in the first aspect to the sixth aspect, the decoding layer ID list deriving means derives all layers included in a layer set which corresponds to the output layer set, as the decoding layer ID list in a case of being a conformance test.

In the image decoding device according to an eighth aspect of the present invention, in the first aspect to the seventh aspect, the output layer set is configured from at least one primary picture or more.

In the image decoding device according to a ninth aspect of the present invention, in the first aspect to the eighth aspect, in a case where a layer in the output layer set is an auxiliary picture layer, the output layer flag of the auxiliary picture layer is 0.

An image decoding device according to a tenth aspect of the present invention is an image decoding device which decodes hierarchy image coding data. The image decoding device includes layer set information decoding means for decoding a layer set, output layer set information decoding means for decoding a layer set identifier of an output layer set, and an output layer flag, inter-layer dependency information decoding means for decoding inter-layer dependency information, output layer set selection means for selecting one of output layer sets as a target output layer set, output layer ID list deriving means for deriving an output layer ID list indicating a configuration of the target output layer based on a layer set corresponding to the output layer set, and the output layer set flag, decoding layer ID list deriving means for deriving a decoding layer ID list indicating a configuration of layers set as decoding targets, based on a layer set corresponding to the layer set, the output layer flag, and the inter-layer dependency information, and picture decoding means for generating a decoding picture of each picture included in the derived decoding layer ID list.

In the image decoding device according to an 11th aspect of the present invention, in the tenth aspect, the decoding layer ID list deriving means derives an output layer of which the output layer flag is 1, and a dependency layer of the output layer, as the decoding layer ID list.

In the image decoding device according to an 12th aspect of the present invention, in the 11th aspect, the decoding layer ID list deriving means includes a layer of which a layer identifier is 0, in the decoding layer ID list.

In the image decoding device according to a 13th aspect of the present invention, in the tenth aspect to the 11th aspect, the decoding layer ID list deriving means determines whether a layer has an output layer flag of 1, or the layer is a dependency layer of an output layer, for each layer included in the output layer set. In a case where the layer is an output layer or a dependency layer of the output layer, the decoding layer ID list deriving means adds the layer as an element of the decoding layer ID list. In a case where the layer is a non-output layer and a non-dependency layer of an output layer, the decoding layer ID list deriving means does not add the layer as an element of the decoding layer ID list.

In the image decoding device according to a 14th aspect of the present invention, in the tenth aspect or the 12th aspect, the decoding layer ID list deriving means determines whether a layer is an output layer or a dependency layer of the output layer, or the layer has a layer identifier of 0, for each layer included in the selected output layer set. In a case where the layer is an output layer or a dependency layer of the output layer, or the layer has a layer identifier of 0, the decoding layer ID list deriving means adds the layer as an element of the decoding layer ID list. In a case where the layer is a non-output layer and a non-dependency layer of an output layer, the decoding layer ID list deriving means does not add the layer as an element of the decoding layer ID list.

In the image decoding device according to a 15th aspect of the present invention, in the tenth aspect, the output layer set information decoding means decodes DPB information of an output layer set or a PTL•DPB information present flag which indicates whether or not an PTL designation identifier of the output layer set is present. In a case where the PTL•DPB information present flag is true, the output layer set information decoding means decodes the PTL designation identifier by coding data. In a case where the PTL•DPB information present flag is false, the output layer set information decoding means omits decoding of the PTL designation identifier, and estimates to be equal to a PTL designation identifier of a basic output layer set corresponding to the layer set identifier of the output layer set.

In the tenth aspect, the image decoding device according to a 16th aspect of the present invention further includes DPB information decoding means for decoding DPB information of an output layer set. The output layer set information decoding means decodes DPB information of the output layer set or a PTL•DPB information present flag indicating whether or not a PTL designation identifier of the output layer set is present. In a case where PTL•DPB information present flag is true, the DPB information decoding means decodes the PTL designation identifier of the output layer set by coding data. In a case where the PTL•DPB information present flag is false, the DPB information decoding means does not decode the DPB information of the output layer set, and estimates to be equal to DPB information of a basic output layer set corresponding to the layer set identifier of the output layer set.

In the image decoding device according to a 17th aspect of the present invention, in the 15th aspect or the 16th aspect, the output layer set information decoding means does not decode the PTL•DPB information flag of the basic output layer set, and estimates the PTL•DPB information present flag to be 1.

In the image decoding device according to a 18th aspect of the present invention, in the tenth aspect, in a case where the output layer set is a basic output layer set, the output layer set information decoding means decodes the PTL designation identifier by coding data. In a case where the output layer set is an additional output layer set, the output layer set information decoding means estimates to be equal to a PTL designation identifier of a basic output layer set corresponding to the layer set identifier of the output layer set.

In the tenth aspect, the image decoding device according to a 19th aspect of the present invention further includes DPB information decoding means for decoding DPB information of an output layer set. In a case where the output layer set is a basic output layer set, the DPB information decoding means decodes the DPB information of the output layer set by coding data. In a case where the output layer set is an additional output layer set, the DPB information decoding means does not decode the DPB information of the output layer set, and estimates to be equal to DPB information of a basic output layer set corresponding to the layer set identifier of the output layer set.

In the tenth aspect, the image decoding device according to a 20th aspect of the present invention further includes sub-bitstream characteristic information decoding means for decoding sub-bitstream characteristic information, and coding data extraction means for performing bitstream extraction processing based on sub-bitstream characteristic information corresponding to the selected output layer set, and for extracting a bitstream of a target set from the input coding data.

In the image decoding device according to a 21st aspect of the present invention, in the 20th aspect, the coding data extraction means discards at least a NAL unit having a layer identifier of a layer which is a non-output layer and a non-dependency layer of an output layer, in the selected output layer set.

In the image decoding device according to a 22nd aspect of the present invention, in the 20th aspect, the coding data extraction means discards at least a NAL unit having a layer identifier of an auxiliary picture layer, in the selected output layer set.

In the image decoding device according to a 23rd aspect of the present invention, in the 20th aspect, the coding data extraction means discards at least a NAL unit having a layer identifier of an auxiliary picture layer which is a non-output layer, in the selected output layer set.

An image coding device according to a 24th aspect of the present invention is an image coding device which decodes hierarchy image coding data. The image coding device includes layer set information coding means for coding a layer set, inter-layer dependency information coding means for coding inter-layer dependency information, output layer set information coding means for coding a layer set identifier of an output layer set, and an output layer flag, sub-bitstream characteristic information coding means for coding sub-bitstream characteristic information which corresponds to the output layer set, DPB information coding means for coding DPB information which corresponds to the output layer set, and picture coding means for coding a picture of each layer included in a layer set which corresponds to the output layer set.

In the image coding device according to a 25th aspect of the present invention, in the 24th aspect, the sub-bitstream characteristic information includes at least a bitstream extraction mode for designating bitstream extraction processing in which a NAL unit having a layer identifier of a layer which is a non-output layer and a non-dependency layer of an output layer is discarded from a bitstream of the output layer set.

In the image coding device according to a 26th aspect of the present invention, in the 24th aspect or the 25th aspect, the output layer set information coding means codes DPB information of an output layer set or a PTL•DPB information present flag indicating whether or not a PTL designation identifier of the output layer set is present.

In the image coding device according to a 27th aspect of the present invention, in the 26th aspect, in a case where the PTL•DPB information present flag is true, the output layer set information coding means codes the PTL designation identifier by coding data. In a case where the PTL•DPB information present flag is false, the output layer set information coding means omits coding of the PTL designation identifier, and estimates to be equal to a PTL designation identifier of a basic output layer set corresponding to the layer set identifier of the output layer set.

In the image coding device according to a 28th aspect of the present invention, in the 26th aspect, in a case where the PTL•DPB information present flag is true, the DPB information coding means codes DPB information of the output layer set. In a case where the PTL•DPB information present flag is false, the DPB information coding means omits coding of the DPB information of the output layer set, and estimates to be equal to DPB information of a basic output layer set corresponding to the layer set identifier of the output layer set.

In the image coding device according to a 29th aspect of the present invention, in the 25th aspect or the 26th aspect, the output layer set information coding means does not code the PTL•DPB information present flag of the basic output layer set, and estimates the PTL•DPB information present flag to be 1.

In the image coding device according to a 30th aspect of the present invention, in the 24th aspect, in a case where the output layer set is a basic output layer set, the output layer set information coding means codes the PTL designation identifier. In a case where the output layer set is an additional output layer set, the output layer set information coding means estimates to be equal to a PTL designation identifier of a basic output layer set corresponding to the layer set identifier of the output layer set.

In the image coding device according to a 31st aspect of the present invention, in the 24th aspect, in a case where the output layer set is a basic output layer set, the DPB information coding means codes DPB information of the output layer set. In a case where the output layer set is an additional output layer set, the DPB information coding means does not code the DPB information of the output layer set, and estimates to be equal to DPB information of a basic output layer set corresponding to the layer set identifier of the output layer set.

In the image coding device according to a 32nd aspect of the present invention, in the 24th aspect, the sub-bitstream characteristic information includes a bitstream extraction mode for designating bitstream extraction processing in which a NAL unit having a layer identifier of an auxiliary picture layer is discarded from a bitstream of the output layer set.

In the image coding device according to a 33rd aspect of the present invention, in the 24th aspect, the sub-bitstream characteristic information includes a bitstream extraction mode for designating bitstream extraction processing in which a NAL unit having a layer identifier of an auxiliary picture layer which is a non-output layer is discarded from a bitstream of the output layer set.

The present invention is not limited to the above-described embodiments, and various changes may be made in a range described in claims. An embodiment obtained by combining the technical means disclosed in each of the different embodiments is also included in the technical scope of the present invention.

### INDUSTRIAL APPLICABILITY

The present invention can be appropriately applied to a hierarchy video decoding device which decodes coding data obtained by hierarchically coding image data, and to a hierarchy video coding device which generates coding data obtained by hierarchically coding image data. The present invention can be appropriately applied to a data structure of hierarchy coding data which is generated by the hierarchy video coding device, and to which the hierarchy video decoding device refers.

### REFERENCE SIGNS LIST

1 HIERARCHY VIDEO DECODING DEVICE
2 HIERARCHY VIDEO CODING DEVICE
10 TARGET SET PICTURE DECODING UNIT
11 NAL DEMULTIPLEXING UNIT (NAL UNIT DECODING MEANS, LAYER IDENTIFIER DECODING MEANS)
12 NON-VCL DECODING MEANS (PARAMETER SET DECODING MEANS, LAYER SET INFORMATION DECODING MEANS, OUTPUT LAYER SET INFORMATION DECODING MEANS, PTL INFORMATION DECODING MEANS, DPB INFORMATION DECODING MEANS, SUB-BITSTREAM CHARACTERISTIC INFORMATION DECODING MEANS, INTER-LAYER DEPENDENCY INFORMATION DECODING MEANS, SCALABLE IDENTIFIER DECODING MEANS)
13 PARAMETER MEMORY
14 PICTURE DECODING UNIT (VCL DECODING MEANS)
141 SLICE HEADER DECODING PORTION
142 CTU DECODING PORTION
1421 PREDICTION RESIDUAL RESTORATION PORTION
1422 PREDICTED IMAGE GENERATION PORTION
1423 CTU DECODING IMAGE GENERATION PORTION
15 DECODING PICTURE MANAGEMENT UNIT
16 OUTPUT CONTROL UNIT (OUTPUT LAYER SET SELECTION MEANS, TARGET OUTPUT LAYER ID DERIVING MEANS, TARGET DECODING LAYER ID LIST DERIVING MEANS)
17 BITSTREAM EXTRACTION MEANS (CODING DATA EXTRACTION MEANS)
20 TARGET SET PICTURE CODING UNIT
21 NAL MULTIPLEXING UNIT (NAL UNIT CODING MEANS)
22 NON-VCL CODING UNIT (PARAMETER SET CODING MEANS, LAYER SET INFORMATION CODING MEANS, OUTPUT LAYER SET INFORMATION CODING MEANS, PTL INFORMATION CODING MEANS, DPB INFORMATION CODING MEANS, SUB-BITSTREAM CHARACTERISTIC INFORMATION CODING MEANS, INTER-LAYER DEPENDENCY INFORMATION CODING MEANS, SCALABLE IDENTIFIER CODING MEANS)
24 PICTURE CODING UNIT (VCL CODING MEANS)
26 CODING PARAMETER DETERMINATION UNIT
241 SLICE HEADER CODING PORTION
242 CTU CODING PORTION
2421 PREDICTION RESIDUAL CODING PORTION
2422 PREDICTED IMAGE CODING PORTION
2423 CTU DECODING IMAGE GENERATION PORTION

1. An image decoding device which decodes hierarchy image coding data, the device comprising:
a first flag decoding circuit that decodes a first flag in a unit of a layer set, which indicates whether or not each layer is included in a layer set;
a layer set information decoding circuit that derives a layer ID list of the layer set based on the first flag;
an output layer set information decoding circuit that decodes output layer set information in a unit of an output layer set, which includes a) a layer set identifier, and b) an output layer flag which indicates whether or not each layer included in the output layer set is an output layer;
a dependency flag deriving circuit that derives a dependency flag which indicates whether or not a first layer is a reference layer of a second layer;
a decoding layer ID list deriving circuit that derives a decoding layer ID list indicating a layer to be decoded for the output layer set based on the layer ID list corresponding to the output layer set, the output layer flag of the output layer set, and the dependency flag; and
a picture decoding circuit that decodes a picture of each layer included in the derived decoding layer ID list from the hierarchy image coding data corresponding to the each layer.

2-4. (canceled)

5. An image decoding method of decoding hierarchy image coding data, the method comprising:
decoding a first flag in a unit of a layer set, which indicates whether or not each layer is included in a layer set;
deriving a layer ID list of the layer set based on the first flag;
decoding output layer set information in a unit of an output layer set, which includes a) a layer set identifier, and b) an output layer flag which indicates whether or not each layer included in the output layer set is an output layer;
deriving a dependency flag which indicates whether or not a first layer is a reference layer of a second layer;
deriving a decoding layer ID list indicating a layer to be decoded for the output layer set based on the layer ID list corresponding to the output layer set, the output layer flag of the output layer set, and the dependency flag; and
decoding a picture of each layer included in the derived decoding layer ID list from the hierarchy image coding data corresponding to the each layer.

6-8. (canceled)

9. A recoding medium which stores a program for making a computer decode hierarchy image coding data, wherein the program making the computer:
decode a first flag in a unit of a layer set, which indicates whether or not each layer is included in a layer set;
derive a layer ID list of the layer set based on the first flag;
decode output layer set information in a unit of an output layer set, which includes a) a layer set identifier, and b) an output layer flag which indicates whether or not each layer included in the output layer set is an output layer;
derive a dependency flag which indicates whether or not a first layer is a reference layer of a second layer;
derive a decoding layer ID list indicating a layer to be decoded for the output layer set based on the layer ID list corresponding to the output layer set, the output layer flag of the output layer set, and the dependency flag; and
decode a picture of each layer included in the derived decoding layer ID list from the hierarchy image coding data corresponding to the each layer.

10. An image coding device which codes a picture and generates hierarchy image coding data, the device comprising:
a first flag determining circuit that determines a first flag in a unit of a layer set, which indicates whether or not each layer is included in a layer set;
a layer set information generating circuit that generates a layer ID list of the layer set based on the first flag;
a output layer set information generating circuit that generates output layer set information in a unit of an output layer set, which includes a) a layer set identifier, and b) an output layer flag which indicates whether or not each layer included in the output layer set is an output layer;
a dependency flag deriving circuit that derives a dependency flag which indicates whether or not a first layer is a reference layer of a second layer;
a decoding layer ID list deriving circuit that derives a decoding layer ID list indicating a layer to be decoded for the output layer set based on the layer ID list corresponding to the output layer set, the output layer flag of the output layer set, and the dependency flag; and
a picture coding circuit that codes a picture of each layer included in the derived decoding layer ID list and generates the hierarchy image coding data corresponding to the each layer.

11. An image coding method of coding a picture and generating hierarchy image coding data, the device comprising:
determining a first flag in a unit of a layer set, which indicates whether or not each layer is included in a layer set;
generating a layer ID list of the layer set based on the first flag;
generating output layer set information in a unit of an output layer set, which includes a) a layer set identifier, and b) an output layer flag which indicates whether or not each layer included in the output layer set is an output layer;
deriving a dependency flag which indicates whether or not a first layer is a reference layer of a second layer;
deriving a decoding layer ID list indicating a layer to be decoded for the output layer set based on the layer ID list corresponding to the output layer set, the output layer flag of the output layer set, and the dependency flag;
coding a picture of each layer included in the derived decoding layer ID list; and
generating the hierarchy image coding data corresponding to the each layer.

12. A recoding medium which stores a program for making a computer code a picture and generate hierarchy image coding data, wherein the program making the computer:
determine a first flag in a unit of a layer set, which indicates whether or not each layer is included in a layer set;
generate a layer ID list of the layer set based on the first flag;
generate output layer set information in a unit of an output layer set, which includes a) a layer set identifier, and b) an output layer flag which indicates whether or not each layer included in the output layer set is an output layer;
derive a dependency flag which indicates whether or not a first layer is a reference layer of a second layer;
derive a decoding layer ID list indicating a layer to be decoded for the output layer set based on the layer ID list corresponding to the output layer set, the output layer flag of the output layer set, and the dependency flag;
code a picture of each layer included in the derived decoding layer ID list; and
generate the hierarchy image coding data corresponding to the each layer.
